(19) United States
(12) Patent Application Publication
(10) Pub. No.: US 2026/0017266 A1
(43) Pub. Date: Jan. 15, 2026

(54) ANALYTICS SUB-SYSTEM OF A PARALLELIZED DATABASE SYSTEM

(71) Applicant: Ocient Holdings LLC, Chicago, IL (US)

(72) Inventors: S. Christopher Gladwin, Chicago, IL (US); Andrew D. Baptist, Mt. Pleasant, WI (US); George Kondiles, Highland Park, IL (US); Jason Arnold, Chicago, IL (US)

(73) Assignee: Ocient Holdings LLC, Chicago, IL (US)

(21) Appl. No.: 19/329,958

(22) Filed: Sep. 16, 2025

Related U.S. Application Data
(63) Continuation-in-part of application No. 19/057,272, filed on Feb. 19, 2025.
Application No. 19/057,272 is a continuation of application No. 18/532,167, filed on Dec. 7, 2023, now Pat. No. 12,271,384.
Application No. 18/532,167 is a continuation of application No. 17/651,914, filed on Feb. 22, 2022, now Pat. No. 11,874,841.
Application No. 17/651,914 is a continuation of application No. 17/443,066, filed on Jul. 20, 2021, now Pat. No. 11,734,283.
Application No. 17/443,066 is a continuation of application No. 16/668,402, filed on Oct. 30, 2019, now Pat. No. 11,106,679.
(63) Continuation-in-part of application No. 18/742,059, filed on Jun. 13, 2024.
Application No. 18/742,059 is a continuation of application No. 18/532,294, filed on Dec. 7, 2023, now Pat. No. 12,259,886.
Application No. 18/532,294 is a continuation of application No. 18/165,029, filed on Feb. 6, 2023, now Pat. No. 11,874,837.
Application No. 18/165,029 is a continuation of application No. 17/150,415, filed on Jan. 15, 2021, now Pat. No. 11,599,542.
Application No. 17/150,415 is a continuation of application No. 16/665,571, filed on Oct. 28, 2019, now Pat. No. 11,093,500.
(63) Continuation-in-part of application No. 18/648,342, filed on Apr. 27, 2024.
Application No. 18/648,342 is a continuation of application No. 16/267,608, filed on Feb. 5, 2019, now Pat. No. 11,977,545.
(60) Provisional application No. 62/745,787, filed on Oct. 15, 2018.

(51) Int. Cl. G06F 16/2455; G06F 16/242; G06F 16/248

(52) U.S. Cl. CPC G06F 16/24564; G06F 16/2428; G06F 16/248

(57) ABSTRACT

A database system includes an analytics sub-system of an administrative sub-system and a parallelized query and results sub-system. The analytics sub-system includes a data management module operable to obtain and store user profile data related to end users of the database system, data provider profile data related to data providers of the database system, database usage data related to one or more current or past queries on the database system, and an analytics processing module operable to obtain query and results information from the parallelized query and results sub-system based on an analysis indication of a query, obtain analysis information from the data management module related to the query and results information, and compare the query and results information and the analysis information in light of the analysis indication to produce an analysis result.

### CROSS-REFERENCE TO RELATED APPLICATIONS

The present U.S. Utility Patent application claims priority pursuant to 35 U.S.C. § 120 as a continuation-in-part of U.S. Utility application Ser. No. 19/057,272, entitled “ENFORCEMENT OF A MAXIMUM RESULT SET SIZE RULE FOR QUERIES REQUESTED FOR EXECUTION AGAINST A DATABASE SYSTEM,” filed Feb. 19, 2025, which claims priority pursuant to 35 U.S.C. § 120 as a continuation of U.S. Utility application Ser. No. 18/532,167, entitled “ENFORCEMENT OF A MINIMUM RESULT SET SIZE RULE FOR QUERIES REQUESTED FOR EXECUTION AGAINST A DATABASE SYSTEM,” filed Dec. 7, 2023, issued as U.S. Pat. No. 12,271,384 on Apr. 8, 2025, which is a continuation of U.S. Utility application Ser. No. 17/651,914, entitled “ENFORCEMENT OF QUERY RULES FOR ACCESS TO DATA IN A DATABASE SYSTEM,” filed Feb. 22, 2022, issued as U.S. Pat. No. 11,874,841 on Jan. 16, 2024, which is a continuation of U.S. Utility application Ser. No. 17/443,066, entitled “ENFORCEMENT OF A SET OF QUERY RULES FOR ACCESS TO DATA SUPPLIED BY AT LEAST ONE DATA PROVIDER,” filed Jul. 20, 2021, issued as U.S. Pat. No. 11,734,283 on Aug. 22, 2023, which is a continuation of U.S. Utility application Ser. No. 16/668,402, entitled “ENFORCEMENT OF SETS OF QUERY RULES FOR ACCESS TO DATA SUPPLIED BY A PLURALITY OF DATA PROVIDERS,” filed Oct. 30, 2019, issued as U.S. Pat. No. 11,106,679 on Aug. 31, 2021, all of which are hereby incorporated herein by reference in their entirety and made part of the present U.S. Utility Patent Application for all purposes.

The present U.S. Utility Patent Application also claims priority pursuant to 35 U.S.C. § 120 as a continuation-in-part of U.S. Utility application Ser. No. 18/742,059, entitled “APPLYING QUERY COST DATA BASED ON POWER VIA AN AUTOMATICALLY GENERATED SCHEME,” filed Jun. 13, 2024, which claims priority pursuant to 35 U.S.C. § 120 as a continuation of U.S. Utility application Ser. No. 18/532,294, entitled “UTILIZING QUERY APPROVAL DATA DETERMINED BASED ON QUERY COST DATA FOR A QUERY REQUEST,” filed Dec. 7, 2023, issued as U.S. Pat. No. 12,259,886 on Mar. 25, 2025, which is a continuation of U.S. Utility application Ser. No. 18/165,029, entitled “GENERATING QUERY COST DATA BASED ON AT LEAST ONE QUERY FUNCTION OF A QUERY REQUEST,” filed Feb. 6, 2023, issued as U.S. Pat. No. 11,874,837 on Jan. 16, 2024, which is a continuation of U.S. Utility application Ser. No. 17/150,415, entitled “END USER CONFIGURATION OF COST THRESHOLDS IN A DATABASE SYSTEM AND METHODS FOR USE THEREWITH,” filed Jan. 15, 2021, issued as U.S. Pat. No. 11,599,542 on Mar. 7, 2023, which is a continuation of U.S. Utility application Ser. No. 16/665,571, entitled “ENFORCEMENT OF MINIMUM QUERY COST RULES REQUIRED FOR ACCESS TO A DATABASE SYSTEM,” filed Oct. 28, 2019, issued as U.S. Pat. No. 11,093,500 on Aug. 17, 2021, all of which are hereby incorporated herein by reference in their entirety and made part of the present U.S. Utility Patent Application for all purposes.

The present U.S. Utility Patent Application also claims priority pursuant to 35 U.S.C. § 120 as a continuation-in-part of U.S. Utility application Ser. No. 18/648,342, entitled “DISTRIBUTED DATABASE SYSTEM,” filed Apr. 27, 2024, which claims priority pursuant to 35 U.S.C. § 120 as a continuation of U.S. Utility application Ser. No. 16/267,608, entitled “GENERATION OF AN OPTIMIZED QUERY PLAN IN A DATABASE SYSTEM,” filed Feb. 5, 2019, issued as U.S. Pat. No. 11,977,545 on May 7, 2024, which claims priority pursuant to 35 U.S.C. § 119 (e) to U.S. Provisional Application No. 62/745,787, entitled “DATABASE SYSTEM AND OPERATION,” filed Oct. 15, 2018, all of which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF INVENTION

### Technical Field of Invention

The disclosed subject matter relates to computer networking and more particularly to database system and operation.

### DESCRIPTION OF RELATED ART

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function.

Of the many applications a computer can perform, a database system is one of the largest and most complex applications. In general, a database system stores a large amount of data in a particular way for subsequent processing. In some situations, the hardware of the computer is a limiting factor regarding the speed at which a database system can process a particular function. In some other instances, the way in which the data is stored is a limiting factor regarding the speed of execution. In yet some other instances, restricted co-process options are a limiting factor regarding the speed of execution.

### BRIEF DESCRIPTION OF THE SEVERAL VIEWS OF THE DRAWING(S)

FIG. 1 is a schematic block diagram of an embodiment of a large scale data processing network that includes a database system;

FIG. 1A is a schematic block diagram of an embodiment of a database system;

FIG. 2 is a schematic block diagram of an embodiment of an administrative sub-system;

FIG. 3 is a schematic block diagram of an embodiment of a configuration sub-system;

FIG. 4 is a schematic block diagram of an embodiment of a parallelized data input sub-system in accordance with the present invention:

FIG. 5 is a schematic block diagram of an embodiment of a parallelized query and response (Q&R) sub-system in accordance with the present invention;

FIG. 6 is a schematic block diagram of an embodiment of a parallelized data store, retrieve, and/or process (IO& P) sub-system in accordance with the present invention;

FIGS. 7A-7D are schematic block diagrams of various embodiments of a computing entity;

FIG. 7E is a schematic block diagram of an embodiment of a computing device;

FIG. 8 is a schematic block diagram of another embodiment of a computing device;

FIG. 9 is a schematic block diagram of another embodiment of a computing device;

FIGS. 9A-9G are schematic block diagrams of various embodiments of a computing device;

FIG. 10 is a schematic block diagram of an embodiment of a node of a computing device;

FIG. 11 is a schematic block diagram of an embodiment of a node of a computing device;

FIG. 12 is a schematic block diagram of an embodiment of a node of a computing device;

FIG. 13 is a schematic block diagram of an embodiment of a node of a computing device;

FIG. 14 is a schematic block diagram of an embodiment of operating systems of a computing device;

FIG. 15 is a schematic block diagram of an embodiment of operating systems for a node of a computing device;

FIG. 16 is a schematic block diagram of an embodiment of operating systems of a sub-system of the database system;

FIG. 17 is a schematic block diagram of an embodiment of operating systems of the database system;

FIGS. 18 and 19 are a logic diagram of an example of processing a table or data set for storage in the database system;

FIGS. 20-29 are schematic block diagrams of an example of processing a table or data set for storage in the database system;

FIGS. 30-32 are schematic block diagrams of an example of storing a processed table or data set in the database system;

FIG. 33 is a logic diagram of an example of creating a query plan for execution within the database system;

FIG. 34 is a logic diagram of another example of creating a query plan for execution within the database system;

FIGS. 35-36 are schematic block diagrams of an example of creating a query plan in the database system;

FIG. 37 is a schematic block diagram of another embodiment of the large scale data processing network that includes the database system;

FIG. 38 is a schematic block diagram of another embodiment of the database system;

FIG. 39 is a schematic block diagram of an embodiment of an analytics sub-system of the database system;

FIG. 40A is an example of an embodiment of user profile data:

FIG. 40B is an example of an embodiment of provider profile data;

FIG. 41 is an example of an embodiment of database usage data;

FIG. 42 is an example of an embodiment of provider compliance rulesets:

FIG. 43 is an example of an embodiment of a maximum result set size ruleset;

FIG. 44 is an example of an embodiment of a minimum result set size ruleset;

FIG. 45 is an example of an embodiment of a forbidden fields ruleset;

FIG. 46 is an example of an embodiment of a forbidden functions ruleset;

FIG. 47 is an example of an embodiment of a temporal access limits ruleset;

FIG. 48 is an example of an embodiment of a record-based access limits ruleset;

FIG. 49 is a schematic block diagram of another embodiment of the analytics sub-system of the database system; and

FIG. 50 is a schematic block diagram of an embodiment of a compliance module of the analytics sub-system.

### DETAILED DESCRIPTION OF INVENTION

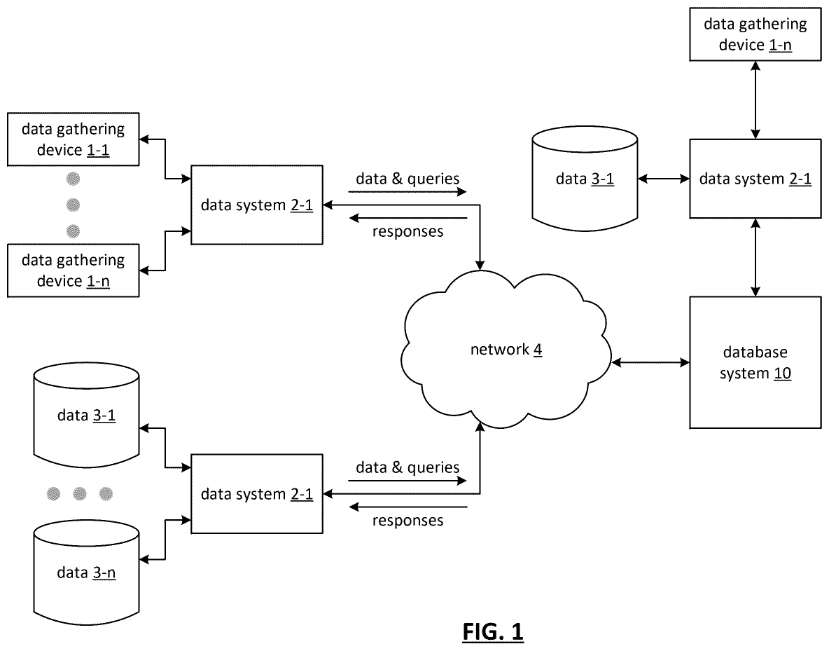

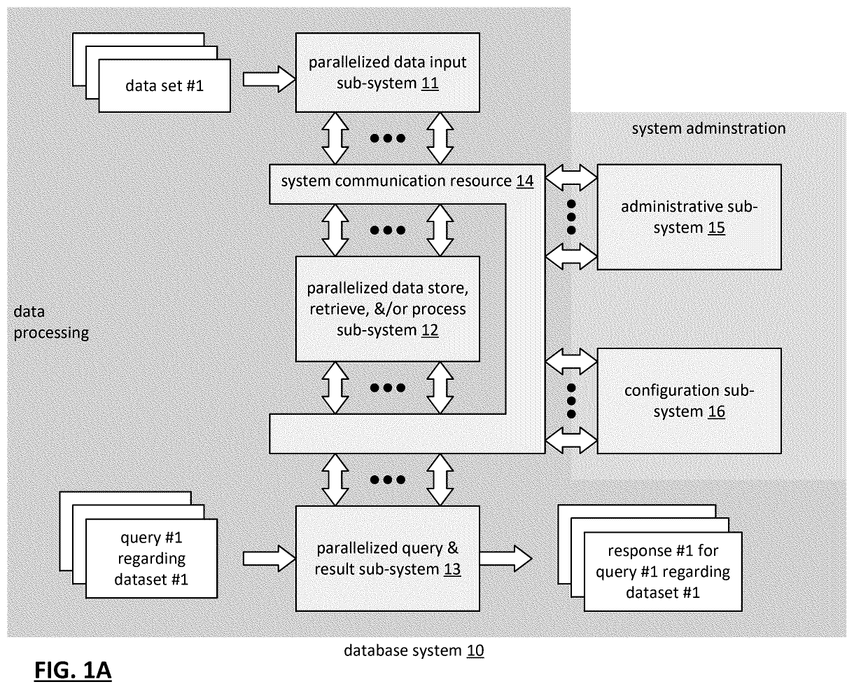

FIG. 1 is a schematic block diagram of an embodiment of a large-scale data processing network that includes a database system. The network further includes a plurality of data system the provide data and one or more queries to the database system 10. The data systems are coupled to or include a plurality of data gathering device (e.g., sensors, monitors, handheld computing devices, etc.) and/or a plurality of storage devices (e.g., hard drives, cloud storage, etc.).

FIG. 1A is a schematic block diagram of an embodiment of a database system 10 that includes a parallelized data input sub-system 11, a parallelized data store, retrieve, and/or process sub-system 12, a parallelized query and response sub-system 13, an administrative sub-system 14, a configuration sub-system 15, and a system communication resource 16. The system communication resources 16 include one or more of wide area network (WAN) connections, local area network (LAN) connections, wireless connections, wireless connections, etc. to couple the sub-systems 11-15 together. Each of the sub-systems 11-15 include a plurality of computing devices: an example of which is discussed with reference to one or more of FIGS. 3A-3C.

In an example of operation, the parallelized data input sub-system 11 receives tables of data from a data source. For example, a data source is one or more computers. As another example, a data source is a plurality of machines. As yet another example, a data source is a plurality of data mining algorithms operating on one or more computers. The data source organizes its data into a table that includes rows and columns. The columns represent fields of data for the rows. Each row corresponds to a record of data. For example, a table include payroll information for a company's employees. Each row is an employee's payroll record. The columns include data fields for employee name, address, department, annual salary, tax deduction information, direct deposit information, etc.

The parallelized data input sub-system 11 processes a table to determine how to store it. For example, the parallelized data input sub-system 11 divides the data into a plurality of data partitions. For each data partition, the parallelized data input sub-system 11 determines a number of data segments based on a desired encoding scheme. As a specific example, when a 4 of 5 encoding scheme is used (meaning any 4 of 5 encoded data elements can be used to recover the data), the parallelized data input sub-system 11 divides a data partition into 5 segments. The parallelized data input sub-system 11 then divides a data segment into data slabs. Using one or more of the columns as a key, or keys, the parallelized data input sub-system sorts the data slabs. The sorted data slabs are sent to the parallelized data store, retrieve, and/or process sub-system 12 for storage.

The parallelized query and response sub-system 13 (also referred to herein as parallelized query & result sub-system) receives queries regarding tables and processes the queries prior to sending them to the parallelized data store, retrieve, and/or process sub-system 12 for processing. For example, the parallelized query and response sub-system 13 receives a specific query regarding a specific table. The query is in a standard query format such as Open Database Connectivity (ODBC), Java Database Connectivity (JDBC), and/or SPARK. The query is assigned to a node within the sub-system 13 for subsequent processing. The assigned node identifies the relevant table, determines where and how it is stored, and determines available nodes within the parallelized data store, retrieve, and/or process sub-system 12 for processing the query.

In addition, the assigned node parses the query to create an abstract syntax tree. As a specific example, the assigned node converts an SQL (Standard Query Language) statement into a database instruction set. The assigned node then validates the abstract syntax tree. If not valid, the assigned node generates a SQL exception, determines an appropriate correction, and repeats. When the abstract syntax tree is validated, the assigned node then creates an annotated abstract syntax tree. The annotated abstract syntax tree includes the verified abstract syntax tree plus annotations regarding column names, data type(s), data aggregation or not, correlation or not, sub-query or not, and so on.

The assigned node then creates an initial query plan from the annotated abstract syntax tree. The assigned node optimizes the initial query plan using a cost analysis function (e.g., processing time, processing resources, etc.). Once the query plan is optimized, it is sent to the parallelized data store, retrieve, and/or process sub-system 12 for processing.

Within the parallelized data store, retrieve, and/or process sub-system 12, a computing device is designated as a primary device for the query plan and receives it. The primary device processes the query plan to identify nodes within the parallelized data store, retrieve, and/or process sub-system 12 for processing the query plan. The primary device then sends appropriate portions of the query plan to the identified nodes for execution. The primary device receives responses from the identified nodes and processes them in accordance with the query plan. The primary device provides the resulting response to the assigned node of the parallelized query and response sub-system 13. The assigned node determines whether further processing is needed on the resulting response (e.g., joining, filtering, etc.). If not, the assigned node outputs the resulting response as the response to the query. If, however, further processing is determined, the assigned node further processes the resulting response to produce the response to the query.

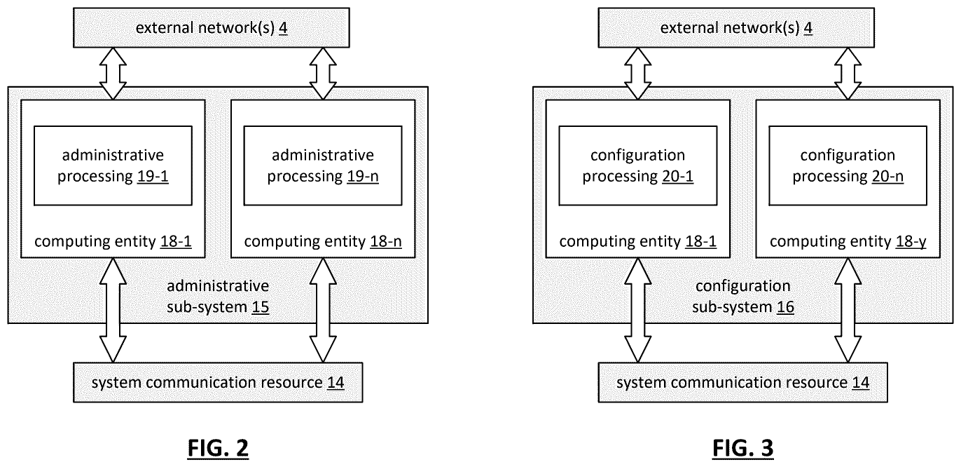

FIG. 2 is a schematic block diagram of an embodiment of an administrative sub-system that includes one or more computing devices. Each of the computing devices executes an administrative processing function (which includes a plurality of administrative operations) that coordinates system level operations of the database system. Each computing device is coupled to an external network, or networks, and to the system communication resources.

As will be described in greater detail with reference to one or more subsequent figures, a computing device includes a plurality of nodes and each node includes a plurality of processing core resources. Each processing core resource is capable of executing at least a portion of an administrative operation independently. This supports lock free and parallel execution of one or more administrative operations.

FIG. 3 is a schematic block diagram of an embodiment of a configuration sub-system that includes one or more computing devices. Each of the computing devices executes a configuration processing function (which includes a plurality of configuration operations) that coordinates system level configurations of the database system. Each computing device is coupled to an external network, or networks, and to the system communication resources.

As will be described in greater detail with reference to one or more subsequent figures, a computing device includes a plurality of nodes and each node includes a plurality of processing core resources. Each processing core resource is capable of executing at least a portion of an configuration operation independently. This supports lock free and parallel execution of one or more configuration operations.

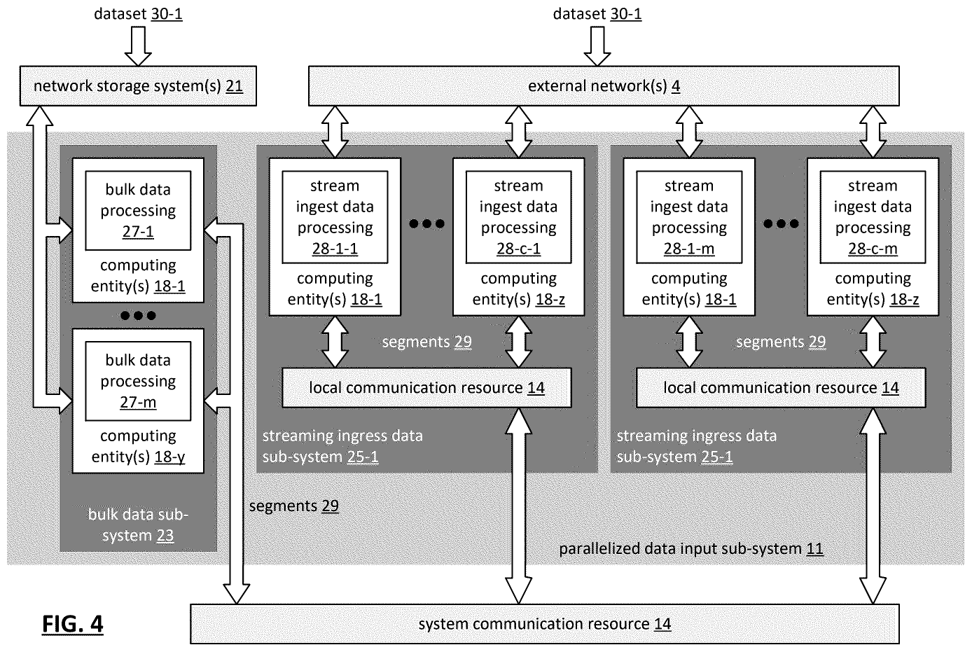

FIG. 4 is a schematic block diagram of an embodiment of a parallelized data input sub-system 11 that includes a bulk data sub-system 20 and a parallelized ingress sub-system 21. Each of the bulk data sub-system 20 and the parallelized ingress sub-system 21 includes a plurality of computing devices. The computing devices of the bulk data sub-system 20 execute a bulk data processing function to retrieve a table from a network storage system 23 (e.g., a server, a cloud storage service, etc.).

The parallelized ingress sub-system 21 includes a plurality of ingress data sub-systems that each include a plurality of computing devices. Each of the computing devices of the parallelized ingress sub-system 21 execute an ingress data processing function that enables the computing device to stream data of a table into the database system 10 from a wide area network 24. With a plurality of ingress data sub-systems, data from a plurality of tables can be streamed into the database system at one time.

Each of the bulk data processing function and the ingress data processing function generally function as described with reference to FIG. 1 for processing a table for storage. The bulk data processing function is geared towards retrieve data of a table in a bulk fashion (e.g., the table is stored and retrieved from storage). The ingress data processing function, however, is geared towards receiving streaming data from one or more data sources. For example, the ingress data processing function is geared towards receiving data from a plurality of machines in a factory in a periodic or continual manner as the machines create the data.

As will be described in greater detail with reference to one or more subsequent figures, a computing device includes a plurality of nodes and each node includes a plurality of processing core resources. Each processing core resource is capable of executing at least a portion of the bulk data processing function or the ingress data processing function. In an embodiment, a plurality of processing core resources of one or more nodes executes the bulk data processing function or the ingress data processing function to produce the storage format for the data of a table.

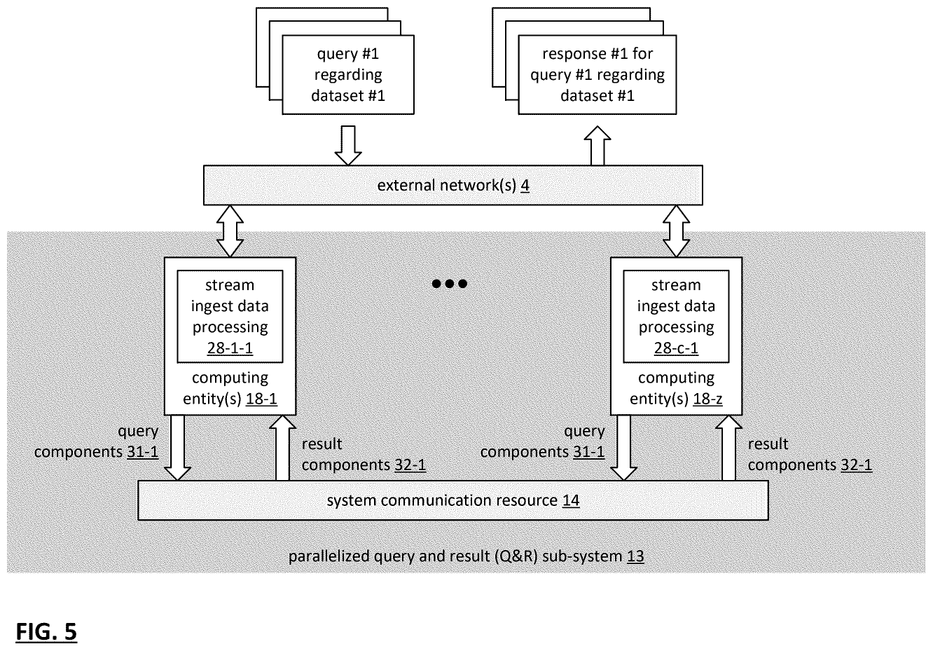

FIG. 5 is a schematic block diagram of an embodiment of a parallelized query and results sub-system 13 that includes a plurality of computing devices. Each of the computing devices executes a query (Q) & response (R) function. The computing devices are coupled to a wide area network 24 (e.g., cellular network, Internet, telephone network, etc.) to receive queries regarding tables and to provide responses to the queries.

The Q & R function enables the computing devices to processing queries and create responses as discussed with reference to FIG. 1. As will be described in greater detail with reference to one or more subsequent figures, a computing device includes a plurality of nodes and each node includes a plurality of processing core resources. Each processing core resource is capable of executing at least a portion of the Q & R function. In an embodiment, a plurality of processing core resources of one or more nodes executes the Q & R function to produce a response to a query.

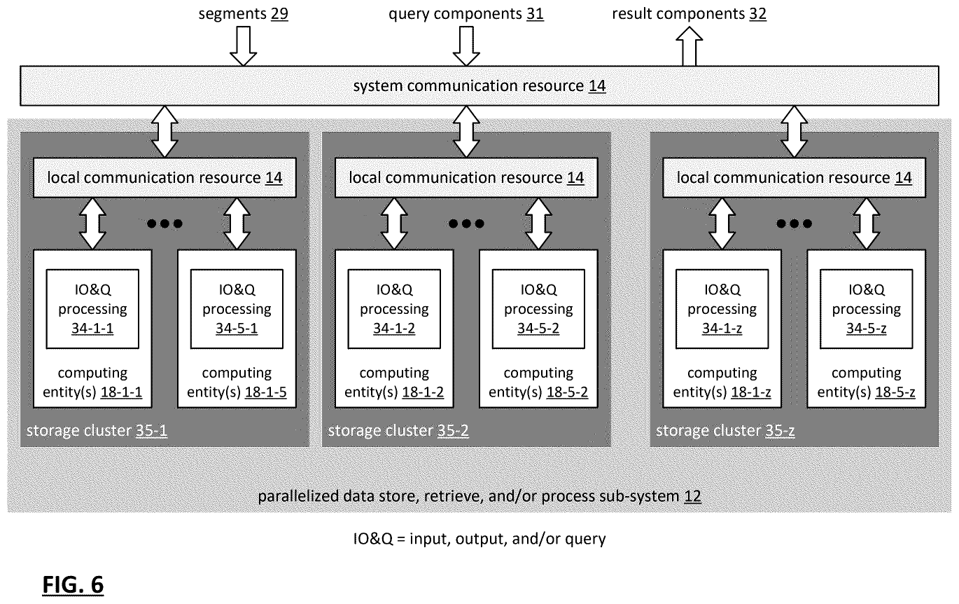

FIG. 6 is a schematic block diagram of an embodiment of a parallelized data store, retrieve, and/or process sub-system 12 that includes a plurality of storage clusters. Each storage cluster includes a plurality of computing devices and each computing device executes an input, output, and processing (IO &P) function to produce at least a portion of a resulting response. The number of computing devices in a cluster corresponds to the number of segments in which a data partitioned is divided. For example, if a data partition is divided into five segments, a storage cluster includes five computing devices. Each computing device then stores one of the segments.

As will be described in greater detail with reference to one or more subsequent figures, a computing device includes a plurality of nodes and each node includes a plurality of processing core resources. Each processing core resource is capable of executing at least a portion of the IO & P function. In an embodiment, a plurality of processing core resources of one or more nodes executes the IO & P function to produce at least a portion of the resulting response as discussed in FIG. 1.

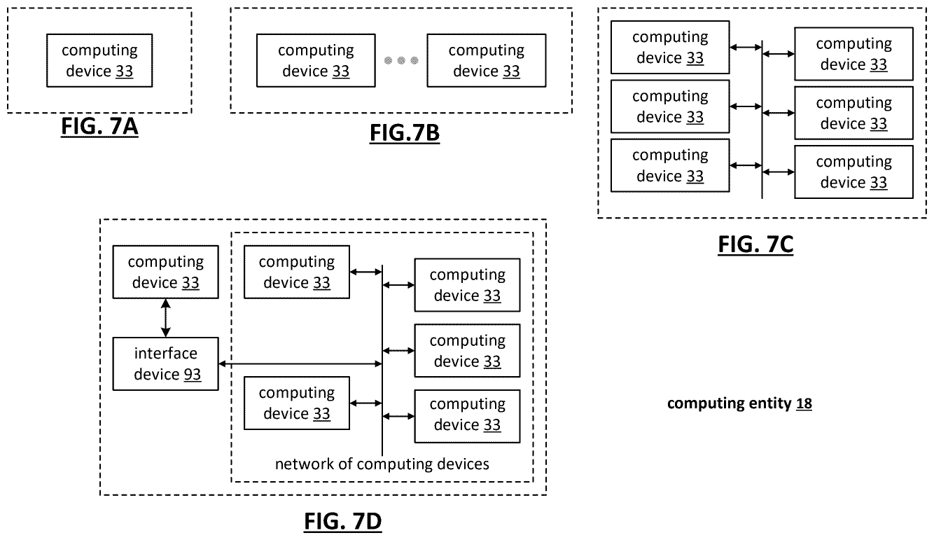

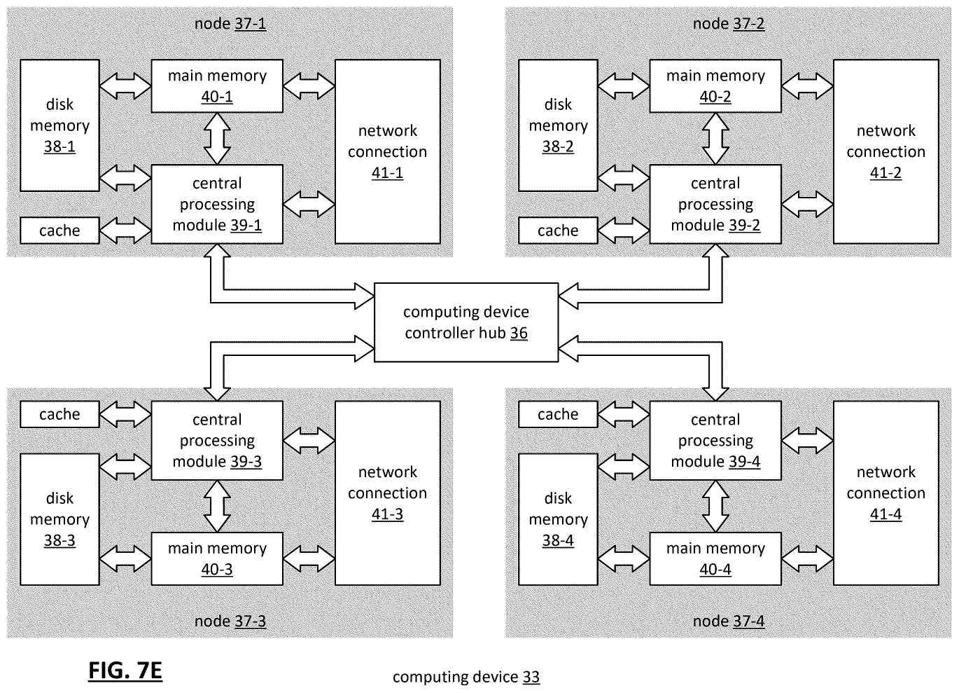

FIGS. 7A through 7D are schematic block diagrams of various embodiments of a computing entity 18. FIG. 7A is schematic block diagram of an embodiment of a computing entity 18 that includes a computing device 33 (e.g., one or more of the embodiments of FIGS. 7E-9G). A computing device may function as a user computing device, a server, a system computing device, a data storage device, a data security device, a networking device, a user access device, a cell phone, a tablet, a laptop, a printer, a game console, a satellite control box, a cable box, etc.

FIG. 7B is schematic block diagram of an embodiment of a computing entity 18 that includes two or more computing devices 33 (e.g., two or more from any combination of the embodiments of FIGS. 7E-9G). The computing devices 33 perform the functions of a computing entity in a peer processing manner (e.g., coordinate together to perform the functions), in a master-slave manner (e.g., one computing device coordinates and the other support it), and/or in another manner.

FIG. 7C is schematic block diagram of an embodiment of a computing entity 18 that includes a network of computing devices 33 (e.g., two or more from any combination of the embodiments of FIGS. 7E-9G). The computing devices are coupled together via one or more network connections (e.g., WAN, LAN, cellular data, WLAN, etc.) and perform the functions of the computing entity.

FIG. 7D is schematic block diagram of an embodiment of a computing entity 18 that includes a primary computing device (e.g., any one of the computing devices of FIGS. 7E-9G), an interface device 93 (e.g., a network connection), and a network of computing devices 33 (e.g., one or more from any combination of the embodiments of FIGS. 7E-9G). The primary computing device utilizes the other computing devices as co-processors to execute one or more the functions of the computing entity, as storage for data, for other data processing functions, and/or storage purposes.

FIG. 7E is a schematic block diagram of an embodiment of a computing device 33 that includes a plurality of nodes 37-1 through 37-4 coupled to a computing device controller hub 36. The computing device controller hub 36 includes one or more of a chipset, a quick path interconnect (QPI), and an ultra path interconnection (UPI). Each node 37-1 through 37-4 includes a central processing module 39-1 through 39-4, a main memory 40-1 through 40-4, a disk memory 38-1 through 38-4, and a network connection 41-1 through 41-4. In an alternate configuration, the nodes share a network connection, which is coupled to the computing device controller hub 36 or to one of the nodes.

In an embodiment, each node is capable of operating independently of the other nodes. This allows for large scale parallel operation of a query request, which significantly reduces processing time for such queries. In another embodiment, one or more node function as co-processors to share processing requirements of a particular function, or functions.

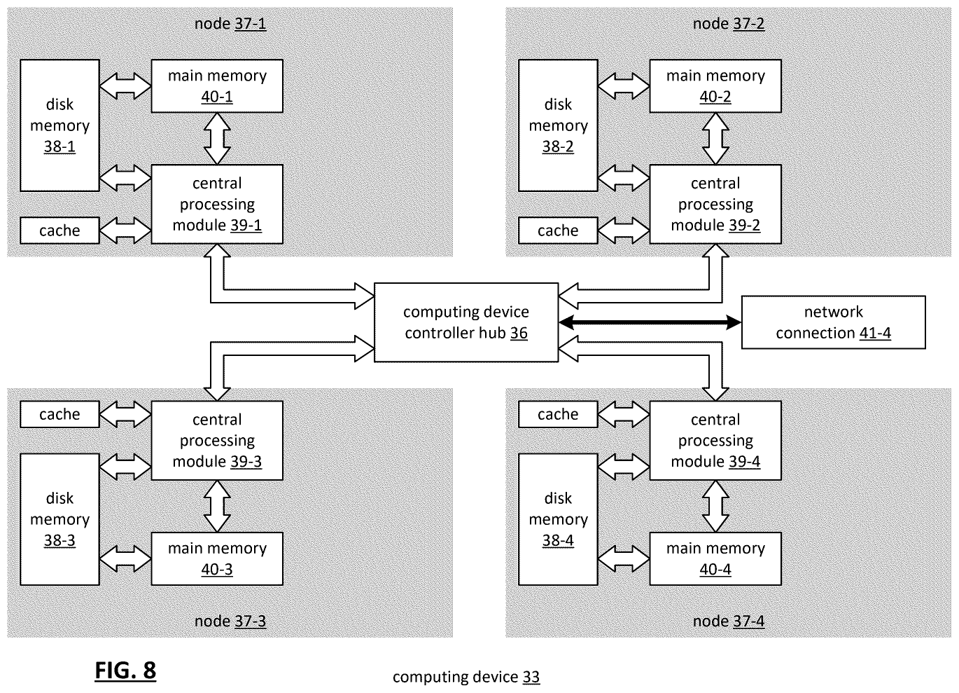

FIG. 8 is a schematic block diagram of another embodiment of a computing device 33 that is similar to the computing device of FIG. 7E with an exception that it includes a single network connection, which is coupled to the computing device controller hub. As such, each node coordinates with the computing device controller hub to transmit or receive data via the network connection.

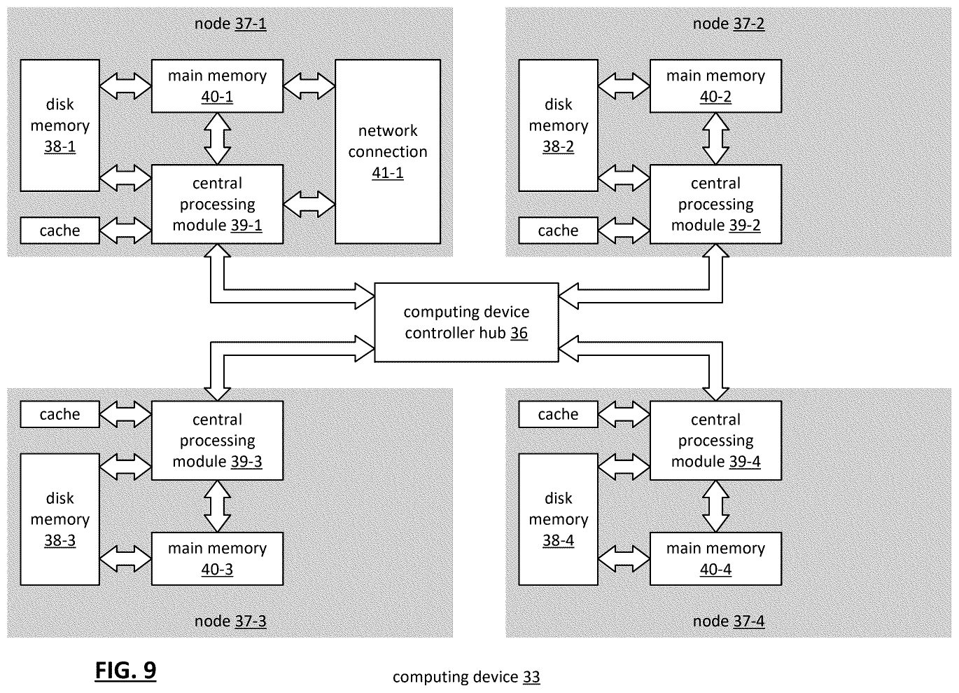

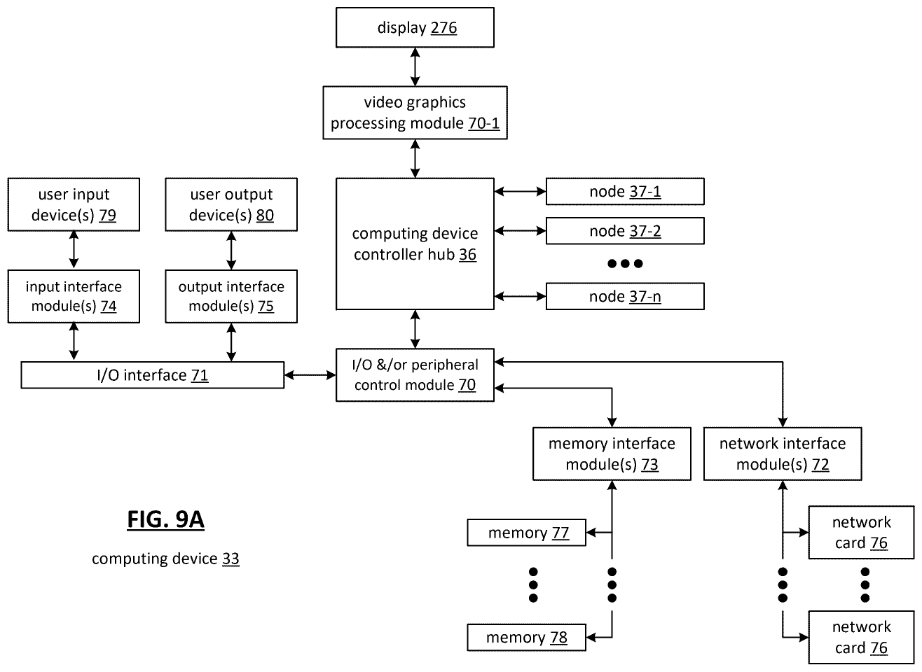

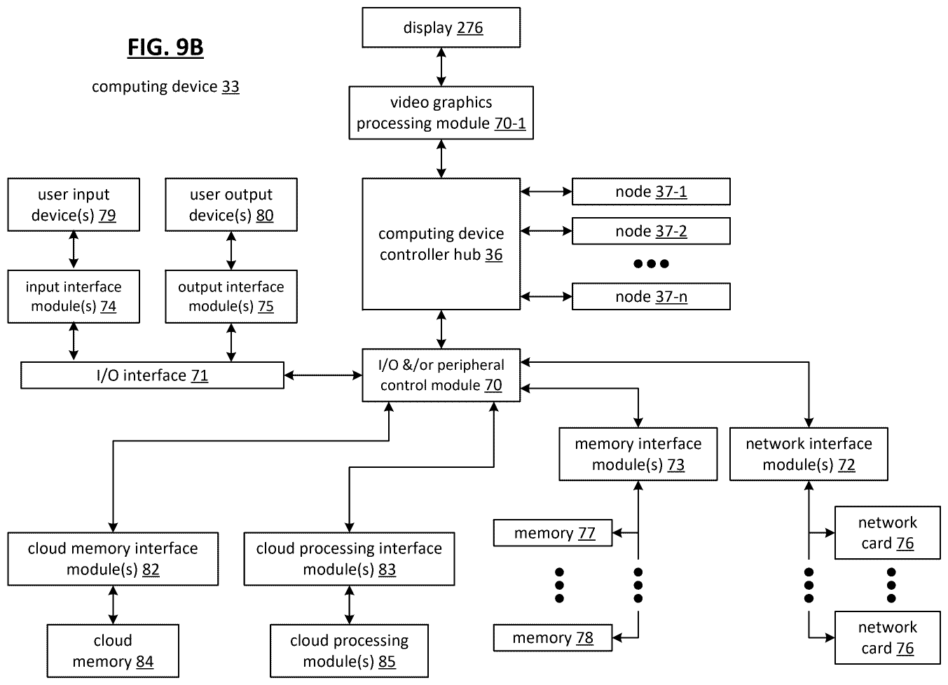

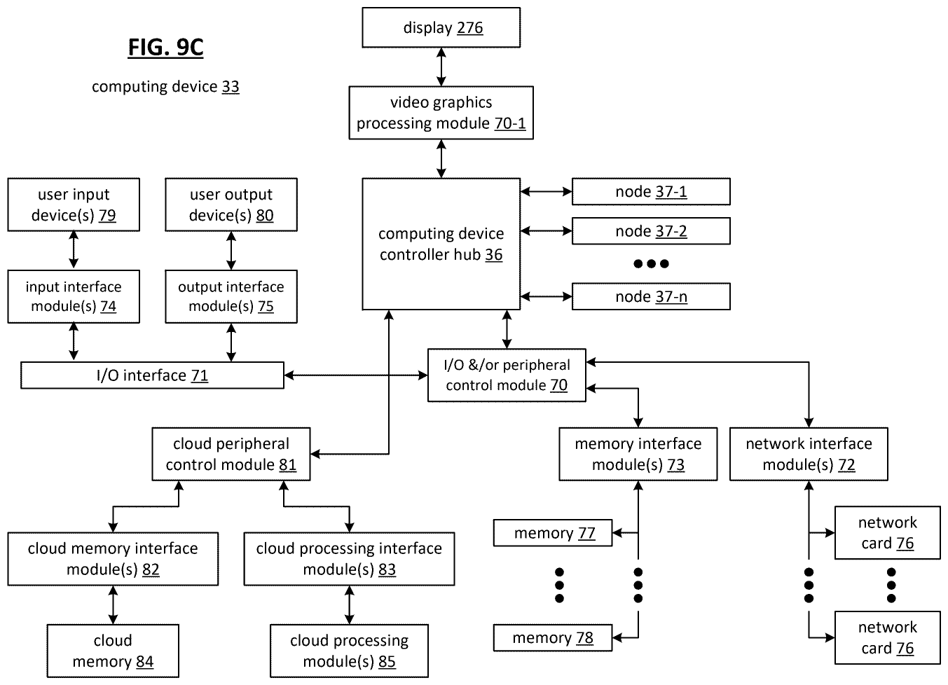

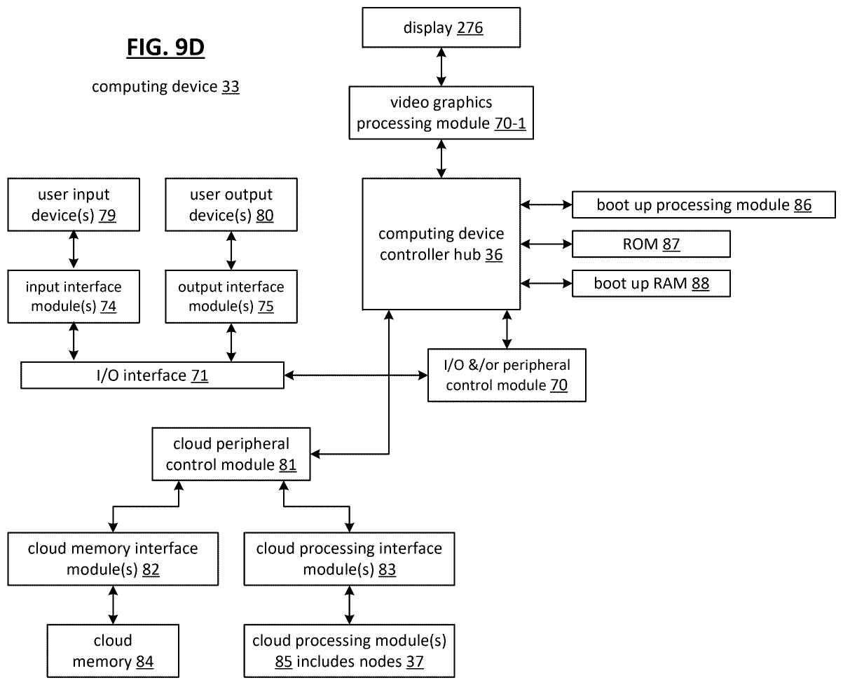

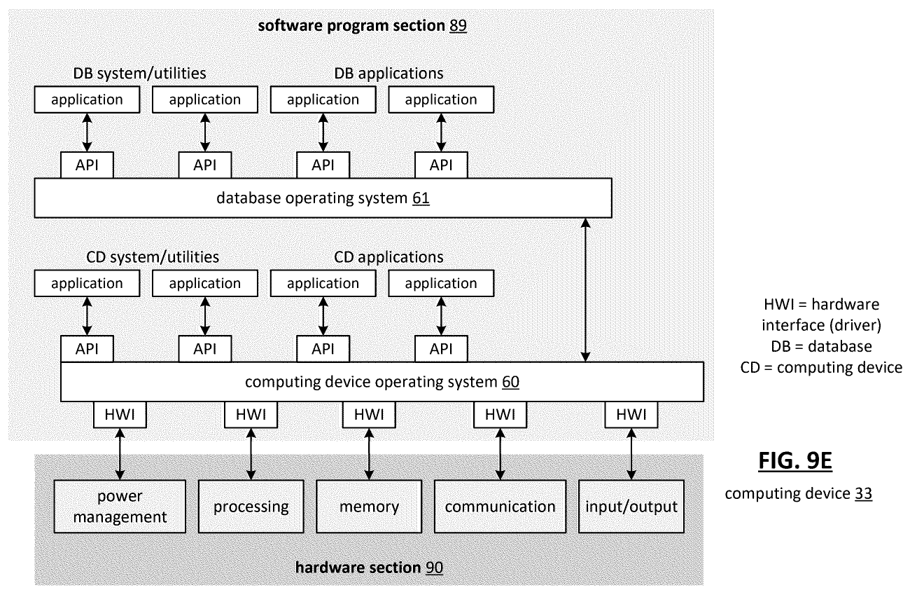

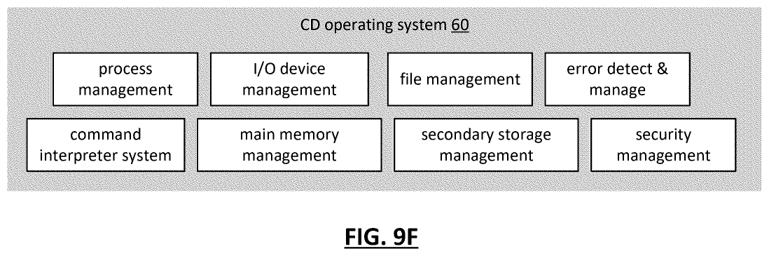

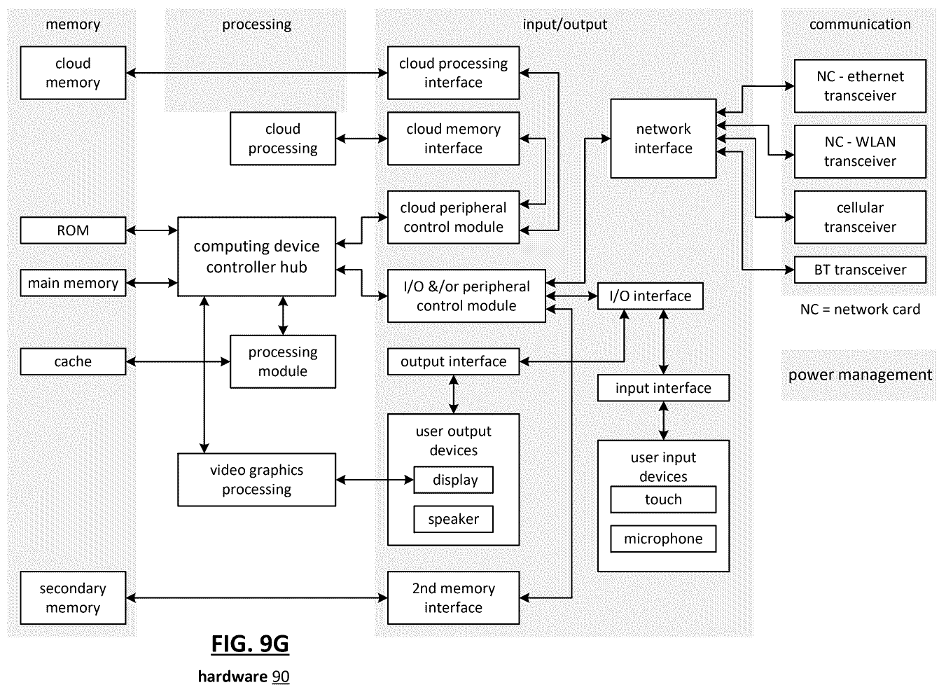

FIG. 9 is a schematic block diagram of another embodiment of a computing device 33 that is similar to the computing device of FIG. 7E with an exception that it includes a single network connection, which is coupled to a processing module of a node. As such, each node coordinates with the processing module via the computing device controller hub to transmit or receive data via the network connection.

FIGS. 9A-9G are schematic block diagrams of various embodiments of a computing device 33. FIG. 9A is a schematic block diagram of an embodiment of a computing device 33 that includes a plurality of computing resources. The computing resources, which form a computing core, include a computing device controller hub 36, a plurality of nodes 37-1 through 37-n, one or more video graphics processing modules 70-1, one or more displays 276 (optional), an Input-Output (I/O) peripheral control module 70, an I/O interface module 71 (which could be omitted if direct connect IO is implemented), one or more input interface modules 74, one or more output interface modules 75, one or more network interface modules 72, and one or more memory interface modules 73, one or more secondary memories 76-78, and one or more network cards 76.

A node of the plurality of nodes 37-1 through 37-n includes a plurality of processing core resources. Various embodiments of the plurality of nodes 37-1 through 37-n are discussed with reference to FIGS. 7H, 8, and 10-12. A processing core resource includes a main memory component (of a distributed main memory), a memory device (e.g., ROM, disk memory, etc.), a memory interface module, cache memory, and a processing module (e.g., a central processing module). Embodiments of processing core resources are discussed in more detail with reference to one or more of the subsequent figures.

A processing module is described in greater detail at the end of the detailed description section. In an alternate embodiment, the computing device controller hub 36 and the I/O and/or peripheral control module 70 are one module, such as a chipset, a quick path interconnect (QPI), and/or an ultra-path interconnect (UPI).

In this example, the nodes 37-1 through 37-n, computing device controller hub 36, and/or the video graphics processing module 70-1 form a processing core for a computing device. In other embodiments, the nodes include other components of the computing device. Computing resources 91 of FIGS. 9B-9G include one more of the components shown in this Figure and/or in or more of FIGS. 9B-9G.

The distributed main memory of the nodes 37-1 through 37-n includes one or more Random Access Memory (RAM) integrated circuits, or chips. In general, the main memory stores data and operational instructions most relevant for the nodes 37-1 through 37-n. For example, the computing device controller hub 36 coordinates the transfer of data and/or operational instructions between the main memory and the secondary memory device(s) 76-78. The data and/or operational instructions retrieve from secondary memory 76-78 are the data and/or operational instructions requested by the processing module or will most likely be needed by the processing module. When the processing module is done with the data and/or operational instructions in main memory, the computing device controller hub 36 coordinates sending updated data to the secondary memory 76-78 for storage.

The secondary memory 76-68 includes one or more hard drives, one or more solid state memory chips, and/or one or more other large capacity storage devices that, in comparison to cache memory and main memory devices, is/are relatively inexpensive with respect to cost per amount of data stored. The secondary memory 76-78 is coupled to the computing device controller hub 36 via the I/O and/or peripheral control module 70 and via one or more memory interface modules 73. In an embodiment, the I/O and/or peripheral control module 70 includes one or more Peripheral Component Interface (PCI) buses to which peripheral components connect to the computing device controller hub 36. A memory interface module 73 includes a software driver and a hardware connector for coupling a memory device to the I/O and/or peripheral control module 70. For example, a memory interface is in accordance with a Serial Advanced Technology Attachment (SATA) port.

The computing device controller hub 36 coordinates data communications between the nodes 37-1 through 37-n and network(s) via the I/O and/or peripheral control module 70, the network interface module(s) 72, and one or more network cards 76. A network card 76 includes a wireless communication unit or a wired communication unit. For example, a wireless communication unit includes a wireless local area network (WLAN) communication device, a cellular communication device, a Bluetooth device, and/or a ZigBee communication device. For example, a wired communication unit includes a Gigabit LAN connection, a Firewire connection, and/or a proprietary computer wired connection. A network interface module 76 includes a software driver and a hardware connector for coupling the network card to the I/O and/or peripheral control module 70. For example, the network interface module 72 is in accordance with one or more versions of IEEE 802.11, cellular telephone protocols, 10/100/1000 Gigabit LAN protocols, etc.

The computing device controller hub 36 coordinates data communications between the nodes 37-1 through 37-n and input device(s) 79 via the input interface module(s) 74, the I/O interface 71, and the I/O and/or peripheral control module 70. An input device 79 includes a keypad, a keyboard, control switches, a touchpad, a microphone, a camera, etc. An input interface module 74 includes a software driver and a hardware connector for coupling an input device to the I/O and/or peripheral control module 70. In an embodiment, an input interface module 74 is in accordance with one or more Universal Serial Bus (USB) protocols.

The computing device controller hub 36 coordinates data communications between the nodes 37-1 through 37-n and output device(s) 80 via the output interface module(s) 75 and the I/O and/or peripheral control module 70. An output device 80 includes a speaker, auxiliary memory, headphones, etc. An output interface module 75 includes a software driver and a hardware connector for coupling an output device to the I/O and/or peripheral control module 70. In an embodiment, an output interface module 75 is in accordance with one or more audio codec protocols.

The nodes 37-1 through 37-n communicate directly with a video graphics processing module 70-1 to display data on the display 276. The display 276 includes an LED (light emitting diode) display, an LCD (liquid crystal display), and/or other type of display technology. The display has a resolution, an aspect ratio, and other features that affect the quality of the display. The video graphics processing module 70-1 receives data from the nodes 37-1 through 37-n, processes the data to produce rendered data in accordance with the characteristics of the display, and provides the rendered data to the display 276.

FIG. 9B is a schematic block diagram of an embodiment of a computing device 33 that includes a plurality of computing resources similar to the computing resources of FIG. 9A with the addition of one or more cloud memory interface modules 82, one or more cloud processing interface modules 83, cloud memory 84, and one or more cloud processing modules 85. The cloud memory 84 includes one or more tiers of memory (e.g., ROM, volatile (RAM, main, etc.), non-volatile (hard drive, solid-state, etc.) and/or backup (hard drive, tape, etc.)) that is remoted from the computing device controller hub 36 and is accessed via a network (WAN and/or LAN). The cloud processing module 85 is similar to a processing module of nodes 37-1 through 37-n but is remoted from the computing device controller hub 36 and is accessed via a network.

FIG. 9C is a schematic block diagram of an embodiment of a computing device 33 that includes a plurality of computing resources similar to the computing resources of FIG. 9B with a change in how the cloud memory interface module(s) 82 and the cloud processing interface module(s) 83 are coupled to computing device controller hub 36. In this embodiment, the interface modules 82 and 83 are coupled to a cloud peripheral control module 81 that directly couples to the computing device controller hub 36.

FIG. 9D is a schematic block diagram of an embodiment of a computing device 33 that includes a plurality of computing resources, which includes include a computing device controller hub 36, a boot up processing module 86, boot up RAM 88, a read only memory (ROM) 87, one or more video graphics processing modules 70-1, one or more displays 276 (optional), an Input-Output (I/O) peripheral control module 70, one or more input interface modules 74, one or more output interface modules 75, one or more cloud memory interface modules 82, one or more cloud processing interface modules 83, cloud memory 84, and cloud processing module(s) 85.

In this embodiment, the cloud processing modules include the nodes 37-1 through 37-n of previous figures. The computing device 33 includes enough processing resources (e.g., processing module 86, ROM 87, and RAM 88) to boot up. Once booted up, the cloud memory 84 and the cloud processing module(s) 83 along with nodes 37-1 through 37-n function as the computing device's memory (e.g., main and hard drive) and processing module.

FIG. 9E is a schematic block diagram of another embodiment of a computing device 33 that includes a hardware section 90 and a software program section 89. The hardware section 90 includes the hardware functions of power management, processing, memory, communications, and input/output. FIG. 9G illustrates the hardware section 90 in greater detail.

The software program section 89 includes a database operating system 61, database system and/or utilities applications, and database applications. The software program section 89 further includes a computing device operating system 60, computing device system and/or utilities applications, and computing device applications. The software program section further includes APIs and HWIs. APIs (application programming interface) are the interfaces between the system and/or utilities applications and the operating system and the interfaces between the applications and the operating system. HWIs (hardware interface) are the interfaces between the hardware components and the operating system. For some hardware components, the HWI is a software driver. The functions of the operating system are discussed in greater detail with reference to FIG. 9F.

FIG. 9F is a diagram of an example of the functions of the computing device operating system of a computing device 33. In general, the operating system function to identify and route input data to the right places within the computer and to identify and route output data to the right places within the computer. Input data is with respect to the processing module and includes data received from the input devices, data retrieved from main memory, data retrieved from secondary memory, and/or data received via a network card. Output data is with respect to the processing module and includes data to be written into main memory, data to be written into secondary memory, data to be displayed via the display and/or an output device, and data to be communicated via a network care.

The operating system includes the OS functions of process management, command interpreter system, I/O device management, main memory management, file management, secondary storage management, error detection & correction management, and security management. The process management OS function manages processes of the software section operating on the hardware section, where a process is a program or portion thereof.

The process management OS function includes a plurality of specific functions to manage the interaction of software and hardware. The specific functions include;
load a process for execution;
enable at least partial execution of a process;
suspend execution of a process;
resume execution of a process;
terminate execution of a process;
load operational instructions and/or data into main memory for a process;
provide communication between two or more active processes;
avoid deadlock of a process and/or interdependent processes; and
control access to shared hardware components.

The I/O Device Management OS function coordinates translation of input data into programming language data and/or into machine language data used by the hardware components and translation of machine language data and/or programming language data into output data. Typically, input devices and/or output devices have an associated driver that provides at least a portion of the data translation. For example, a microphone captures analog audible signals and converts them into digital audio signals per an audio encoding format. An audio input driver converts, if needed, the digital audio signals into a format that is readily usable by a hardware component.

The File Management OS function coordinates the storage and retrieval of data as files in a file directory system, which is stored in memory of the computing device. In general, the file management OS function includes the specific functions of;
File creation, editing, deletion, and/or archiving;
Directory creation, editing, deletion, and/or archiving;
Memory mapping files and/or directors to memory locations of secondary memory; and
Backing up of files and/or directories.

The Network Management OS function manages access to a network by the computing device. Network management includes
Network fault analysis;
Network maintenance for quality of service;
Network access control among multiple clients; and
Network security upkeep.

The Main Memory Management OS function manages access to the main memory of a computing device. This includes keeping track of memory space usage and which processes are using it: allocating available memory space to requesting processes; and deallocating memory space from terminated processes.

The Secondary Storage Management OS function manages access to the secondary memory of a computing device. This includes free memory space management, storage allocation, disk scheduling, and memory defragmentation.

The Security Management OS function protects the computing device from internal and external issues that could adversely affect the operations of the computing device. With respect to internal issues, the OS function ensures that processes negligibly interfere with each other: ensures that processes are accessing the appropriate hardware components, the appropriate files, etc.; and ensures that processes execute within appropriate memory spaces (e.g., user memory space for user applications, system memory space for system applications, etc.).

The security management OS function also protects the computing device from external issues, such as, but not limited to, hack attempts, phishing attacks, denial of service attacks, bait and switch attacks, cookie theft, a virus, a trojan horse, a worm, click jacking attacks, keylogger attacks, eavesdropping, waterhole attacks, SQL injection attacks, and DNS spoofing attacks.

FIG. 9G is a schematic block diagram of the hardware components of the hardware section 90 of a computing device. The memory portion of the hardware section includes the ROM, the main memory, the cache memory, the cloud memory, and the secondary memory. The processing portion of the hardware section includes the computing device controller hub, the processing modules (e.g., of the nodes), the video graphics processing module, and the cloud processing module.

The input/output portion of the hardware section includes the cloud peripheral control module, the I/O and/or peripheral control module, the network interface module, the I/O interface module, the output device interface, the input device interface, the cloud memory interface module, the cloud processing interface module, and the secondary memory interface module. The IO portion further includes input devices such as a touch screen, a microphone, and switches. The IO portion also includes output devices such as speakers and a display.

The communication portion includes an ethernet transceiver network card (NC), a WLAN network card, a cellular transceiver, a Bluetooth transceiver, and/or any other device for wired and/or wireless network communication.

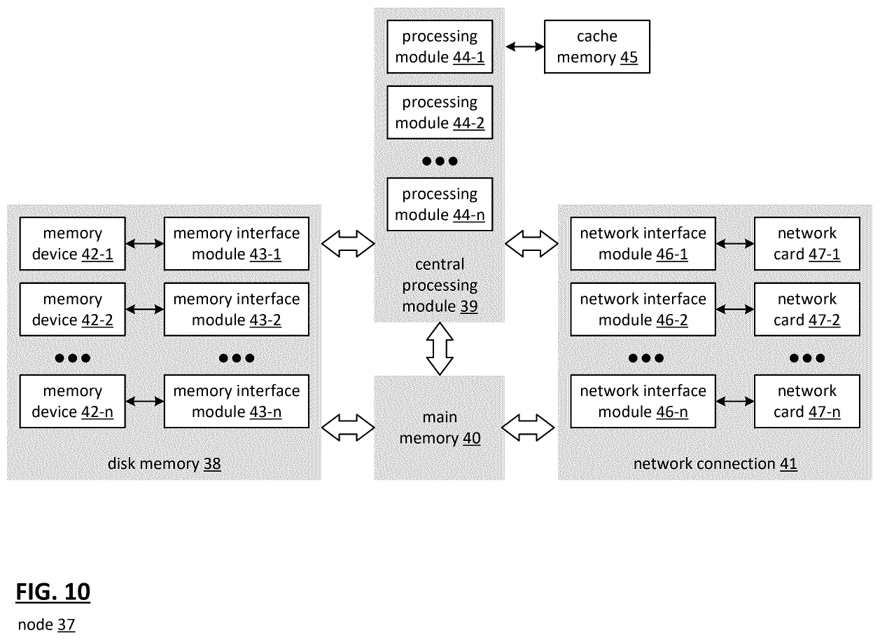

FIG. 10 is a schematic block diagram of an embodiment of a node 37 of computing device 33. The node 37 includes the central processing module 39, the main memory 40, the disk memory 38, and the network connection 41. The main memory 40 includes read only memory (RAM) and/or other form of volatile memory for storage of data and/or operational instructions of applications and/or of the operating system. The central processing module 39 includes a plurality of processing modules 44-1 through 44-n one or more cache memory 45. A processing module is as defined at the end of the detail description.

The disk memory 38 includes a plurality of memory interface modules 43-1 through 43-n and a plurality of memory devices 42-1 through 42-n. The memory devices 42-1 through 42-n include, but are not limited to, solid state memory, disk drive memory, cloud storage memory, and other non-volatile memory. For each type of memory device, a different memory interface module 43-1 through 43-n is used. For example, solid state memory uses a standard, or serial, ATA (SATA), variation, or extension thereof, as its memory interface. As another example, disk drive memory devices use a small computer system interface (SCSI), variation, or extension thereof, as its memory interface.

In an embodiment, the disk memory 38 includes a plurality of solid state memory devices and corresponding memory interface modules. In another embodiment, the disk memory 38 includes a plurality of solid state memory devices, a plurality of disk memories, and corresponding memory interface modules.

The network connection 41 includes a plurality of network interface modules 46-1 through 46-n and a plurality of network cards 47-1 through 47-n. A network card 47-1 through 47-n includes a wireless LAN (WLAN) device (e.g., an IEEE 802.11n or another protocol), a LAN device (e.g., Ethernet), a cellular device (e.g., CDMA), etc. The corresponding network interface module 46-1 through 46-n includes the software driver for the corresponding network card and a physical connection that couples the network card to the central processing module or other component(s) of the node.

The connections between the central processing module 39, the main memory 40, the disk memory 38, and the network connection 41 may be implemented in a variety of ways. For example, the connections are made through a node controller (e.g., a local version of the computing device controller hub). As another example, the connections are made through the computing device controller hub.

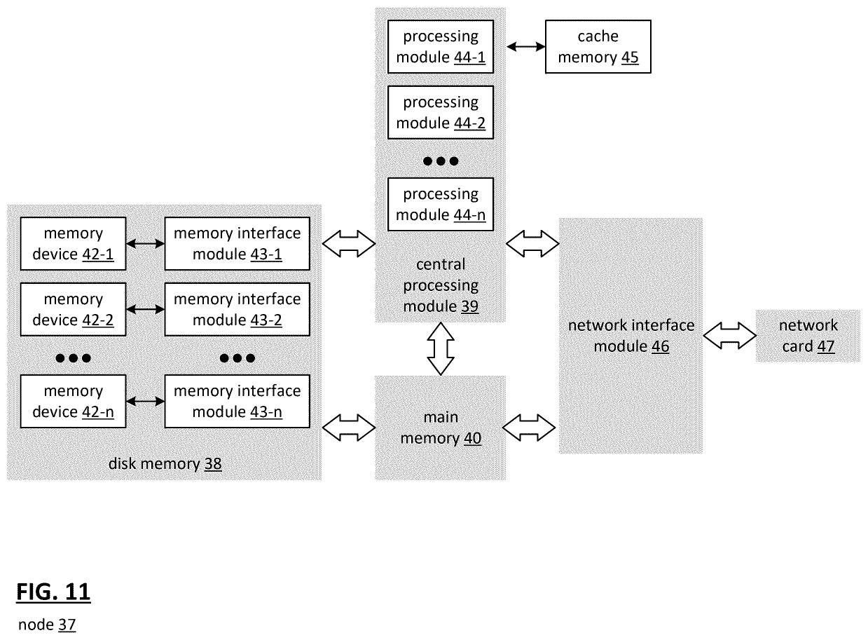

FIG. 11 is a schematic block diagram of an embodiment of a node of a computing device that is similar to the node of FIG. 10, with a difference in the network connection. In this embodiment, the node includes a single network interface module-network card configuration.

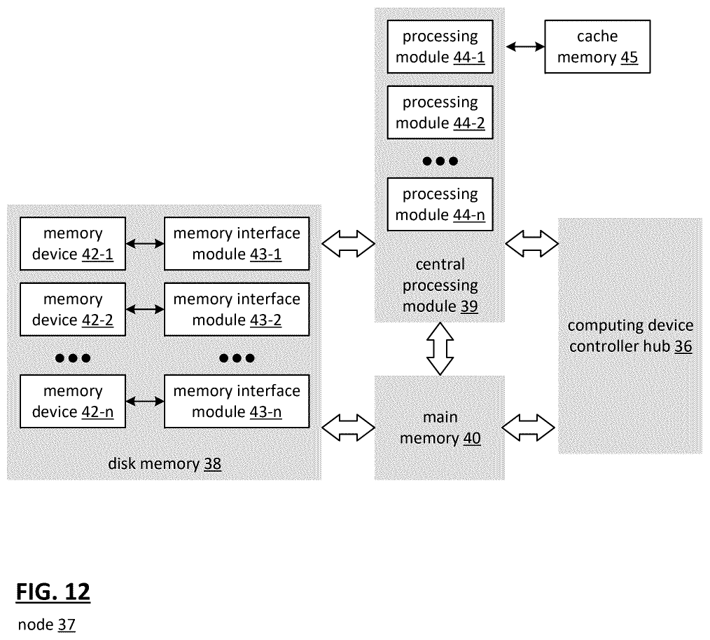

FIG. 12 is a schematic block diagram of an embodiment of a node of a computing device that is similar to the node of FIG. 10, with a difference in the network connection. In this embodiment, the node connects to a network connection via the computing device controller hub.

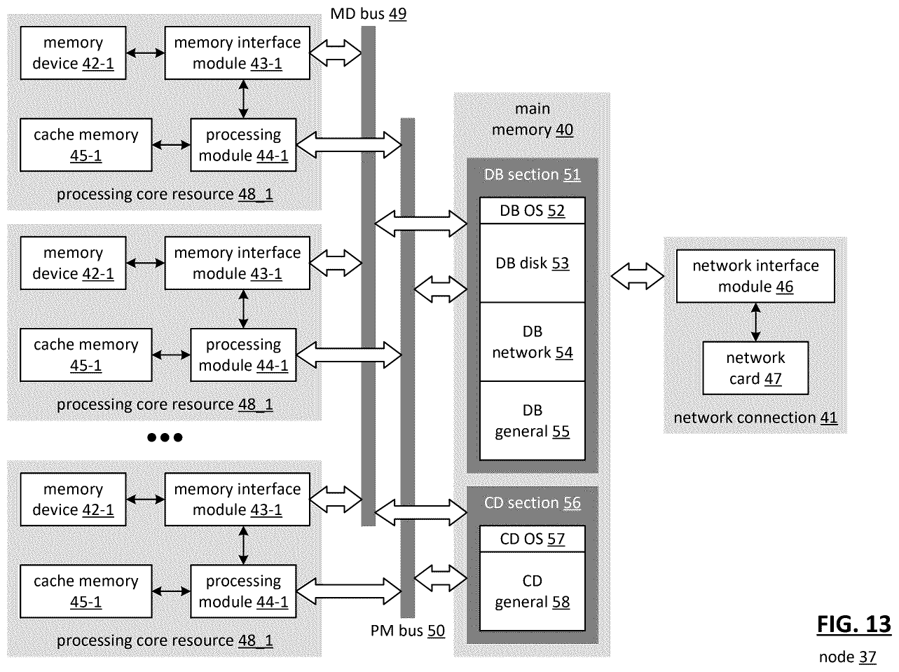

FIG. 13 is a schematic block diagram of another embodiment of a node 37 of computing device 33.

The components of the node are arranged into processing core resources 48_1. Each processing core resource includes a processing module 44-1, a memory interface module(s) 43-1, memory device(s) 42-1, and cache memory 45-1 In this configuration, each processing core resource can operate independently of the other processing core resources. This further supports increased parallel operation of database functions to further reduce execution time.

The main memory is divided into a computing device (CD) section and a database (DB) section. The database section includes a database operating system (OS) area, a disk area, a network area, and a general area. The computing device section includes a computing device operating system (OS) area and a general area. Note that each section could include more or less allocated areas for various tasks being executed by the database system.

In general, the database OS allocates main memory for database operations. Once allocated, the computing device OS cannot access that portion of the main memory. This supports lock free and independent parallel execution of one or more operations.

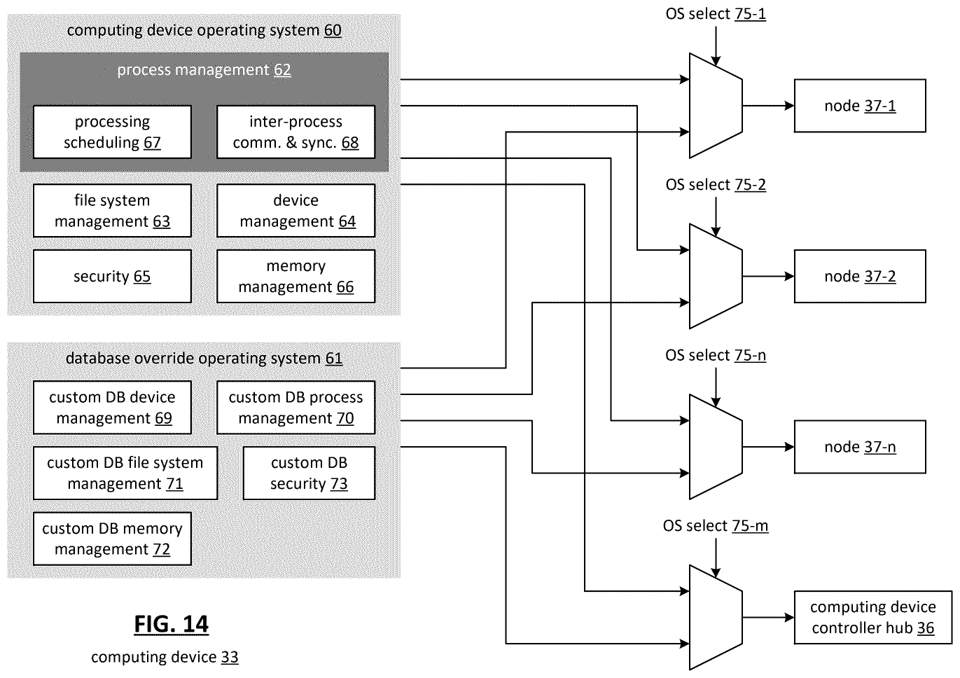

FIG. 14 is a schematic block diagram of an embodiment of operating systems of a computing device. The computing device includes a computing device operating system (CD OS) 60 and a database overriding operating system (DB OS) 61. The computing device OS 60 includes process management 62, file system management 63, device management 64, memory management 66, and security 65. The processing management 62 generally includes process scheduling 67 and inter-process communication and synchronization 68. In general, the computing device OS 60 is a conventional operating system used by a variety of types of computing devices. For example, the computing device operating system is a personal computer operating system, a server operating system, a tablet operating system, a cell phone operating system, etc.

The database operating system (DB OS) 61 includes custom DB device management 69, custom DB process management 70 (e.g., process scheduling and/or inter-process communication & synchronization), custom DB file system management 71, custom DB memory management 72, and/or custom security 73. In general, the database OS 61 provides hardware components of a node more direct access to memory, more direct access to a network connection, improved independency, improved data storage, improved data retrieval, and/or improved data processing than the computing device OS.

In an example of operation, the database OS 61 controls which operating system, or portions thereof, operate with each node and/or computing device controller hub of a computing device. For example, device management of a node is supported by the computing device operating system, while process management, memory management, and file system management are supported by the database operating system. To override the computing device OS, the database OS provides instructions to the computing device OS regarding which management tasks will be controlled by the database OS. The database OS also provides notification to the computing device OS as to which sections of the main memory it is reserving exclusively for one or more database functions, operations, and/or tasks. One or more examples of the database operating system are provided in subsequent figures.

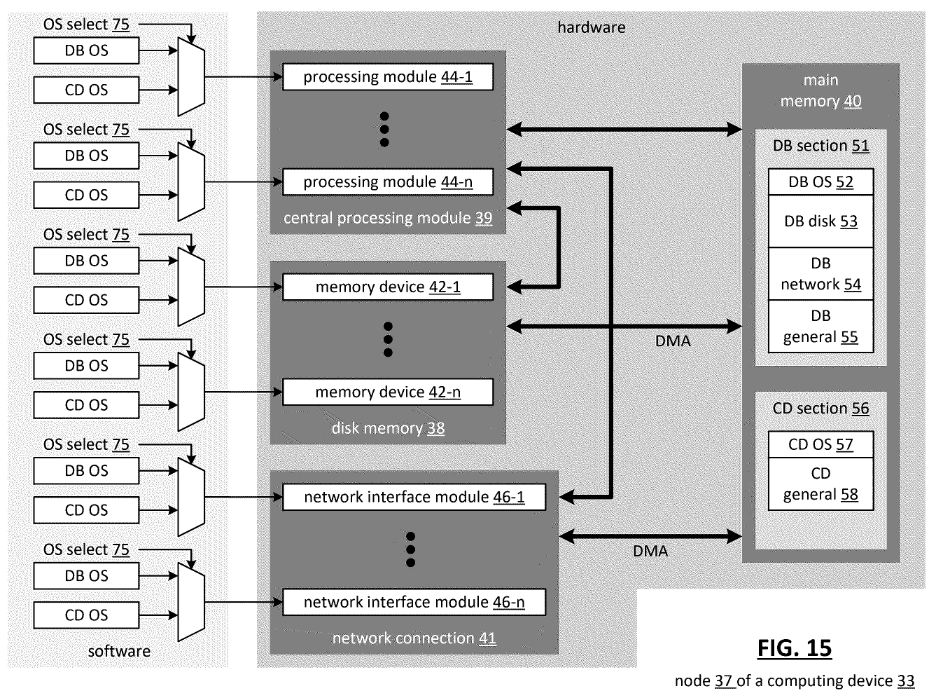

FIG. 15 is a schematic block diagram of an embodiment of operating systems for a node 37 of a computing device 33. A node 37 of a computing device 33 includes hardware and software architectures. The software architecture includes a computing device operating system (CD OS), a database operating system (DB OS), and a plurality of software applications (not shown). The hardware architecture includes disk memory 38, a centralized processing module unit (CPM) 39, main memory (which is shared by the nodes of the computing device) 40, and a network connection (which could be dedicated to the node or shared by the nodes of the computing device) 41.

The disk memory 38 includes a plurality of disks (e.g., memory devices 42-1 through 42-n). A memory device is a non-volatile memory of a variety of forms. For example, a memory device is a solid-state memory such as random access memory (RAM) and/or flash memory (NAND or NOR flash). The centralized processing module unit (CPM) 39 includes a plurality of processing modules 44-1 through 44-n. A processing module is defined at the end of the detailed description section. If the node includes its own network connection 41, the network connection 41 includes one or more network interfaces 46-1 through 46-n and corresponding network cards (which are not shown).

Within the hardware section of a node, the centralized processing module unit (CPM) 39 has direct connections with the disk memory 38, with the main memory 40, and with the network connection 41. Also within the hardware section, each of the disk memory 38 and network connection 41 has direct memory access (DMA) with the main memory 40.

The software architecture allows individual selection of which operating system to use for the centralized processing module unit (CPM), the disk memory, and/or the network connection. Further, within each of these hardware sections, the desired operating system is selectable at the component level. For example, a first processing module uses the computing device operating system (CD OS) and a second processing module uses the database operating system (DB OS).

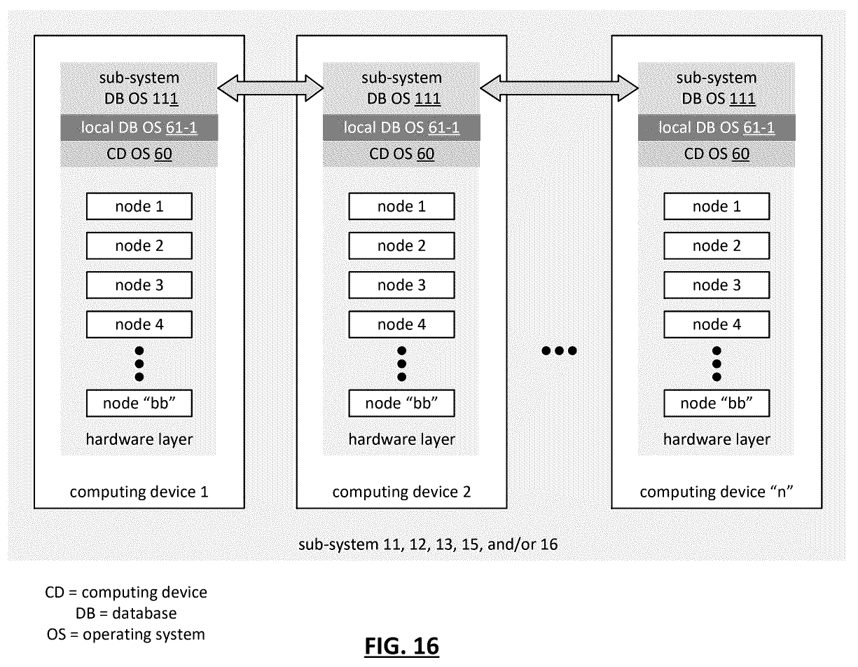

FIG. 16 is a schematic block diagram of an embodiment of operating systems of a sub-system of the database system. The sub-system (e.g., the parallelized data input sub-system, the parallelized store, retrieve, and/or process sub-system, the parallelized query & results sub-system, the administrative sub-system, and/or the configuration sub-system) includes a plurality of computing devices. Each computing device includes a hardware (HW) layer that includes a plurality of nodes and a software layer. The software layer includes the computing device operating system (CD OS), a local database operating system (DB OS), and a sub-system database operating system (DB OS).

The interaction action between the hardware layer, the computing device operating system (CD OS), and the local database operating system (DB OS) was generally described with reference to FIG. 15. The sub-system database operating system (DB OS) resides within one or more of the computing devices to provide sub-system level operating system functionality of one or more of file system management, device management, process management (e.g., process scheduling and/or inter-process communication and synchronization), memory management, and/or security.

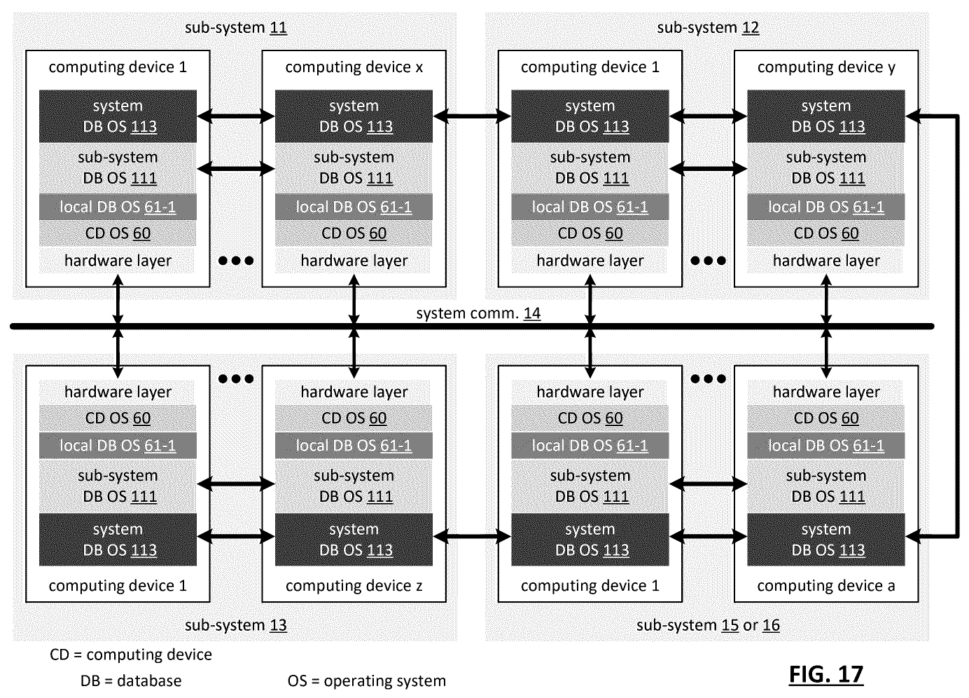

FIG. 17 is a schematic block diagram of an embodiment of operating systems of the database system that includes a plurality of sub-systems (e.g., the parallelized data input sub-system, the parallelized store, retrieve, and/or process sub-system, the parallelized query & results sub-system, the administrative sub-system, and/or the configuration sub-system). Each sub-system includes a plurality of computing devices (CD) and each computing device includes the hardware layer and the software layer of FIG. 16 with the addition of a system level database operating system.

The system database operating system (DB OS) resides within one or more of the computing devices of one or more of the sub-systems to provide system level operating system functionality of one or more of file system management, device management, process management (e.g., process scheduling and/or inter-process communication and synchronization), memory management, and/or security.

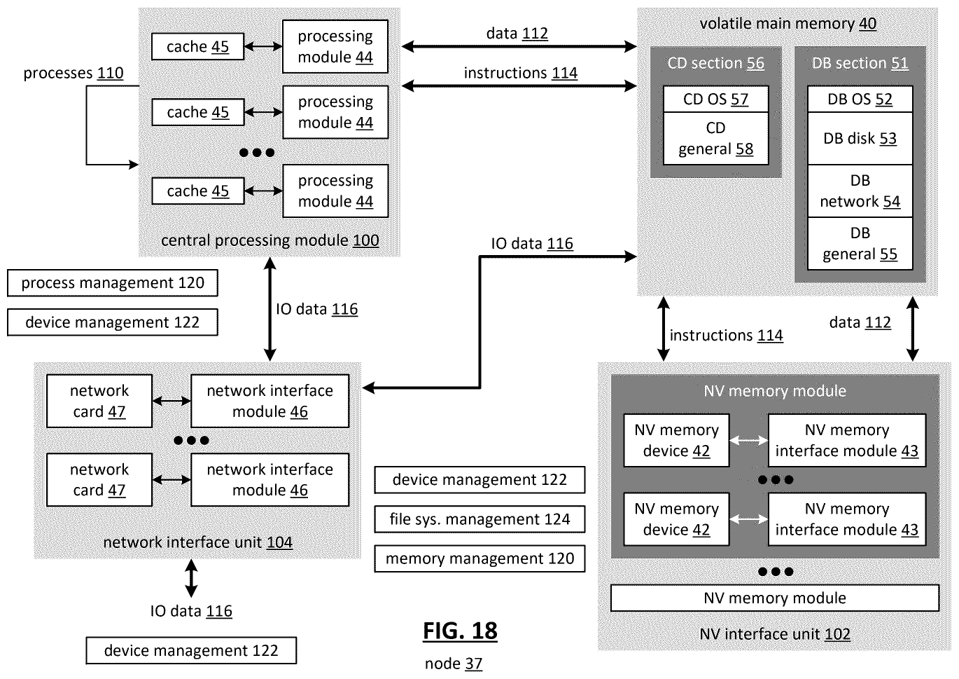

FIG. 18 is a logic diagram of an example of processing a table or data set for storage in the database system that begins at step 101 where a processing core resource, a node, a computing device, or devices, (hereinafter for this figure referred to as a computing node) of the parallelized data input sub-system receives a data set (e.g., a table). The method continues at step 103 where the computing node determines whether to partition the data set.

If yes, the method continues at step 107 where the computing node ascertains partitioning parameters (e.g., one or more of segment size, number of computing devices in a cluster, number of nodes, number of processing core resources, data block size, memory formatting, network formatting, query probabilities (how the data will need to be sorted, retrieved, and/or processed for queries), etc.). The method continues at step 109 where the computing node partitions the data set into a plurality of data partitions in accordance with the partitioning parameters.

If not partitioning the data set (e.g., a table), then the method continues at step 105 where the computing node treats the data set as one data partition. The method continues from step 105 and from step 109 at step 111 where the computing node determines a number of segments in a segment group for each data partition. For example, the number of segments is based on a coding scheme for encoding the data set before storage. As a specific example, when the coding scheme is parity encoding of four data pieces, then five pieces are created (e.g., four for the data pieces and one for the parity piece) and the number of segments in a group is five.

The method continues at step 115 where the computing node determines a number of segments groups to be created for each data partition based on one or more of a variety of factors. The factors include, but are not limited to, data block size, number of processing core resources available, number of nodes available, number of computing devices available, number of storage clusters, etc. The method continues at step 117 where the computing node divides a data partition into raw segments for each segment group.

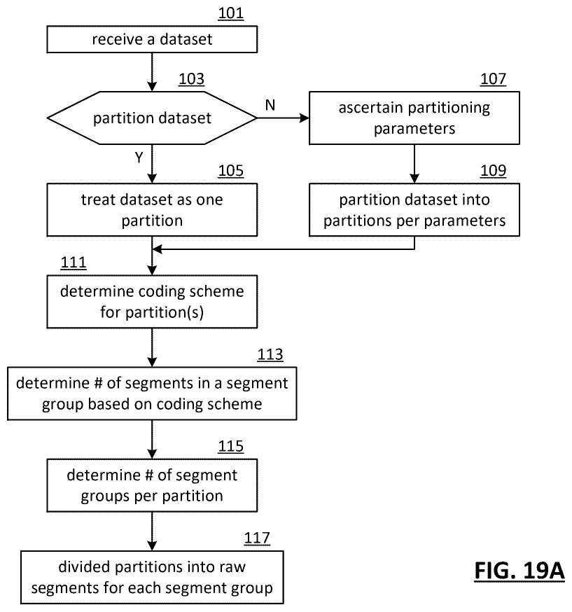

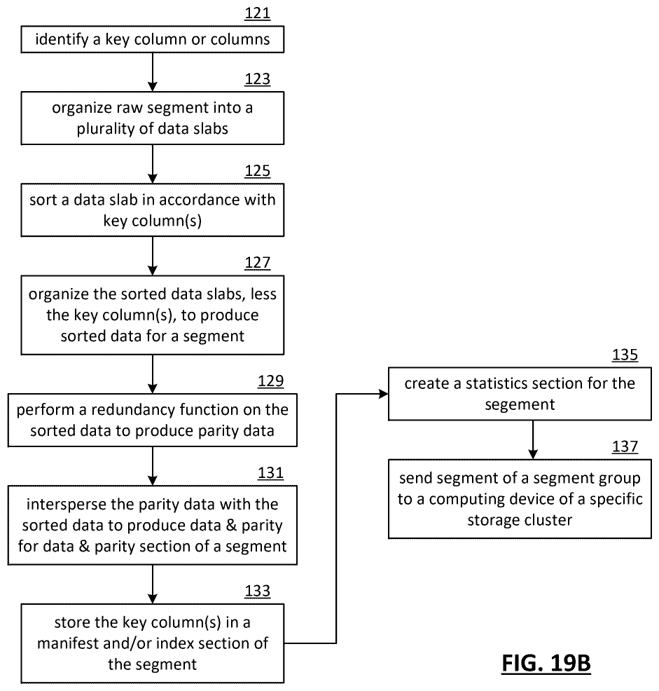

FIG. 19 is a logic diagram of an example of processing a raw data segment of a table or data set for storage in the database system that begins at step 121 where a processing core resource, a node, a computing device, or devices, (hereinafter for this figure referred to as a computing node) of the parallelized data input sub-system receives a data set (e.g., a table). The method continues at step 123 where the computing node organizes the raw (e.g., unsorted, uncompressed, and/or unprocessed) data segment into a plurality of data slabs. For example, a data slab corresponds to a column of a table.

The method continues at step 125 where the computing node sorts a data slab in accordance with one or more key columns (i.e., one or more selected columns of the table used to sort the data slab). The method continues at step 127 where the computing node organizes the sorted data slabs, less the key column(s), to produce a plurality of sorted data slabs (i.e., a sorted data segment).

The method continues at step 129 where the computing node performs a redundancy function (e.g., parity, RAID 5, RAID 6, RAID 10, erasure encoding, etc.) on the sorted data segment to produce parity data. The method continues at step 131 where the computing node intersperses the parity data with the sorted data to produce data & parity of a data & parity section of a segment. The method continues at step 133 where the computing node stores the key column(s) in a manifest and/or an index section of the segment. The manifest section stores metadata of the data and/or parity of the data & parity section of the segment.

The method continues at step 135 where the computing node creates a statistics sections for the segment for storing statistical information regarding the segment. For example, the statistics section stores number of rows in a table, number of rows in a data slab, average length of a variable length column, average row length, etc. The method continues at step 137 where the computing node sends the segment of a segment group to a computing device of a specific storage cluster.

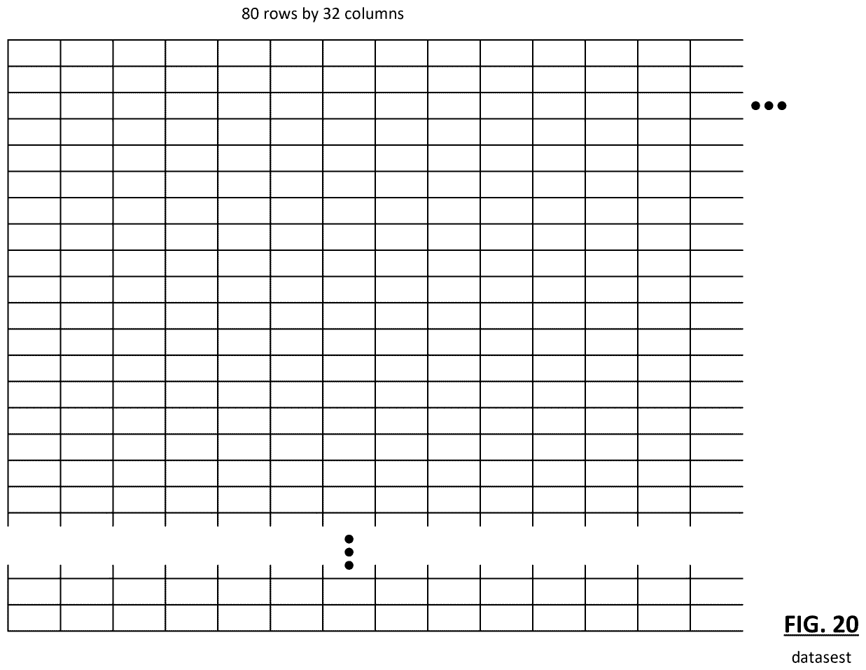

FIGS. 20-29 are schematic block diagrams of an example of processing a table or data set for storage in the database system. FIG. 20 illustrates an example of a data set or table that includes 32 columns and 80 rows, or records, that is received by the parallelized data input-subsystem. This is a very small table, but is sufficient for illustrating one or more concepts regarding one or more aspects of a database system.

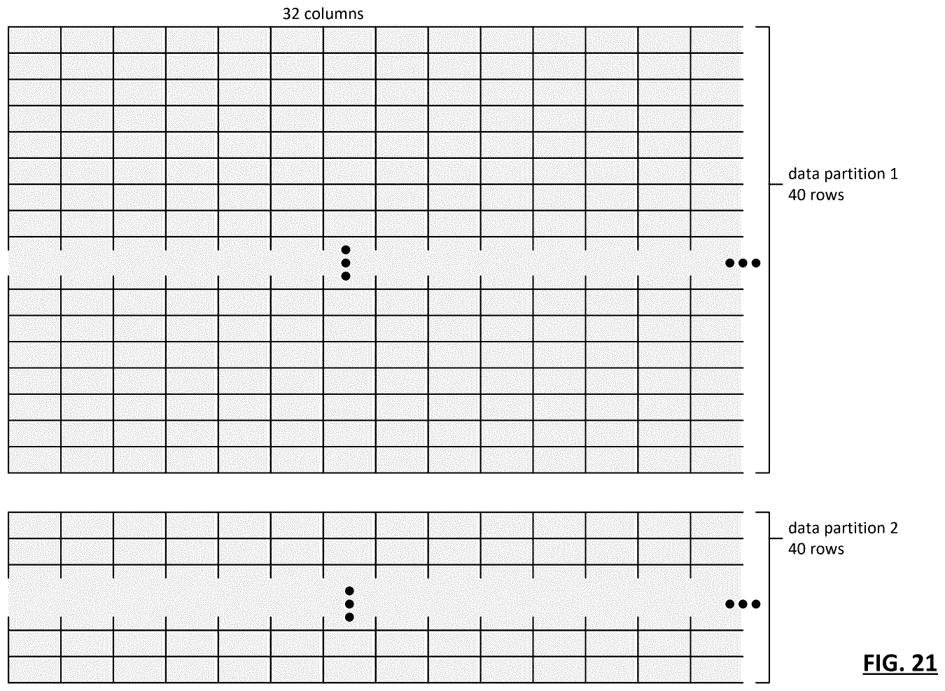

FIG. 21 illustrates an example of the parallelized data input-subsystem dividing the data set into two partitions. Each of the data partitions includes 40 rows, or records, of the data set. In others examples, the parallelized data input-subsystem divides the data set into more than two partitions with each partition including a different number of rows.

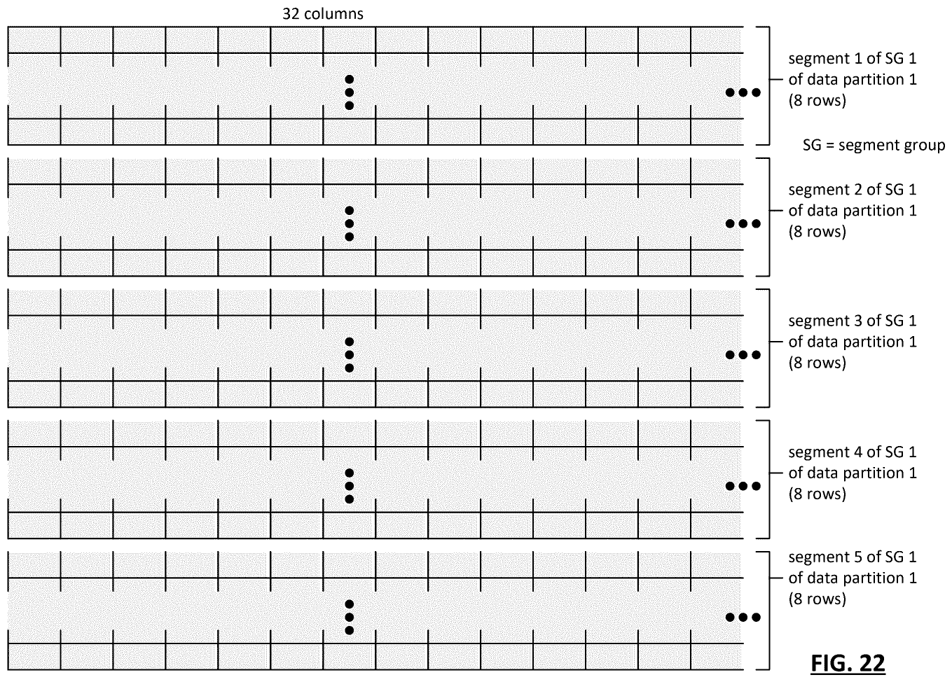

FIG. 22 illustrates an example of the parallelized data input-subsystem dividing a data partition into a plurality of segments to form a segment group. The number of segments in a segment group is a function of the data redundancy encoding. In this example, the data redundancy encoding is single parity encoding from four data pieces; thus, five segments are created.

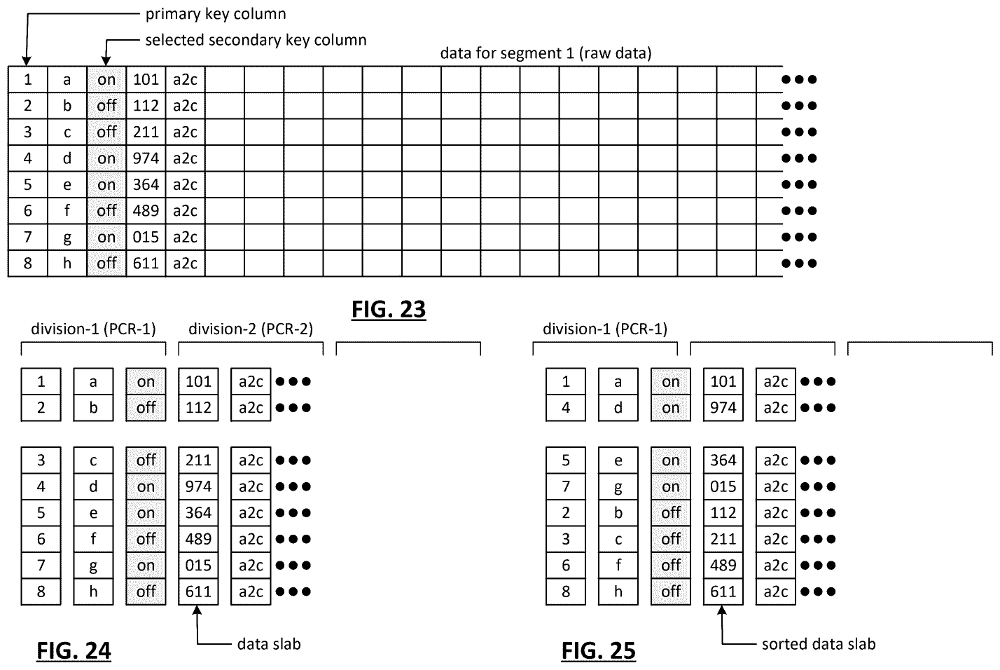

FIG. 23 illustrates an example of data for segment 1 of the segments of FIG. 22; referred to as a raw segment. Segment 1 includes 8 rows and 32 columns. The third column is selected as the key column.

FIG. 24 illustrates an example of the parallelized data input-subsystem dividing segment 1 of FIG. 23 into a plurality of data slabs. A data slab is a column of segment 1. In this figure, the data of the data slabs has not been sorted.

FIG. 25 illustrates an example of the parallelized data input-subsystem sorting the data slabs based on the key column. In this example, the data slabs are sorted based on the third column which includes data of “on” or “off”. The result is sorted data slabs.

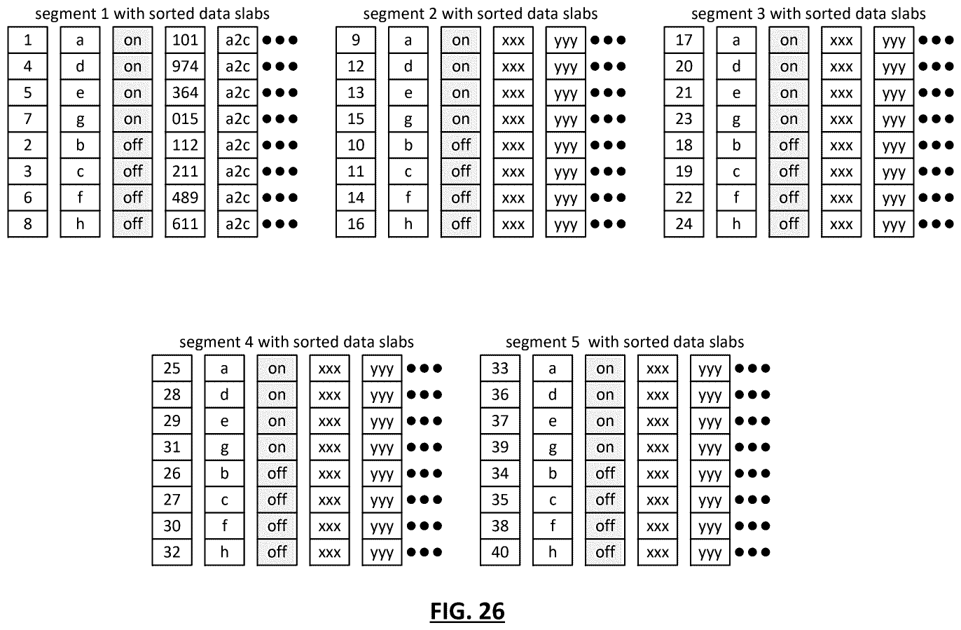

FIG. 26 illustrates an example of each segment being sorted to produce sorted data slabs. The similarity of data from segment to segment is for the convenience of illustration. Note that each segment has its own data, which may or may not be similar to the data in the other sections. Each segment is divided into the same number of data slabs and are sorted based on the same key column.

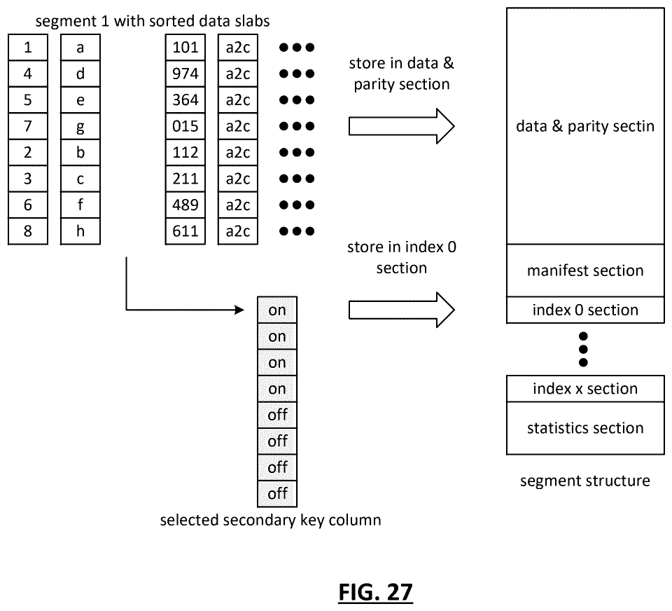

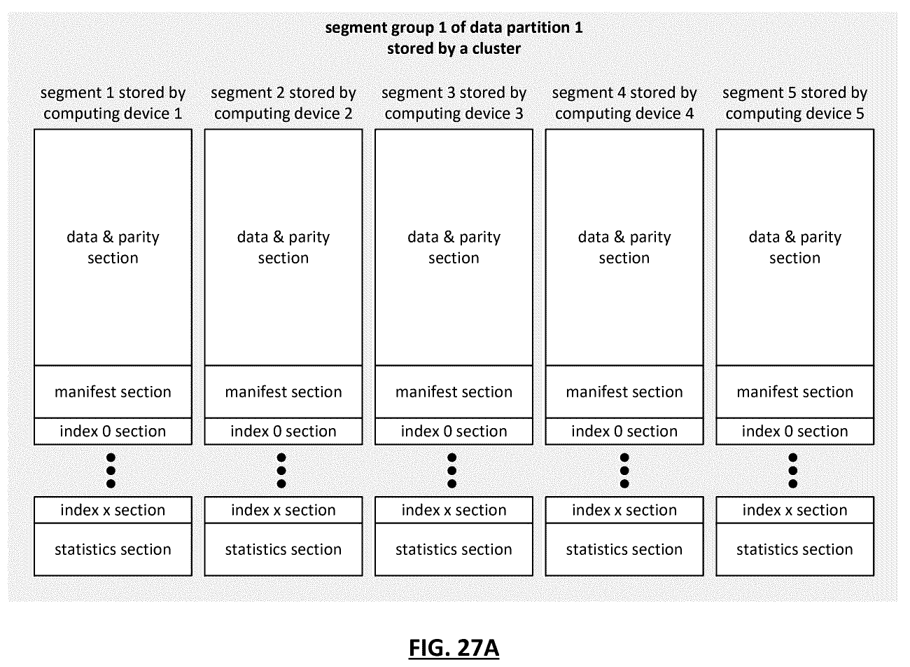

FIG. 27 illustrates an example of creating segment of a group of segments. The sorted data slabs of FIG. 25 being placed in the data & parity section of a segment. The sorted data slabs are stored in the data & parity section in a compressed format or as raw data (i.e., non-compressed format).

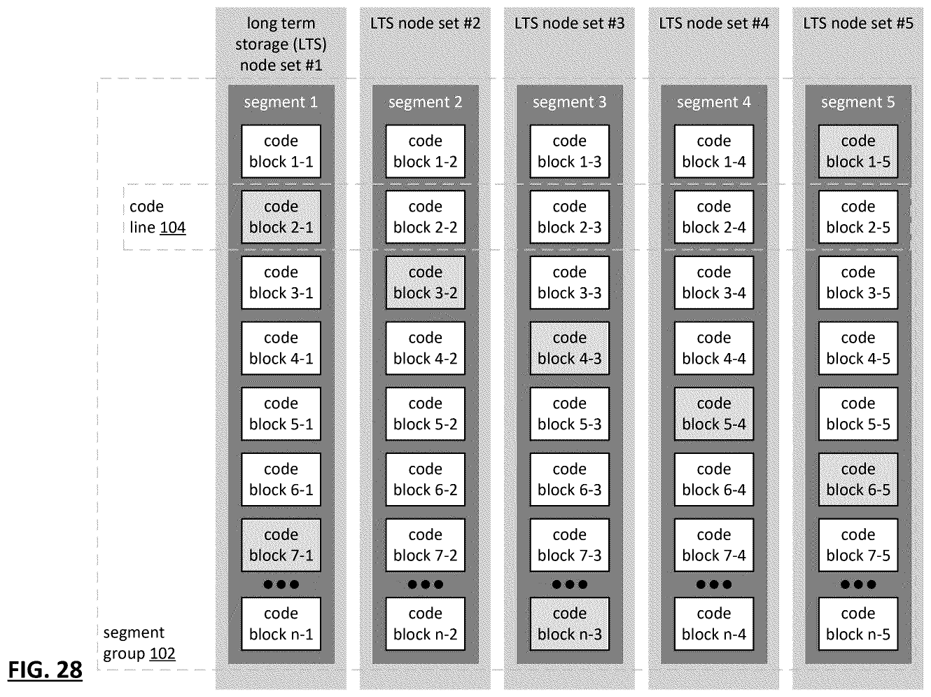

Before the sorted data slabs are stored in the data & parity section, or concurrently with storing in the data & parity section, sorted data slabs from the segments of a segment group are redundancy encoded. The redundancy encoding may be done in a variety of ways. For example, the redundancy encoding is in accordance with RAID 5, RAID 6, or RAID 10. As another example, the redundancy encoding is a form of forward error encoding (e.g., Reed Solomon, Trellis, etc.). An example of redundancy encoding is discussed in greater detail with reference to FIG. 28.

The manifest section stores metadata regarding the sorted data slabs. The metadata includes one or more of, but is not limited to, descriptive metadata, structural metadata, and/or administrative metadata. Descriptive metadata includes one or more of, but is not limited to, information regarding data such as name, an abstract, keywords, author, etc. Structural metadata includes one or more of, but is not limited to, structural features of the data such as page size, page ordering, formatting, compression information, redundancy encoding information, logical addressing information, physical addressing information, physical to logical addressing information, etc. Administrative metadata includes one or more of, but is not limited to, information that aids in managing data such as file type, access privileges, rights management, preservation of the data, etc.

The key column is stored in an index section. For example, a first key column is stored in index #0. If a second key column exists, it is stored in index #1. As such, for each key column, it is stored in its own index section. Alternatively, one or more key columns are stored in a single index section.

The statistics section stores statistical information regarding the segment and/or the segment group. The statistical information includes one or more of, but is not limited, to number of rows (e.g., data values) in one or more of the sorted data slabs, average length of one or more of the sorted data slabs, average row size (e.g., average size of a data value), etc. The statistical information includes information regarding raw data slabs, raw parity data, and/or compressed data slabs and parity data.

FIG. 27A illustrates a segment group having five segments. Each segment includes a data & parity section, a manifest section, one or more index sections, and a statistic section. Each segment is targeted for a different computing device of a storage cluster. The number of segments in the segment group corresponds to the number of computing devices in a storage cluster. In this example, there are five computing devices in a storage cluster. Other examples include more or less than five computing devices in a storage cluster.

FIG. 28 illustrates an example of redundancy encoding using single parity encoding. The data of a segment is divided into data blocks (e.g., 4 K bytes). The data blocks of the segments are logically aligned such that the first data blocks of the segments are aligned. For example, coding block 1_1 (the first number represents the code block number in the segment and the second number represents the segment number, thus 1_1 is the first code block of the first segment) is aligned with the first code block of the second segment (code block 1_2), the first code block of the third segment (code block 1_3), and the first code block of the fourth segment (code block 1_4). This forms a data portion of a coding line.

The four data coding blocks are exclusively ORed together to form a parity coding block, which is represented by the gray shaded block 1_5. The parity coding block is placed in segment 5 as the first coding block. As such, the first coding line includes four data coding blocks and one parity coding block. Note that the parity coding block is typically only used when a data code block is lost or has been corrupted. Thus, during normal operations, the four data coding blocks are used.

To balance the reading and writing of data across the segments of a segment group, the positioning of the four data coding blocks and the one parity coding block are distributed. For example, the position of the parity coding block from coding line to coding line is changed. In the present example, the parity coding block, from coding line to coding line, follows the modulo pattern of 5, 1, 2, 3, and 4. Other distribution patterns may be used. In some instances, the distribution does not need to be equal. Note that the redundancy encoding may be done by one or more computing devices of the parallelized data input sub-system and/or by one or more computing devices of the parallelized data store, retrieve, &/or process sub-system.

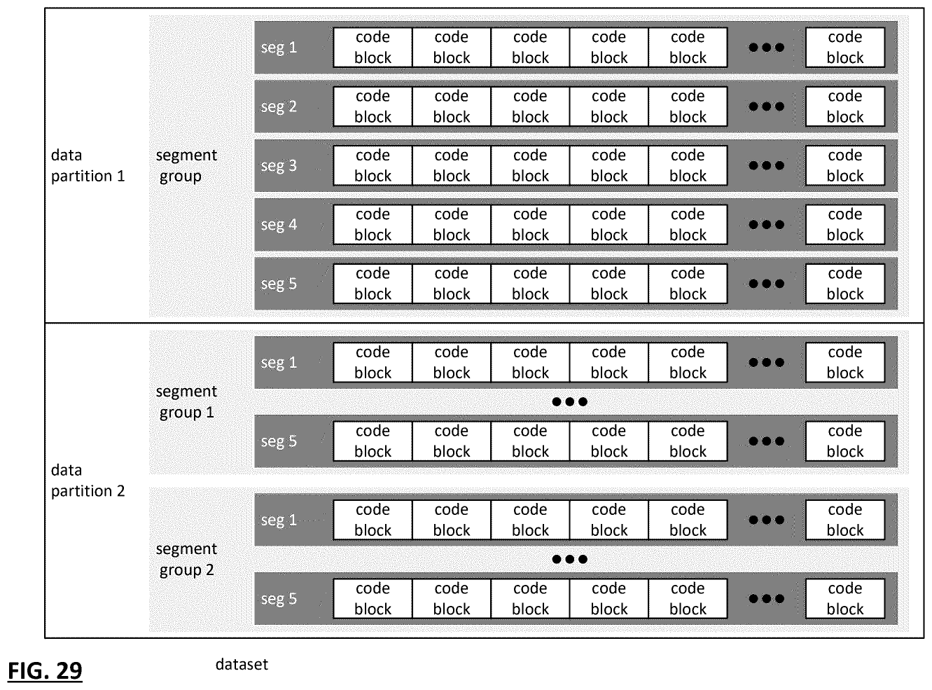

FIG. 29 illustrates an overlay of the dividing of a data set (e.g., a table) into partitions. Each partition is then divided into one or more segment groups. Each segment group includes a number of segments. Each segment is further divided into coding block, which include data coding blocks and parity coding blocks.

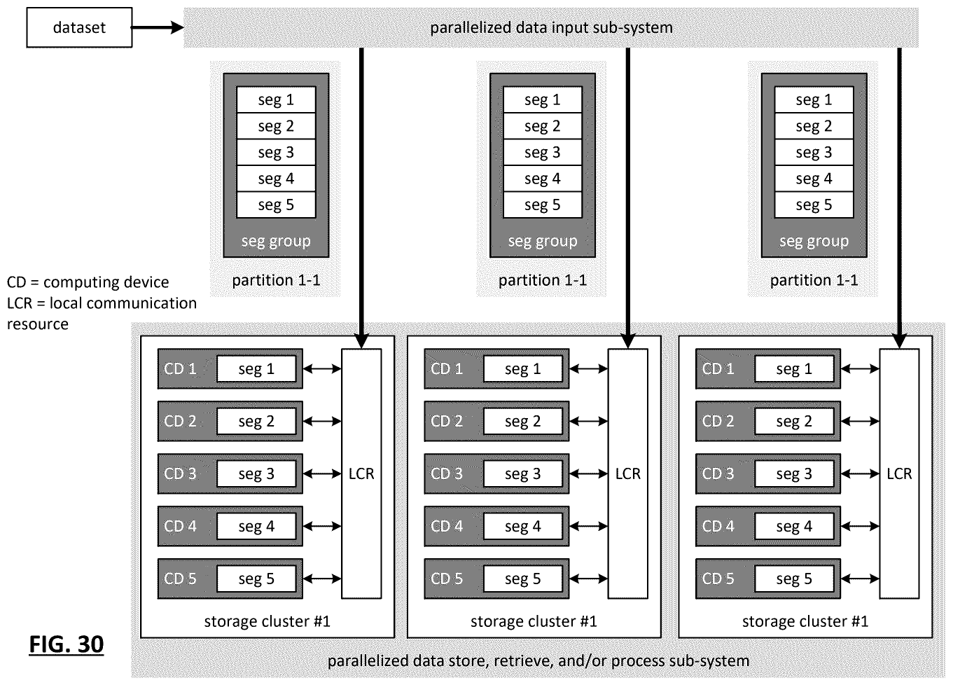

FIGS. 30-32 are schematic block diagrams of an example of storing a processed table or data set in the database system. FIG. 30 illustrates the parallelized data input sub-system sending segment groups of data partitions of a data set (e.g., table) to storage clusters of the parallelized data store, retrieve, &/or process sub-system. In this example, each storage cluster includes five computing devices, as such, a segment group includes five segments.

Each storage cluster has a primary computing device for receiving incoming segment groups. The primary computing device is randomly selected for each ingesting of data or is selected in a predetermined manner (e.g., a round robin fashion). The primary computing device of each storage cluster receives the segment group and then provides the segments to the computing devices in its cluster: including itself. Alternatively, the parallelized data input-section sends each segment of a segment group to a particular computing device within the storage clusters.

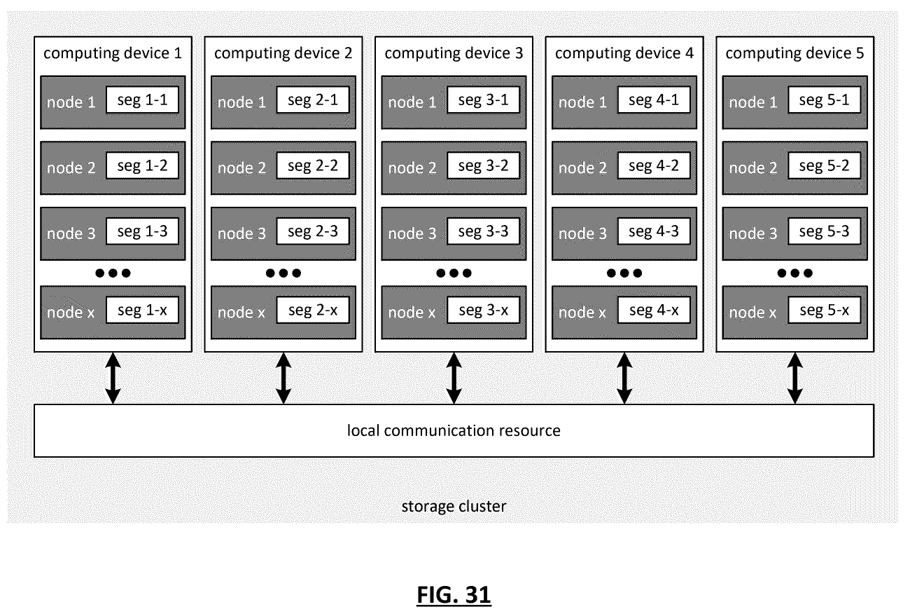

FIG. 31 illustrates a storage cluster distributing storage of a segment group among its computing devices and the nodes within the computing device. Within each computing device, a node is selected as a primary node for dividing a segment into segment divisions and distributing the segment divisions to the nodes: including itself. For example, node 1 of computing device (CD) 1 receives segment 1. Having x number of nodes in the computing device 1, node 1 divides the segment into x segment divisions (e.g., seg 1_1 through seg 1_x, where the first number represents the segment number of the segment group and the second number represents the division number of the segment). Having divided the segment into divisions (which may include an equal amount of data per division, an equal number of coding blocks per division, an unequal amount of data per division, and/or an unequal number of coding blocks per division), node 1 sends the segment divisions to the respective nodes of the computing device.

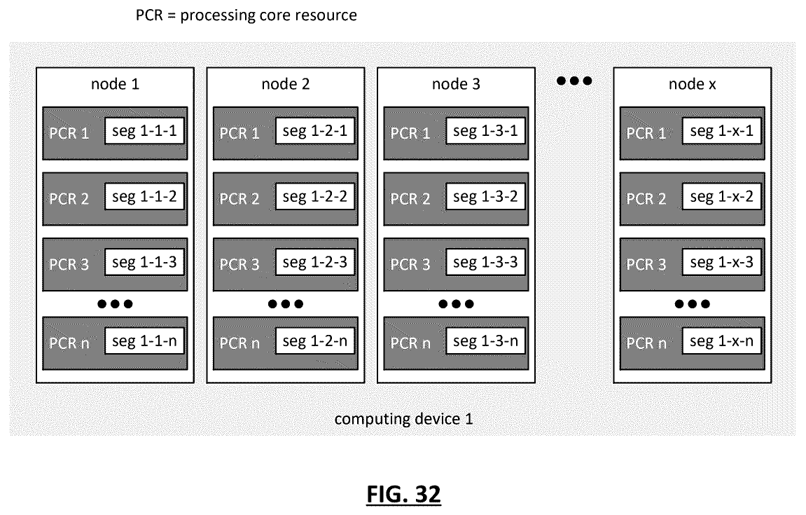

FIG. 32 illustrates a node of a computing device distributing storage of a segment division among its processing core resources (PCR). Within each node, a processing core resource (PCR) is selected as a primary PCR for dividing a segment division into segment sub-divisions and distributing the segment sub-divisions to the other PCRs of the node: including itself. For example, PCR 1 of node 1 of computing device 1 receives segment division 1_1. Having n number of PCRs in node 1, PCR 1 divides the segment division 1 into n segment sub-divisions (e.g., seg 1_1_1 through seg 1_1_n, where the first number represents the segment number of the segment group, the second number represents the division number of the segment, and the third number represents the sub-division number). Having divided the segment division into sub-divisions (which may include an equal amount of data per sub-division, an equal number of coding blocks per sub-division, an unequal amount of data per sub-division, and/or an unequal number of coding blocks per sub-division), PCR 1 sends the segment sub-divisions to the respective PCRs of node 1 of computing device 1.

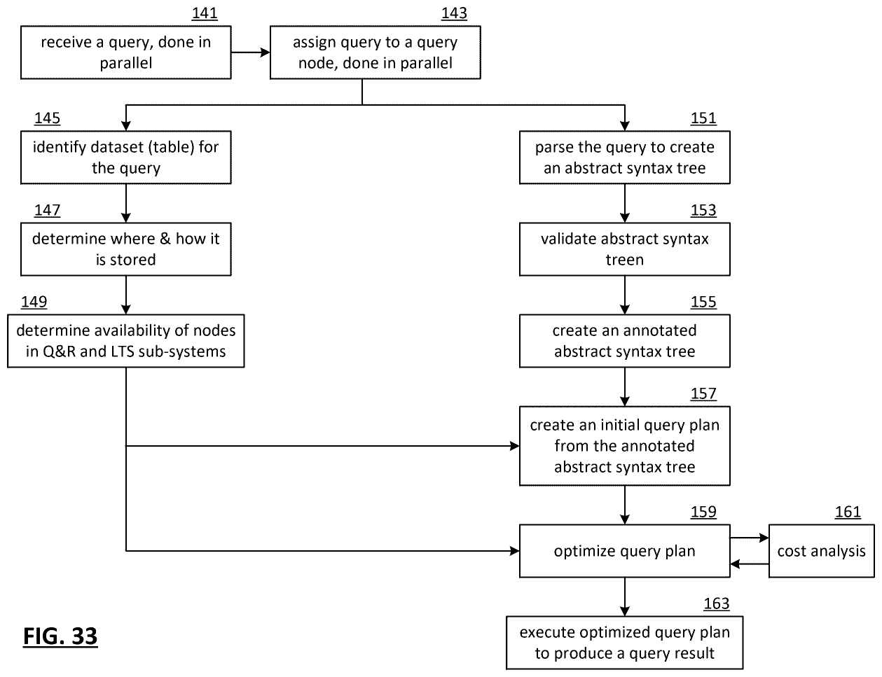

FIG. 33 is a logic diagram of an example of creating a query plan for execution within the database system that begins at steps 141 and 143 where one or more processing core resources of a node, one or more nodes of a computing device, and/or one or more computing devices of the parallelized query & response sub-system (hereinafter referred to as a computing node for the discussion of this figure) is assigned to receive a query. The received query is formatted in one of a variety of conventional query formats. For example, the query is formatted in accordance with Open Database Connectivity (ODBC), Java Database Connectivity (JDCB), or Spark.

The parallelized query & response sub-system is capable of receiving and processing a plurality of queries in parallel. For ease of discussion, the present method is discussed with reference to one query.

The method branches to steps 145 and 151. At step 145, the computing device identifies a table (or tables) for the received query. The method continues at step 147 where the computing device determines where and how the table(s) is/are stored. For example, the computing device determines how the table was partitioned: how each partition was divided into one or more segment groups: how many segments in a segment group: how many storage clusters are storing segment groups: how many computing devices are in a storage cluster; how many nodes per computing device; and/or how many processing core resources per node.

The method continues at step 149 where the computing device determines available nodes (and/or processing core resources) within the parallelized Q&R sub-system for processing operations of the query. In addition, the computing device determines nodes (and/or processing core resources) available for processing operations of the query. Typically, the nodes and/or processing core resources storing a relevant portion of the table will be need for processing one or more operations of the query.

At step 151, the computing device parses the received query to create an abstract syntax tree. For example, the computing device converts SQL statements of the query into nodes of a syntactic structure of source code and creates a tree structure of the nodes. A node corresponds to a construct occurring in the source code.

The method continues at step 153 where the computing device validates the abstract syntax tree. For example, the computing device verifies one or more of the SQL statements are valid, the conversion to operations of the DB instruction set are valid, the table(s) exists, the selected operations of the DB instruction set and/or the SQL statements yield viable data (e.g., will produce a result, will not cause a deadlock, etc.), etc. If not, the computing device sends an SQL exception to the source of the query.

For validated abstract syntax tree, the method continues at step 155 where the computing device generates an annotated abstract syntax tree. For example, the computing device adds column names, data types, aggregation information, correlation information, subquery information, etc. to the verified abstract system tree.

The method continues at step 157 where the computing device creates an initial query plan from the annotated abstract syntax tree. For example, the computing device selects operations from an operating instruction set of the database system to implement the abstract syntax tree. The operating instruction set of the database system (i.e., DB instruction set) includes the following operations;
Aggregation-aggregates two or more rows based on one or more values of a row and then combine (e.g., sum, average, appended, sort, etc.) into a row;
Agg VectorOperationInstance-use when number of rows is known and is less than or equal to a specific value (e.g., 256), use a vector operation instead of a hash function to aggregate rows, which allows aggregation without the need for caching;
Broadcast-computing device or node sending data to other computing devices or nodes performing similar tasks, functions, and/or operations (typically for lateral data flow in the system);
Eos-“end of stream” is a placeholder to indicate no data, may also be used to indicate a function cannot be performed;
Except-set subtraction;
Extend-add a column to received data;
Gather-combine data together;
GdeLookup-“Global Dictionary Compression” lookup function for data compression;
HashJoin-join data using a hash function;
IncrementBigInt-increment one or more data values in accordance with a test protocol
IncremetingInt-increment one or more data values
Index-uses indexed metadata to reduce amount of data to read and/or to push operations downstream to delay reading;
IndexAgg-aggregation of indexing;
IndexDistinct-indexing of distinct row, rows, column, and/or columns;
SegmentAgg (operator instance)—segmenting of an aggregation operation to produce sub-aggregation operations;
SegmentDistinct (operator instance)—segmenting of a distinct operation to produce sub-distinct operations;
IndexCountStar—
Intersect—is a mathematical function to find data from two or more sets of data that intersect:
Jobs Virtual—
Limit-limit the number of rows to be read, to be operated on, etc.;
Make Vector-convert columns into a matrix for linear algebra functions;
UnMake Vector-convert a resulting matrix back into columns;
MatrixExtend-add columns or another matrix to an existing matrix;
Offset—is an offset for data retrieval;
OrderedAgg-ordering of aggregation to allow for lower level aggregation, which allows higher level to be more efficient;
OrderedDistinct-ordering of distinct values at lower levels, which allows higher levels to be more efficient;
OrderedGather-ordering of gathering at lower levels, which allows higher levels to be more efficient;
ProductJoin-nested loop join function (e.g., join data from one or more rows and/or from one or more columns);
ProjectOut—remove a column for data of interest (e.g., want to do this as far downstream as possible);
Rename—change name of a column, (can be used to avoid column name collisions);
Reorder—reorder data of one or more rows and/or one or more columns based on an ordering preference;
Root—conduit for data flow;
Select—select columns from one or more tables;
Shuffle—sub-divide data into a plurality of data sub-divisions (typically for lateral data flow in the system);
Switch—change where to send data when a condition is met;
TableScan—retrieve all of the data of a table;
TableSlabScan (operator instance)—retrieve particular data slabs of a table;
Tee—creates a brand in operational flow when operating on redundant data;
Union—establish a set of operations;
Window—is a specific type of aggregation that captures a moving window of aggregated data (e.g., a running sum, a running average, etc.); and
MultiplexerOperatorInstance for Set/ProductJoin/HashJoin/Sort/Aggregation-allows for lock free multiplexing for various types of operations.

The method continues at step 159 where the computing device optimizes the query plan using a cost analysis of step 161. The initial query plan is created to be executed by a computing device within the parallelized query & response sub-system. Optimizing the plan spreads the execution of the query across multiple layers (e.g., three or more) and to include the other sub-systems of the database system. The computing device utilizes one or more optimization transforms to optimize the initial query plan. The optimization transforms include;
AddDistinctBeforeMinMax: Adds a union distinct before an aggregation operator that only performs min/max
RemoveDistinctBeforeMinMax: The opposite of addDistinctBeforeMinMax
AddDistinctBetoreSemiAnti: Adds a union distinct as the right child of a join that is a semi or anti join
RemoveDistinctBeforeSemiAnti: The opposite of addDistinctBeforeSemiAnti

AggDistinctPushDown: Pushes down an aggregation that is only performing distinct operators (count/sum distinct) below its child
AggDistinctPushUp: The opposite of AggDistinctPushDown
AggregatePushDown: The same as AggDistinctPushDown but for aggregations performing non-distinct operations
AggregatePushUp: The opposite of AggregatePushDown
ConvertProductToHashJoin: Converts a product join with lhasCol=rhsCol filters into an equivalent hash join
CreateTee: Given a certain node in the tree, searches the rest of the tree for equivalent subtrees, if one or more is found, the equivalent subtrees are deleted and a tee operator is created as the parent of the given node, which then forwards the results to the parents of those equivalent subtrees
Delete Tee: The opposite of create Tee
RedistributeAggDistinct: Moves a distinct aggregation to a lower level (below a gather), and adds a shuffle if needed
DedistributeAggDistinct: The opposite of redistributeAggDistinct
RedistibuteAggregation: The same as redistributeAggDistinct but for non-distinct aggregations
DedistributeAggregation: The opposite of redistributeAggregation
DeletePointlessSort: Deletes a pointless sort from the tree
DeletePointlessSwitch: Deletes a pointless switch from the tree (only happens if all of the extends the switch created were pushed out of the switch-union block)
DuplicateAggBelow Shuffles: Given an aggregation (including aggdistinct) with a shuffle as its child, create a copy of the aggregation below the shuffle and update the original to have the correct operations
RemoveAggBelow Shuffles: The opposite of duplicateAggBelow Shuffles
DuplicateLimit: Given a limit above a gather type operator, create a copy of it below the gather type operator
ExceptPushDown: Pushes an except operator down below all of its child, can only happen if they are all equivalent
ExceptPushUp: The opposite of exceptPushDown
ExceptUnionContract: Given an except with more than 2 children, take children [1, N-1] and make them the children of a union all, which becomes child 1 of the except
ExceptUnionExpand: The opposite of exceptUnionContract
ExtendPushDown
ExtendPush Up
IntersectPushDown: The same as exceptPushDown but for an intersect operator
IntersectPushUp: The opposite of intersectPushDown
JoinPushDown: Pushes a join down below its child (ren). Similar to except/intersectPushDown except with a few other cases. If one child is a join it instead swaps the joins, it also has to check that pushing below its children doesn't break the join (for example by creating name collisions or removing columns that needed to exist)
JoinPushUp: The opposite of joinPushDown, but with some more potential for optimizations. Specifically, if the parent is a select on equiJoin columns, the select can be pushed down to all children, or is the parent is a project and the join is a gdcJoin, then this deletes the join and its right subtree entirely
LimitPushDown
LimitPushUp
Make VectorDown
Make VectorPushUp
MatrixExtendPushDown
MatrixExtendPushI) own
MergeEquiJoins: Given two adjacent inner hash joins with no other filters, combine them into a single hash join with more children
SplitEquiJoins: The opposite of mergeEquiJoins
MergeExcept: Given two adjacent except operators, take the input to the lower one and make all of its children become children of the higher one
MergeIntersect: The same as mergeExcept but for intersect
MergeTee: Given two adjacent tee operators, take delete the higher one and make its parent additional
parents on the lower one
MergeUnion: The same as mergeExcept but for union
Merge Windows: Combine two adjacent window operators into a single one
OffsetPushDown
OffsetPushUp
ProjectOutPushDown
ProjectOutPushUp
PushAggBelowJoin: Duplicates an aggregation below a hash join, and updates the higher one
accordingly
PushAggAboveJoin: The opposite of pushAggBelow.Join
PushAggBelowGdcJoin: Given an aggregation above a gdcJoin, this moves it below the gdcJoin if possible. Currently requires that the aggregation does not reference the gdc column at all, or only groups by it. More cases are possible
PushJoinBelowSet: Given a join where one if it's children is a set operator, and moves the join below the set such that there are not multiple joins as the children of the set operator
PushSetBelowJoin: The opposite of pushJoinBelowSet
PushLimitintolndex: Pushes a limit operator into an index operator, this way the index knows to only output up to LIMIT rows
PushLimitIntoSort: Pushes a limit into a sort operator, which causes us to run a faster limitSort algorithm in the virtual machine (e.g., node or processing core resource)
PushLimitOutOfSort: The opposite of pushLimitIntoSort
PushProjectIntoIndex: Pushes a project into an operator, which causes a not read of a column. Used when start reading all columns in plan generation
PushSelectBelowGdc.Join: Given a select above a gdcJoin, where the select is filtering the compressed column, this converts the filter to a filter on the stored integer mapping of that column, and moves the select below the join. For example, where coll= “hello” might be converted to where coll Key=42
PushSelectintoHash.Join: Given a select above a hash join, where the select filters on lhsCol=rhsCol, this creates additional equi join columns on the hash join
PushSelectOutOffiashJoin: The opposite of pushSelectintoHashJoin
PushSelectintoProduct: The same as pushSelectintoHashJoin but for product joins
PushSelectOut01Product: The opposite of pushSelectIntoProduct
RenamePushDown
RenamePushUp
ReorderPushDown
ReorderPushUp
SelectOut.JoinNulls: Given a join that is joining on coll, if coll is nullable this creates a select below the join that has the filter where coll!=NULL
UnselectOut.JoinNulls: The opposite of selectOut.JoinNulls
SelectPushDown
SelectPushUp
SortPushDown
SortPushUp
SwapJoinChildren: Swaps the order of a joins children
SwitchPushDown: Given a switch operator, push it down over its child. In some cases, this causes copies of the child to become the switch's parents′, and in others this causes that child to jump the entire switch union block and become the parent of the union associated with the switch
SwitchPushUp: The opposite of switchPushDown, but nothing jumps because the parents of the switch are inside the switch union block already. Also requires that all parents are equivalent
TeePushDown: Pushes a tee down below its child, causing that child to be copied for each parent of the tee
TeePushUp: The opposite of teePushDown, requires that all parents are equivalent
UnionDistinctCopyDown: Given a union distinct with gathers as its children, creates another 1 child union distinct as the children of those gathers
UnionDistinctCopyUp: The opposite of unionDistinctCopyDown

UnionPushDown: The same as exceptPushDown except for union, also handles the different rules that apply to union all and union distinct
UnionPushlJp: The opposite of unionPushDown, also handles the case where this is the opposite of switchPushDown because the union has an associated switch, so some operators will jump the entire switch union block
Unmake VectorPushDown
Unmake VectorPushUp
WindowPushDown
WindowPushUp post-optimization options
Combining adjacent selects into super Selects
Combining adjacent limits
Combining adjacent offsets
Converting distinct aggregations into a non-distinct aggregation with a union distinct as its child
Duplicating union distincts around shuffles, this only happens if there is a union distinct on 1 side of a shuffle, but not both
Replacing index type operators with an eos operator we if can determine that the filters (if any) on the index are always false (possible by comparing possible values of data types)
Evaluating alternate indexes besides the primary index
Building orderedAggregations and orderedDistincts
Getting rid of pointless renames
Pushing sorts down to level 3 if possible
Creating indexCountStar operators if possible
Fixing out of order indexAggs, this makes the grouping key order match the primary index order when possible
Tee′ing leaf operators, this combines as many equivalent leaf operators as possible to reduce IO
Deleting pointless reorders

Note that the Down and push Up transforms are used frequently, and mean to take the given operator and swap its position in the tree with its child (or parent) for most operators. Further note that not all of these transforms are legal in all possible cases, and they only get applied if they are legal.

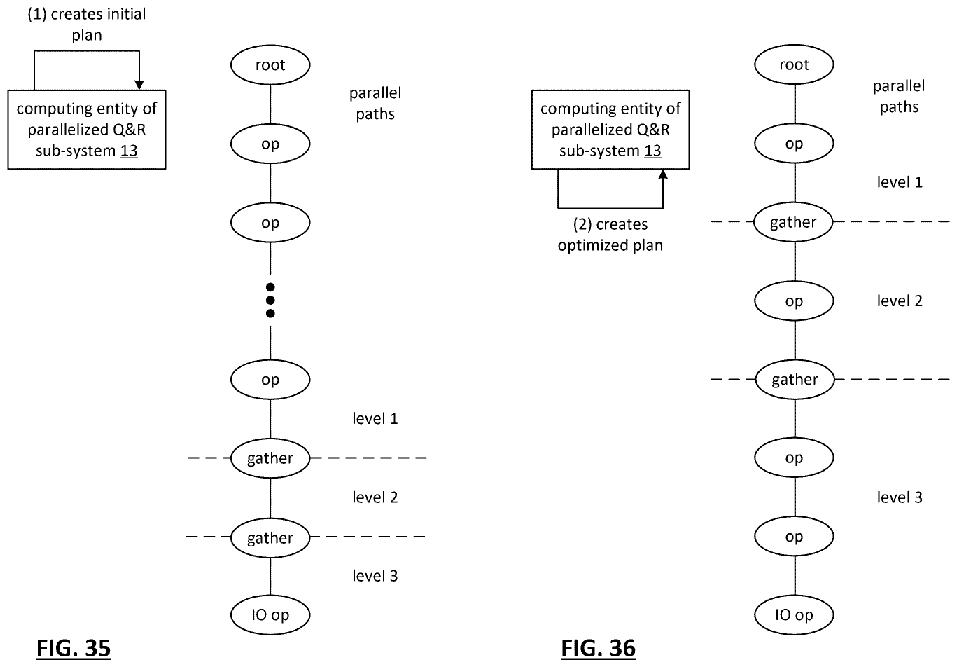

The method continues at step 163 where the query plan is executed to produce a query result. FIGS. 35-36 provide an example of optimizing a query plan.

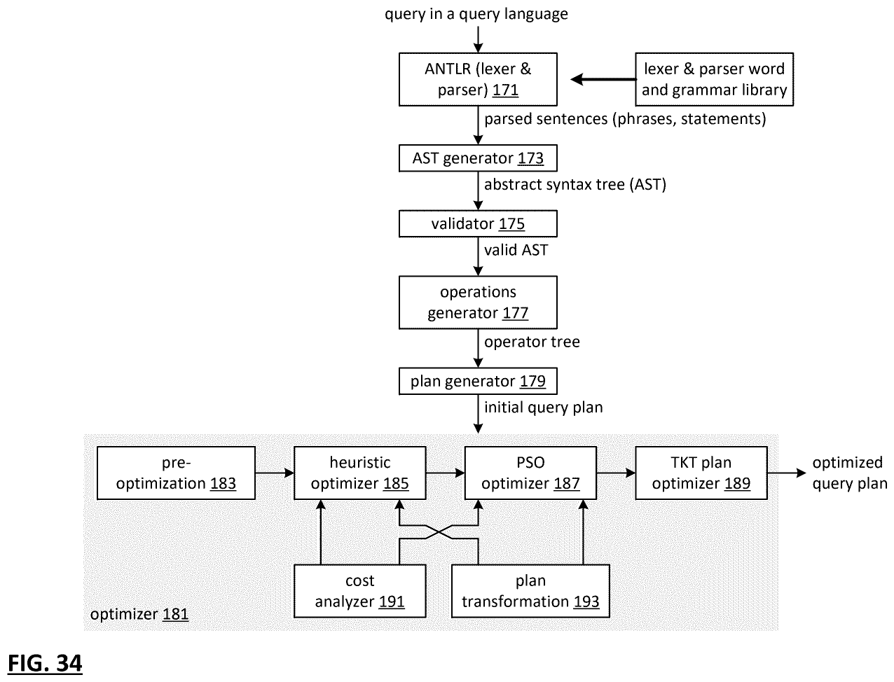

FIG. 34 is a logic diagram of another example of creating a query plan for execution within the database system that begins at step 171 where one or more processing core resources of a node, one or more nodes of a computing device, and/or one or more computing devices of the parallelized query & response sub-system (hereinafter referred to as a computing node for the discussion of this figure) performs a lexer function and a parsing function using ANTRL on a received query, which was received in a query language. The computing node executes steps 173 -181 to produce a query plan.

FIGS. 35-36 are schematic block diagrams of an example of creating and distributing a query plan in the database system. FIG. 35 illustrates one or more processing core resources of a node, one or more nodes of a computing device, and/or one or more computing devices of the parallelized query & response sub-system (hereinafter referred to as a computing device for the discussion of FIGS. 35-36). The computing device creates an initial plan from a received query using one or more operators from a plurality of operators.

FIG. 35 illustrates an example of a computing device of the parallelized Q&R sub-system creating an initial plan from a received query. The initial query plan is created for execution by a computing device of the parallelized query & response sub-system. As created, the initial query plan is guaranteed to produce a result from the select table(s).

The initial plan includes a root operator, a plurality of operators (op), and one or more input/output operations (IO op). The query includes one or more parallel paths of execution. Accordingly, when the computing device is creating the initial plan, it is dividing the execution of the query plan into threads that can be executed relatively independently and without lock up. For the most part, the initial plan is executed at level 1 and the other levels have very few, if any, operations.

FIG. 36 illustrates the computing device optimizing the initial plan to produce an optimized plan. In general, an optimized plan still guarantees a result, just like the initial plan, but is optimized for efficiency of execution (e.g., efficient use of processing resources of the database system and speed in producing an answer). In this example, the computing device creates a plurality of a parallel paths and distributes execution of operations among three levels. Note that there may be more than three levels of execution.

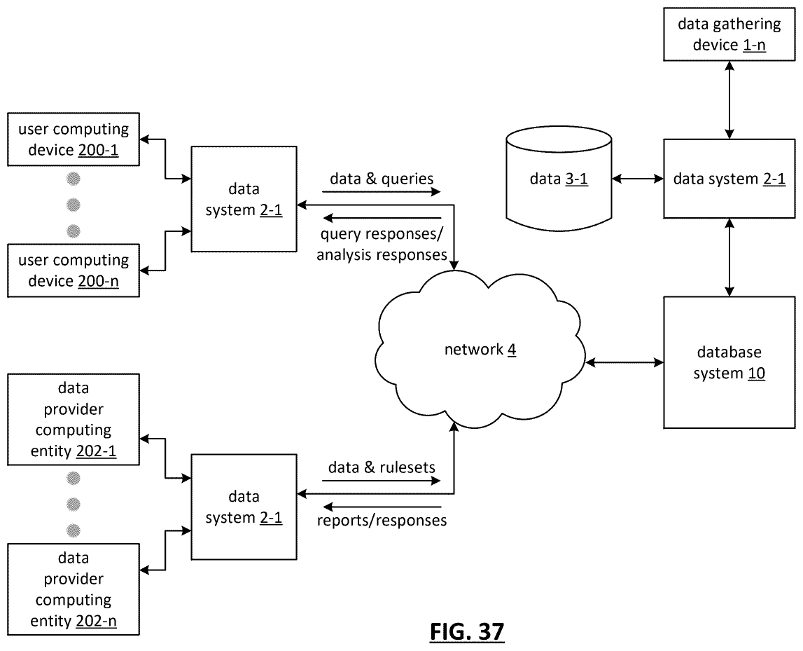

FIG. 37 is a schematic block diagram of another embodiment of a large-scale data processing network that includes the database system 10. The large-scale data processing network of FIG. 37 is similar to the large-scale data processing network of FIG. 1 except that specific examples of data gathering devices are shown providing data to the database system 10. For example, data gathering devices include a plurality of user computing devices 200-1 through 200-n and a plurality of data provider computing entities 202-1 through 202-n.

The data systems 2-1 are coupled to or include a respective one of the plurality of user computing devices 200-1 through 200-n and the plurality of data provider computing entities 202-1 through 202-n and/or a respective plurality of storage devices (e.g., hard drives, cloud storage, etc.). The user computing devices 200-1 through 200-n provide queries and/or data (e.g., user profile information, user preferences, data for storage, etc.) to the database system 10 via the network 4 and the data system 2-1 and obtain query responses and/or analysis responses from the database system 10 via the network 4 and the data system 2-1.

The data provider computing entities are associated with the user computing devices and provide data (e.g., data collected from user computing devices, provider profile information, etc.) and rulesets (e.g., rules for how associated user computing devices can interact with data stored in the database system) to the database system 10. The data provider computing entities can obtain reports regarding users, data usage, ruleset abidance, statistics, etc. and responses to particular analysis requests from the database system 10.

A data provider computing entity may be affiliated with a particular data provider, such as a company that facilitates, manages, and/or controls collection of the data from the user computing device 200-1 through 200-n. In another example, the data provider manufactures one or more corresponding user computing devices 200-1 through 200-n, and/or manufactures one or more user computing devices 200-1 through 200-n that communicate with one or more corresponding data provider computing entities 202-1 through 202-n. In another example, a data provider can be affiliated with the network 4, where the data provider maintains and/or manages the network 4. In another example, the data provider services and/or manages a mobile application, browser application, and/or website that collects data from user computing devices 200-1 through 200-n.

For example, a data provider can be affiliated with a telecommunications company, where the plurality of user computing devices 200-1 through 200-n are a plurality of cellular devices communicating via a cellular network associated with the telecommunications company. For example, network 4 can be implemented utilizing the cellular network of the telecommunications company. In such cases, the data provider computing entities can be implemented via a server system or other memory of the telecommunications company, where the data sent to the database system 10 may include data collected from the user computing devices 200-1 through 200-n and/or data collected by the user computing devices 200-1 through 200-n via their own connection to the cellular network, the Internet, or a different network.

As another example, a data provider may be a mobile device manufacturing company that manufactured the plurality of user computing devices 200-1 through 200-n where the plurality of user computing devices 200-1 through 200-n are mobile devices and configured the mobile devices to send their collected data to the database system 10.

As another example, a data provider can be affiliated with a particular automobile company. The user computing devices 200-1 through 200-n can correspond to a plurality of cars or other automobiles manufactured by the automobile company that send their geolocation sensor data or other vehicle sensor data to the database system.

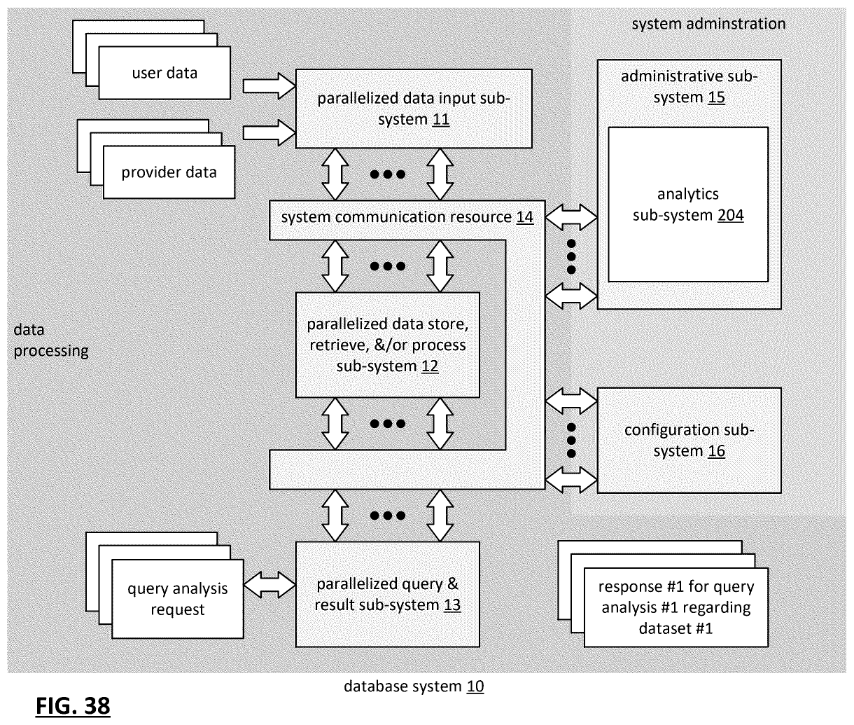

FIG. 38 is a schematic block diagram of another embodiment of a database system 10 that includes a parallelized data input sub-system 11, a parallelized data store, retrieve, and/or process sub-system 12, a parallelized query and response sub-system 13, an administrative sub-system 14, a configuration sub-system 15, and a system communication resource 16. The database system 10 of FIG. 38 operates similarly to the database system of FIG. 1A except that the administrative sub-system 15 is shown in more detail to include an analytics sub-system 204.

The analytics sub-system 204 includes one or more computing devices of the administrative sub-system 15. Each computing device includes a plurality of nodes and each node includes a plurality of processing core resources. Each processing core resource is capable of executing at least a portion of an analytics operation independently. This supports lock free and parallel execution of one or more analytics operations. The analytics operations will be discussed in more detail with reference to one or more of the subsequent figures.

In an example of operation, the parallelized data input sub-system 11 receives tables of data from a data source. For example, a data source is one or more user computing devices and the data is user data. As another example, a data source is a plurality of data provider computing entities and the data is provider and/or user data. The provider and/or user data may include data for storage in the database system, data pertaining to use of the database system, and/or information pertaining to the provider and/or user. The parallelized data input sub-system 11 provides the analytics sub-system 204 with data needed for analytics (e.g., user profile information, rulesets, etc.).

The parallelized query & result sub-system 13 is operable to receive query analysis requests (e.g., a query with an analysis indication) and other analytics requests in addition to database queries. The parallelized query & result sub-system 13 coordinates with the parallelized data store, retrieve, and/or process sub-system 12 to provide the analytics sub-system 204 data needed for a particular analysis. The analytics sub-system 204 is operable to produce analysis responses, reports, logs, and other analysis results and output the result(s) to the requester (e.g., via one or more computing devices of the parallelized query & result sub-system 13).

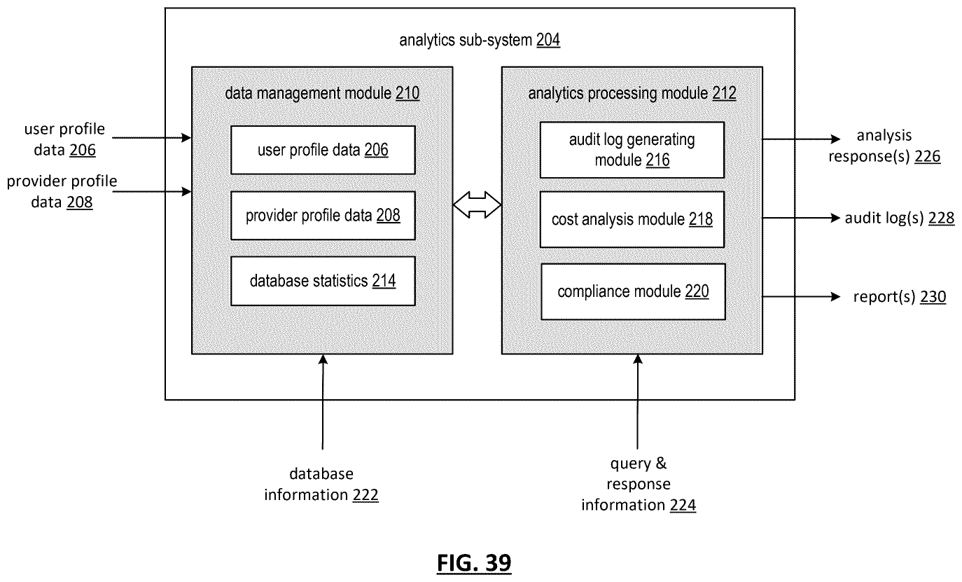

FIG. 39 is a schematic block diagram of an embodiment of an analytics sub-system 204 that includes one or more computing devices of the administrative sub-system 15 of the database system. The analytics sub-system 204 includes a data management module 210 and an analytics processing module 212. The data management module 210 stores and manages user profile data 206, provider profile data 208, and database usage data 214. User profile data 206 includes various user profile data for one or more end users of the database system. As used herein, an end user can correspond to a single person and/or single account holder that uses and/or owns one or more corresponding user devices. An end user can alternatively or additionally correspond to an entity, such as a company that accesses the data of the database system. In such embodiments, one or more individual users of one or more user devices can query the database system and/or otherwise interact with the analytics sub-system via a user interface (e.g. GUI) on behalf of the entity.

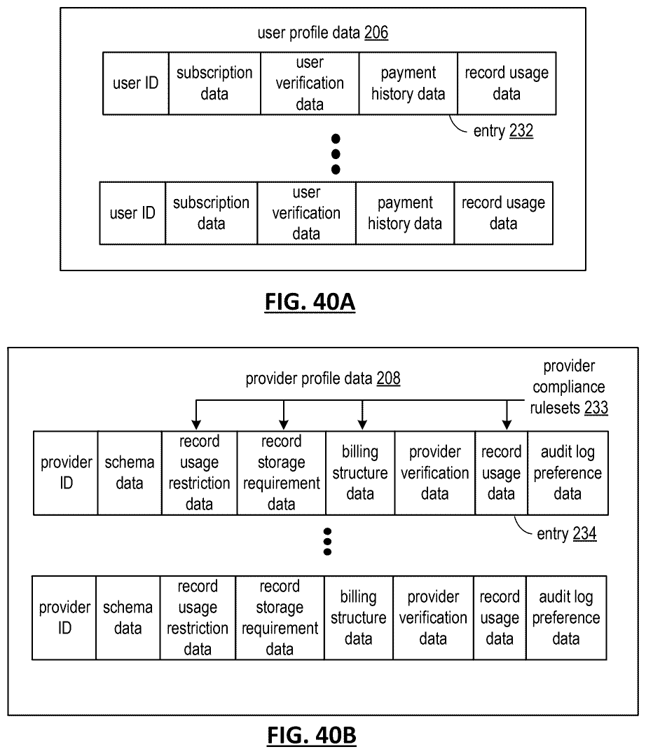

The user profile data 206 includes user identifiers (IDs), subscription data related to one or more data provider, user verification data, payment data, and/or database usage information. Examples of user profile data 206 are discussed in more detail with reference to FIG. 40A. The provider profile data 208 includes provider identifiers (IDs), schema data, database usage restriction data, database storage requirement data, billing data, provider verification data, database usage data, and/or audit log preference data. Examples of provider profile data 208 are discussed in more detail with reference to FIG. 40B.

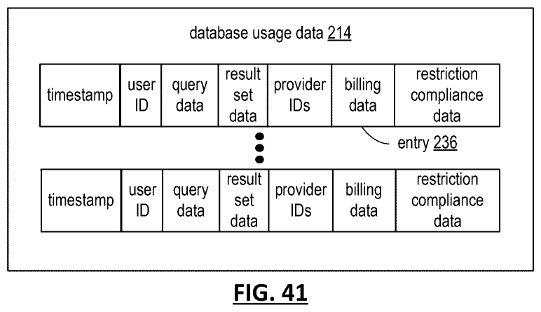

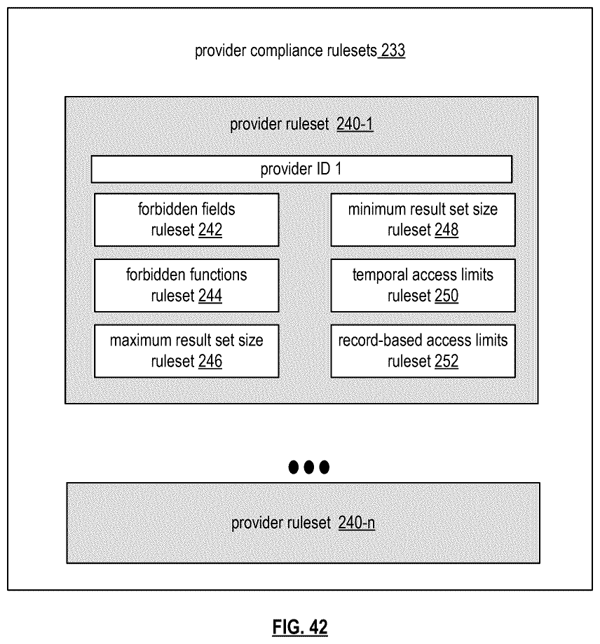

The database usage data 214 includes database information 222 related to past or current queries associated with users and/or providers of the database system such as a query timestamp, user ID, query data, result set data, provider ID(s), billing data, and/or compliance data. Examples of database usage data 214 are discussed in more detail with reference to FIG. 41.

The analytics processing module 212 includes an audit log generating module 216, a cost analysis module 218, and a compliance module 220. The analytics processing module 212 obtains query and response information 224 (e.g., a query analysis request) and generates one or more analysis response(s) 226, audit log(s) 228, and/or report(s) 230 based on information stored by the data management module 210 and on various analyses, functions, and/or procedures. In an example, the analytics processing module 212 can evaluate whether or not to execute a query against the database system and/or can evaluate whether or not to return a result set to an end user.

The analytics processing module 212 can retrieve provider data such as rules indicated in record usage restriction data or other sections of the provider profile data 208. This can include sending a provider data request to the data management module 210 and receiving record usage restriction data or other provider profile data for one or more data providers in response. This can further include indicating a particular provider identifier in the provider data request in response to receiving a query request that involves usage of data supplied by a data provider associated with the provider identifier and/or in response receiving a result set that includes and/or is derived from data supplied by a data provider associated with the provider identifier.

In response, the data management module 210 can send the one or more provider rules such as record usage restriction data for the identified data provider to the analytics processing module 212. The analytics processing module can utilize the record usage subscription data for a particular provider to evaluate a query and/or this corresponding result set generated by executing the query against the database system. As another example, record usage restriction data for multiple data providers can be retrieved and stored locally for usage by the analytics processing module 212 in evaluating future queries and/or result sets. For example, record usage restriction data can be sent to the analytics processing module in response to being updated in provider profile data by a data provider.

The analytics processing module 212 can retrieve user data such as a subscription data and/or record usage data from the data management module 210. This can include sending a user data request for user profile data 206 and receiving subscription data, record usage data, or other user profile data for one or more end users in response. This can further include indicating a particular user identifier in the user data request in response to receiving a query request from a corresponding end user. In response, the data management module 210 can send subscription data and/or record usage data for the identified end user to the analytics processing module 212.

Furthermore, a particular provider identifier can be indicated in response to a query involving usage of data supplied by a data provider associated with the provider identifier and/or in response to receiving a result set that includes and/or is derived from data supplied by a data provider associated with the provider identifier. In response, the data management module 210 can send record usage data for identified end user, specific to data supplied by the data provider, to the analytics processing module 212. Similarly, the data management module 210 can send subscription data for the identified end user, specific to their subscription with the specified data provider, to the analytics processing module 212. The analytics processing module 212 can utilize the subscription data and/or record usage data for a particular end user to evaluate a query received from the end user and/or the corresponding result set generated by executing the query against the database system.

In other examples, subscription data and/or record usage data for multiple users can be retrieved and stored locally for usage by the analytics processing module 212 in evaluating future queries and/or result sets. For example, subscription data can be automatically sent to the analytics processing module 212 by the data management module 210 in response to being updated in user profile data 206 by the end user and/or by an automatic determination. As another example, record usage data can be sent to the analytics processing module 212 by the data management module 210 in response to being updated in user profile data 206 based on recent usage of records of the database system.

The various outputs produced by the analytics processing module 212, the audit log generating module 216, the cost analysis module 218, and the compliance module 220 will be discussed in more detail with reference to one or more of the subsequent figures.

FIG. 40A is an example of an embodiment of user profile data 206 stored and/or managed by the analytics sub-system. The user profile data 206 includes a plurality of entries 232 corresponding to users of the database system. Each entry 232 can indicate information for a corresponding end user, for example, keyed by a user ID. Some or all of the fields of an entry 232 can be populated based on user profile data received from a user device, for example, based on user input by an end user to a GUI. Alternatively, some or all of the fields of an entry 232 can be populated by data generated automatically by the analytics sub-system. While one embodiment of an entry 232 is shown, different embodiments may not include all of the fields illustrated in FIG. 40 and/or can include additional fields to provide additional information corresponding to a user.

An entry 232 for a particular end user can include subscription data. This can indicate which subscription level the user is subscribed to for one or more different data providers. In such embodiments, the end user can select and/or provide payment for their desired subscription level, which can be the same or different for different data providers. In another example, subscription data can be automatically populated to indicate which subscription level has been reached by the user, determined automatically by the analytics sub-system based on the user's usage of data in a most recent billing period and/or over time. This can require that the user provide payment in response to reaching the corresponding subscription level in a given billing period.

An entry 232 for a particular end user can include user verification data. The user verification data can indicate provider account credentials and/or encryption key data utilized by the analytics sub-system to verify that user devices transmitting query requests were indeed sent by a verified end user that is authorized to and/or has sufficient subscription level to receive the resulting query response. This can further be utilized to track which queries were performed for each of a plurality of end users.

An entry 232 for a particular end user can include payment history data. This can indicate payments the user has made in a billing period or across multiple billing periods to the analytics sub-system and/or for designation to individual data providers. This can be utilized by the analytics sub-system to automatically determine which subscription level the user has paid for and thus can set the subscription level of the subscription data of the entry automatically for one or more data providers and/or for the analytics sub-system as a whole. This can further be utilized to track payment by the user in accordance costs of performing individual queries set by the billing structure data of one or more data providers.

An entry 232 for a particular end user can include record usage data. This can indicate various metrics indicating amount and/or type of usage by the end user of various records provided by one or more particular data providers, over time and/or within a current timeframe. This can be utilized to determine billing and/or subscription level of the end users and/or by the analytics system as a function of amount and/or type of queries performed on data, for example, in each of a series of billing periods. This can further be utilized in determining whether any threshold maximum usage set by particular providing entities in their record usage restriction data has been reached by the user within a current timeframe and/or over time.

FIG. 40B is an example of an embodiment of provider profile data 208 stored and/or managed by the analytics sub-system. The provider profile data 208 includes a plurality of entries 234 corresponding to data providers related to the database system. An entry 234 of provider profile data 208 indicates information for a corresponding data provider keyed by a corresponding provider ID.

Some or all of the fields of an entry 234 can be populated based on provider profile data received from a provider computing entity, for example, based on user input by a user associated with the corresponding data provider to a GUI. In an example, some or all of the fields of an entry 234 can be populated by data generated automatically by the analytics sub-system. While one embodiment of an entry 234 is shown, different embodiments may not include all of the fields illustrated in FIG. 40B and/or can include additional fields in entries 234 to provide additional information corresponding to a data provider.

An entry 234 for a particular data provider can include schema data, which can indicate a data format of records included in one or more data streams transmitted by the corresponding data provider. This schema data can be utilized by the analytics sub-system to determine the types and/or formatting of one or more fields included in the data stream for each individual record, and/or to extract the values from a data stream.

An entry 234 for a particular data provider can include record usage restriction data. Unrestricted access of the database system by end users can lead to privacy concerns and licensing concerns for data providers. Furthermore, data providers may be required to adhere to data privacy requirements set by regulatory entities. To resolve these concerns, data providers can select and/or customize record usage restriction data, which can indicate a particular set of rules or other restrictions on the usage of their data by end users. As discussed in further detail herein, the record usage restriction data can be utilized by the database system to ensure that data that was supplied by the data provider is queried and accessed in adherence with the rules administered by the data provider.

An entry 234 for a particular provider can include record storage requirement data. The encryption of data and/or geographic location of stored data can be of concern to data providers, especially if the data is particularly sensitive, is particularly valuable, and/or if the data providers are required to adhere to data privacy requirements set by regulatory entities. Data providers can select and/or customize record storage requirement data, which can indicate how and/or where different types of records and/or different types of fields supplied by the data provider are stored by the database system. The record storage requirement data can be utilized to write records supplied by the data provider to the database system, for example, by dictating how these records are encrypted and/or where these records are physically located.

An entry 234 for a particular data provider can include billing structure data. Data providers can be incentivized to share their collected data with the analytics sub-system via payments for usage of the data by particular end users and/or by the analytics sub-system as a whole. Data providers can select and/or customize a billing structure for the usage of their data. In particular, the billing structure data can indicate costs to end users and/or the analytics sub-system for different numbers and/or types of queries performed on different types and/or numbers of fields for different types and/or numbers of records.

For example, cost of a query can be a function of the number of records used in an aggregation and/or returned in a result set; can be a function of whether or not raw and/or aggregated data is returned: can be a function of the fields and/or combination of fields used and/or returned. The billing structure data can dictate costs and/or requirements for various subscription levels for end users, for example, where end users are granted greater access and/or querying capabilities on data supplied by the data provider if they have a higher level and/or higher cost subscription plan. Billing structure data can indicate the restriction of data usage as a function of cost and/or subscription level. The billing structure data can be utilized by the analytics sub-system to facilitate payments to the data provider, to charge end users based on their subscription level and/or usage of the data supplied by different providers, and/or to ensure that data that was supplied by the data provider is queried, accessed, and billed for in adherence with the billing structure and corresponding usage restrictions configured by the data provider.

An entry 234 for a particular data provider can include provider verification data. The provider verification data can indicate provider account credentials, encryption key data, and/or verification requirements set by the provider in the provider profile data and/or generated by the analytics sub-system as a requirement of the analytics sub-system to verify providers. In particular, the provider verification data can be utilized by the analytics sub-system to verify that data streams were collected by the corresponding data provider entity: that the data streams were not corrupted in their transmission from the data provider, and/or in transmission from their original data collection device; and/or that data streams were not fabricated by a faux providing entity seeking payment from end users for falsified data; and/or that data streams were not maliciously obtained from a true providing entity. This can increase the integrity of the data stored in database system by helping to ensure that end users are accessing authentic data that was supplied by a verified data provider and further helping to ensure that only verified data providers are allowed to benefit from supplying their own data.

An entry 234 for a particular data provider can include record usage data. Record usage data can indicate various metrics indicating amount and/or type of usage of various records provided by the data provider over time and/or within a current timeframe. This can further indicate and/or be generated based on particular records accessed by particular users over time. This can be utilized to determine billing by particular end users and/or by the analytics sub-system as a function of amount and/or type of queries performed on data, for example, in each of a series of billing periods.

An entry 234 for a particular data provider can include audit log preference data. This can indicate customized preferences regarding generation of audit logs for the provider. The audit log preference data can indicate frequency of generation and/or transmission of audit logs: filtering parameters indicating which types of usage log entries should be included in audit logs; device identifiers and/or account identifiers for particular recipients for the audit logs: summary metric preferences indicating one or more aggregating functions to be performed on usage log entries to generate the audit logs; and/or other formatting, layout, and/or viewing preferences for audit logs.

The analytics sub-system is operable to extract information from the provider profile data 208 as provider compliance rulesets 233. The compliance provider rulesets 233 may include information from one or more of the record usage restriction data, record storage requirement data, billing structure data, and record usage data.

FIG. 41 is an example of an embodiment of database usage data 214 stored and/or managed by the data management module. The database usage data 214 may be a part of the database store and compute sub-section and/or query log or an independent collection of data related to potential analytical functions. The database usage data 214 includes a plurality of entries 236 corresponding to queries by users and/or providers against the database system over time. A query with a corresponding entry 236 can correspond to a query that executed against the database system, where a result of the query was transmitted to the requesting end user.

In some cases, a query with a corresponding entry 236 can correspond to a query that was partially and/or fully executed against the database system where the result of the query was determined not to be transmitted to the requesting end user. In some cases, a query with a corresponding entry in the database usage data 214 can correspond to a query that was received in a query request but was determined not to be executed against the database system. As used herein, a query can correspond to a single query and/or can correspond to a plurality of queries in a same transaction, for example, where the transaction including the multiple queries was received from a same user device in a single query request or in a series of query requests.

An entry 236 for a particular query can include a timestamp indicating a time and/or temporal period at which the query was received by the database system, a time and/or temporal period at which the execution of the query against the database system commenced, and/or a time and/or temporal period at which the execution of the query against the database system was completed. An entry 236 can include a unique query identifier and/or an identifier indicating an ordering at which the query was executed relative to other queries logged in the database usage data 214.

An entry 236 for a particular query can include a user ID, indicating an identifier of a particular end user that generated and/or transmitted the query request that included the query. This user ID can thus map to a corresponding entry 236 in the user profile data of the data management module. An entry 236 for a particular query can include query data, indicating information about the query itself. This can include some or all of the original query request and/or some or all of the query executed against the database system. This can include identifiers indicating one or more query functions included in the query and/or can include domain data indicating one or more tables, fields, and or records involved in the query.

An entry 236 for a particular query can include result set data. This can include the output that resulted from execution of the query against the database system at the time of the query (e.g., runtime resultant data). This can include intermediate values and/or intermediate result sets generated in executing the query. This can indicate a number of records included in the result set and/or record identifiers for records included in the result set. This can indicate a number of records utilized in an aggregation and/or other query function utilized to produce the result set. This can indicate whether or not the result set included raw values of one or more fields. This can indicate a number of fields included in the result set as raw or derived values and/or identifiers for a set of fields included in the result set as raw or derived values.

An entry 236 can include one or more provider IDs. This can include provider IDs responsible for providing the data for any records that were utilized in executing the query. This can include provider IDs for any records included in the result set. In some cases, each provider ID can each be mapped to corresponding records indicated in the result set data of the entry.

An entry 236 can include billing data. The billing data can indicate line item and/or total costs for execution of a query of portion thereof. The billing data can indicate multiple costs corresponding to multiple subscription levels and/or can indicate costs for a particular subscription level for the end user that sent the query request. The billing data can subdivide costs for each of a plurality of data providers associated with the request, for example, denoted by their corresponding provider IDs. The billing data can be generated automatically by the analytics processing module and/or can be generated and received from another subsystem, such as the query and response sub-system.

An entry 236 can include restriction compliance data. Restriction compliance data includes information regarding whether or not a query and/or result set met one or more requirements of corresponding record usage restriction data for one or more corresponding providers. This can further include an indication of whether or not a query was executed and/or whether or not the result set was transmitted back to the end user. This can further include indications of one or more reasons that the corresponding query was not executed. For example, one or more particular rules of the record usage restriction data that were not adhered to in the query can be indicated and/or one or more portions of the query that did not adhere to one or more corresponding rules of the record usage restriction data can be indicated. Similarly, one or more particular rules of the record usage restriction data that were not adhered to in the final result set and/or in intermediate results can be indicated and/or one or more portions of the final result set and/or in intermediate results that did not adhere to one or more corresponding rules of the record usage restriction data can be indicated. This can further indicate which providers, such as a single provider or proper subset of providers involved in the query, had rules that were adhered to and/or had rules that were not adhered to in the query and/or result set.

The database usage data entries can be generated automatically by the analytics sub-system, for example, by the query and response sub-system. In particular, the query and response sub-system can determine values and/or other information for some or all of the fields of an entry, for example, in response to receiving a query request from a user device, in response to initiating execution of a query against the database system, and/or in response to receiving a result set in response to execution of a query. Information regarding the query request, query, and/or result set can be utilized to generate the corresponding database usage data entry, and the database usage data entry can be sent to the data management module for storage.

Information regarding database usage data can be added to provider profile data and/or to user profile data as record usage data. Some or all record usage data can be sent automatically, for example in response to being received for storage: in predefined intervals: in response to receipt of a corresponding request from a requester, etc. For example, the data management module can request record usage data derived from the database usage data 214 indicating one or more particular data providers, denoted by their corresponding provider IDs. Similarly, the data management module can request record usage data derived from the database usage data 214 indicating one or more particular end users, denoted by their corresponding user IDs.

FIG. 42 is an example of an embodiment of provider compliance rulesets 233 of provider profile data 208 stored by the analytics sub-system. The provider compliance rulesets 233 includes a plurality of provider rulesets 240-1 through 240-n extracted and/or provided from sections of provider profile data. A provider ruleset 240-1 through 240-n can indicate and/or be mapped to a provider ID of a data provider that generated the rules and/or for which the provider ruleset otherwise applies. A provider ruleset includes a set of rules related to a particular provider that indicates requirements for usage of data by end users. In an example, a provider ruleset 240-1 related to a provider with a provider ID 1 includes a forbidden fields ruleset 242, a forbidden functions ruleset 244, a maximum result set size ruleset 246, a minimum result set size ruleset 248, a temporal access limits ruleset 250, and a record-based access limits ruleset 252. More or less rulesets and/or rules within rulesets are possible.

Different rulesets can be customized and enforced for data supplied by different providers. Further, different rulesets can be customized and enforced for data accessed by users at differing subscription levels. Alternatively, the analytics sub-system can calculate or otherwise determine rulesets for different subscription levels automatically as a function of the cost of the subscription level and/or as a function of the favorability of the subscription level. For example, subscription levels corresponding to a higher recurring payment, higher cost, and/or otherwise more favorable subscription levels can be configured with higher maximums or lower minimums that those configured for less favorable subscription levels to enhance the experience for the users at increasingly more favorable subscription levels.

Additionally, providers can further configure licensing for different data fields of their records, for example, corresponding to different levels of valuation of different data fields and/or different levels of demand for usage of different data fields. This is achieved by enabling customization of different rules for access to different fields, different numbers of fields, and/or different combinations of fields. Alternatively, the analytics sub-system can calculate or otherwise determine rulesets for different fields automatically as a function of the value of the data included in the field, the number of fields, and/or a level of demand for the data included in the field by end users. For example, a higher maximum can be configured for result sets that include a greater number of fields and/or that include particular fields of a lower value, while a lower maximum can be configured for result sets that include a smaller number of fields and/or that include particular fields of a higher value to impose greater limits on access to the higher valued data.

Furthermore, providers can further control licensing of data based on whether it is returned to end users as raw values or utilized as an intermediate step in performing a query. This is achieved by enabling customization of different rulesets for final result sets returned to end users and intermediate result sets utilized in execution the query, for example, as input to one or more particular aggregation functions. Alternatively, the analytics sub-system can calculate or otherwise determine rules related to result set sizes for types of result sets automatically as a function of the level of aggregation that will be applied to the result set. For example, a lower maximum can be configured for results sets that are returned to the end user as raw data while a higher maximum can be configured for result sets that are utilized as input to aggregation functions. This can be favorable in cases where access to raw data of a set of records is deemed more valuable and/or requires greater bandwidth than access to results of aggregations performed on a set of records.

In some cases, the rulesets can be configured by the provider and/or automatically based on bandwidth restrictions and/or processing restrictions, where rulesets are set such that the volume of data that can be transmitted and/or utilized in performing an aggregation is within reason for the database system to function properly without its resources becoming exhausted. This can further be a function of the type of data and/or number of bytes utilized for different fields, where lower maximums are set for fields that include multimedia data and/or otherwise richer data, and higher maximums are set for fields that include primitive data types or otherwise less less-rich data.

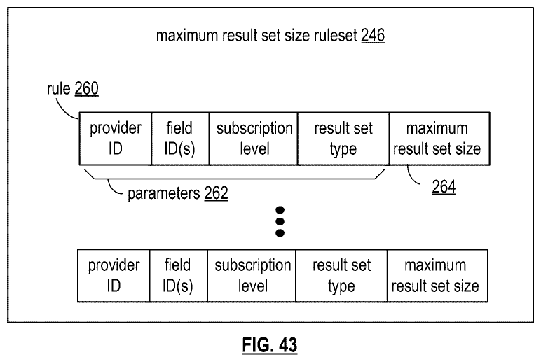

Rules in the plurality of rulesets can have one or more corresponding parameters indicating conditions in which the rule is applicable to a given query and/or result set. For example, a parameter can indicate a particular provider's data to which the rule applies and/or a particular field to which the rule applies. Examples of the forbidden fields ruleset 242, the forbidden functions ruleset 244, the maximum result set size ruleset 246, the minimum result set size ruleset 248, the temporal access limits ruleset 250, and the record-based access limits ruleset 252 are provided with reference to FIGS. 43-48.

FIG. 43 is an example of an embodiment of a customized maximum result set size ruleset 246 related to a particular provider. The maximum result set size ruleset 246 includes a plurality of rules 260. Each rule 260 can indicate a maximum result set size 264 for result sets of queries received by the database system. For example, the maximum result set size 264 can indicate a value that corresponding to the maximum allowable number of records in a result set, where result sets with a number of records that exceeds this value are non-compliant with this rule.

Each rule 260 can further indicate one or more rule parameters 262, denoting the conditions under which this particular maximum result set size 264. The parameters 262 of a rule 260 can include at least one provider ID, denoting which provider from which the rule 260 was received in a corresponding provider ruleset. The parameters 262 of a rule 260 can include one or more particular field IDs and/or groupings of field IDs, denoting the corresponding maximum result set size 264 applies to result sets that include one or more of the particular field IDs and/or one or more of the groupings of field IDs. The parameters 262 of a rule 260 can include one or more subscription levels, denoting the maximum result set size 264 applies to queries received from users at a corresponding subscription level indicated in the one or more subscription levels. The parameters 262 of a rule 260 can include a result set type, denoting whether the corresponding maximum result set size 264 applies to result sets to be returned by the query as the final result, whether this maximum applies to result sets that are used in an aggregation, and/or whether this maximum applies to result sets that are otherwise intermediate results sets generated in executing the query. For example, a particular rule 260 can indicate that records returned in queries that include the values for field C can include a maximum of 500 records supplied by provider X for users at subscription level I.

In some embodiments, field conditionals such as ranges of acceptable and/or unacceptable raw values or aggregated values for the fields included in the result set unto which the maximum size applies can be indicated in the parameters 262 or otherwise apply to the rule. For example, a particular rule 260 can indicate that records in a result set that include field C can include a maximum of 500 records where the value field C is between 50 and 100. Such field conditionals and/or ranges of acceptable and/or unacceptable raw values or aggregated values for other fields of records included in the result set, even if these fields themselves are not included in the result set, can be further indicated as parameters 262. For example, a particular rule 260 can indicate that records in a result set that include field C, but not field G, can include a maximum of 500 records where the value field G is equal to “BLUE,” “GREEN,” or “YELLOW.”

Some rules 260 can include fewer parameters 262 and/or can include additional parameters 262 not indicated in FIG. 43. In some cases, each listed parameter 262 must be met for the corresponding maximum result set size 264 to be retrieved, checked, and/or applied by the analytics sub-system for the given query. In some cases, the analytics sub-system must determine the conditions of each listed parameter 262 of a rule 260 match or otherwise compare favorably to those of a given query or result set for a determination of non-compliance with rule 260 to be possible.

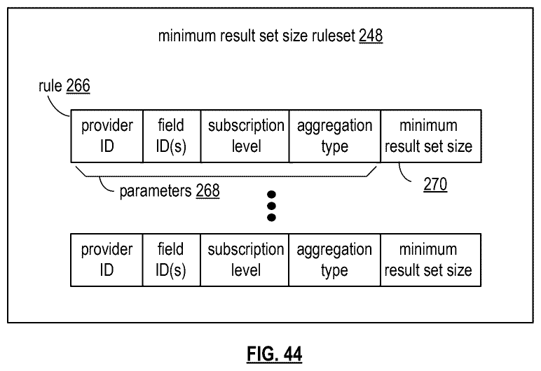

FIG. 44 is an example of an embodiment of a minimum result set size ruleset 248, which designates a minimum number of records that can be included in result sets utilized in aggregations. The example of FIG. 44 is similar to the example of FIG. 43 except that the rule is related to a minimum number of records rather than a maximum. Enforcement of a minimum result set size ruleset can serve to enhance the functionality discussed with regards to enforcement of a forbidden fields ruleset and/or the forbidden functions ruleset. In particular, the minimum result set size ruleset can further limit the usage of sensitive fields and/or groupings of fields that may already be indicated as forbidden fields ruleset by further forbidding the usage of certain aggregations or other processing upon records that include these forbidden fields when these result sets are not of a large enough size. This can be preferable in cases where outright forbidding aggregations upon these fields as discussed in conjunction with the forbidden functions ruleset is deemed unreasonable, yet output of aggregations can still pose privacy concerns when applied to a small enough number of records.

An additional motivation for a minimum result set size ruleset 248 may be for maintaining anonymity and/or adhering to regulatory requirements relating to data privacy, rather than controlling licensing usage as discussed with regards to the minimum result set size ruleset 248, in some embodiments, the same minimum is applied regardless of user subscription level.

The analytics sub-system may calculate or otherwise determine minimums result set sizes for different fields automatically as a function of number of fields, a level of sensitivity of the data included in the field, and/or a level of susceptibility that data provided in the field can enabling identity matching. For example, a higher minimum can be configured for result sets that include a greater number of fields and/or that include particular fields that include more sensitive data and/or data that is more susceptible for enabling identity matching, while a lower minimum can be configured for result sets that include a smaller number of fields and/or that include particular fields that that include less sensitive data and/or data that is less susceptible for enabling identity matching.

Furthermore, providers can further enhance privacy of data based on the type of aggregation that is performed on the result set in the query. This is achieved by enabling customization of different minimums for different types of aggregations applied to the in execution the query, for example, as input to one or more particular aggregation functions.

The minimum result set size ruleset 248 includes a plurality of rules 266. A rule 266 can indicate a minimum result set size 270 to be enforced by the database system for result sets of queries received by the database system. For example, the minimum result set size 270 can indicate a value that corresponding to the minimum allowable number of records in a result set, where result sets with a number of records that exceeds this value are non-compliant with this rule. A rule 266 can further indicate one or more rule parameters 268, denoting the conditions under which this particular minimum result set size 270 is applicable to a given query and/or given result set.

For example, the analytics sub-system can determine compliance to a given minimum result set size 270 based on determining that the corresponding parameters 268 compare favorably to corresponding parameters determined by the analytics sub-system for the given query and/or result set.

The parameters 268 of a rule 266 can include at least one provider ID, denoting which provider from which the rule 266 was received in a corresponding provider ruleset 248 and/or otherwise denoting the corresponding minimum result set size 270 applies to data supplied by the corresponding at least one provider. The parameters 268 of a rule 248 can include one or more particular field IDs and/or groupings of field IDs, denoting the corresponding minimum result set size 270 applies to result sets that include one or more of the particular field IDs and/or one or more of the groupings of field IDs, and/or applies to result sets where an aggregation is performed upon the corresponding field ID or grouping of field IDs.

The parameters 268 of a rule 248 can include one or more subscription levels, denoting the minimum result set size 270 applies to queries received from users at a corresponding subscription level indicated in the one or more subscription levels. The parameters 268 of a rule 266 can include one or more aggregation types, denoting the minimum result set size 270 applies to result sets of queries where the corresponding type of aggregation performed on the result set in execution of the query. For example, a particular rule 266 can indicate that a set records of that include the values for field A and are utilized in an averaging function must include a minimum of 500 records supplied by provider X for users at subscription level I.

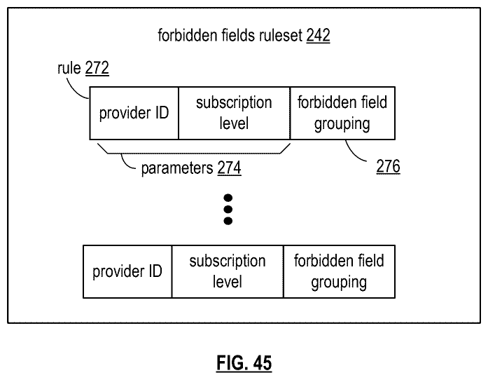

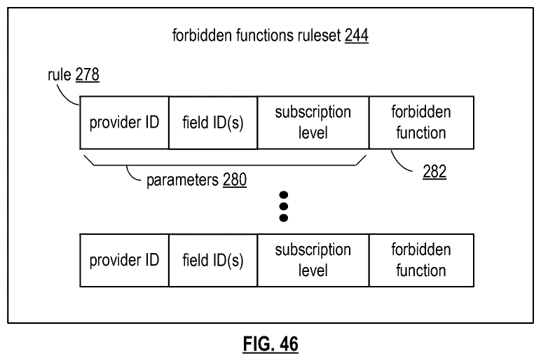

FIG. 45 is an example of an embodiment of a forbidden fields ruleset 242, which designates individual forbidden fields and/or sets of forbidden fields that cannot be returned to end users as raw data. The example of FIG. 45 is similar to the ruleset examples of FIGS. 43-44. The forbidden fields ruleset 242 includes a plurality of rules 272. A rule 272 can indicate a forbidden fields grouping 276, which can indicate one or more fields to be enforced by the database system as a grouping of forbidden fields for result sets of queries received by the database system.

For example, a forbidden fields grouping 276 can indicate a field identifier for a single field that can never be returned as raw data in a result set, or multiple field identifiers for a particular grouping of fields that can never be returned as raw data in tandem for a same record. A rule 272 can further indicate one or more rule parameters 274, denoting the conditions under which this particular forbidden fields grouping 276 is applicable to a given query and/or given result set. For example, the analytics sub-system can create compliance data based on determining that the corresponding parameters 274 compare favorably to corresponding parameters determined by the analytics sub-system for the given query and/or result set.

The parameters 274 of a rule 272 can include at least one provider ID, denoting which provider from which the rule 272 was received in a corresponding provider ruleset and/or otherwise denoting the corresponding forbidden fields grouping 276 applies to data supplied by the corresponding at least one provider. The parameters 274 of a rule 272 can include one or more subscription levels, denoting the forbidden fields grouping 276 applies to queries received from users at a corresponding subscription level indicated in the one or more subscription levels. For example, a particular rule 272 can indicate that records supplied by provider X returned in queries cannot include the combination of fields C and D for users at subscription level I.

FIG. 46 is an example of an embodiment of a forbidden functions ruleset 244, which can include a plurality of rules 278. The example of FIG. 46 is similar to the ruleset examples of FIGS. 43-45. A rule 278 can indicate a forbidden function 282, which can indicate one or more particular types of functions and/or one or more function parameters to one or more particular functions that are forbidden for application. This can include a single function, and/or can indicate a grouping of functions that cannot be applied upon the same result set, cannot be applied in a designated order, and/or otherwise cannot be applied in tandem in a query. This can further include an indication of whether the output cannot be returned to the end user but can be utilized as input to further processing in the query, or that the function cannot be applied in the query even for use as an intermediate result. For example, a forbidden function 282 can indicate an identifier or other information indicating the particular one or more forbidden functions.

A rule 278 can further indicate one or more rule parameters 280, denoting the conditions under which this particular forbidden function 282. For example, the analytics sub-system can determine to retrieve and/or utilize a given forbidden function 282, and/or can otherwise determine a given forbidden function 282 is applicable to a given query or result set, based on determining that the corresponding parameters 280 compare favorably to corresponding parameters determined by the analytics sub-system for the given query and/or result set.

The parameters 280 of a rule 278 can include at least one provider ID, denoting which provider from which the rule 278 was received in a corresponding provider ruleset and/or otherwise denoting the corresponding forbidden function 282 applies to data supplied by the corresponding at least one provider. The parameters 280 of a rule 278 can include one or more field ID indicating individual fields and/or field groupings upon which the forbidden function cannot be applied. The parameters 280 of a rule 278 can include one or more subscription levels, denoting the forbidden function 282 applies to queries received from users at a corresponding subscription level indicated in the one or more subscription levels. For example, a particular rule 278 can indicate that the result of an averaging function applied to field C of a set of records supplied by provider X cannot be returned in queries for users at subscription level I.

Some rules 278 can include fewer parameters 280 and/or can include additional parameters 280. In some cases, each listed parameter 280 must be met for the corresponding forbidden function 282 to be deemed compliant by the analytics sub-system. In some cases, the analytics sub-system must determine the conditions of each listed parameter 280 of a rule 278 match or otherwise compare favorably to those of a given query or result set for a determination of non-compliance with rule 278 to be possible.

In some embodiments, field conditionals such as ranges of acceptable and/or unacceptable raw values or aggregated values for the fields included in the result set unto which the forbidden function is applied can be indicated in the parameters 280 or otherwise apply to the rule. For example, a particular rule 278 can indicate that an averaging function for records in a result set that include field C is forbidden when any of the records in the result set have a value for field C that is less than 10. Such field conditionals and/or ranges of acceptable and/or unacceptable raw values or aggregated values for other fields of records included in the result set, even if these fields themselves are not included in the result set, can be further indicated as parameters 280. For example, a particular rule 278 can indicate that an averaging function for records in a result set that include field C, but not field G, is forbidden if the value field G is equal to ‘RED’ for all records in the set and/or for at least a threshold number of the records.

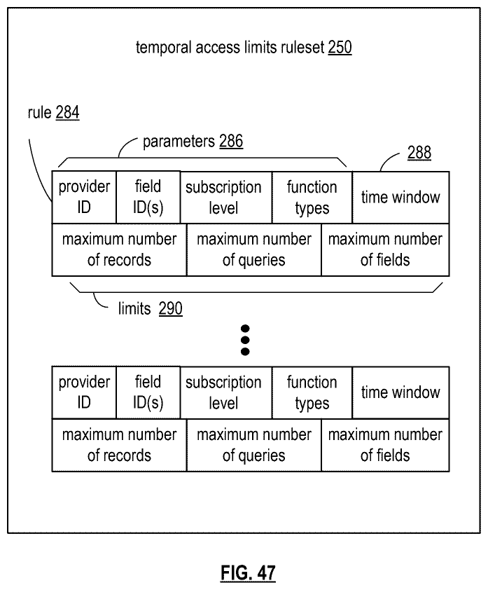

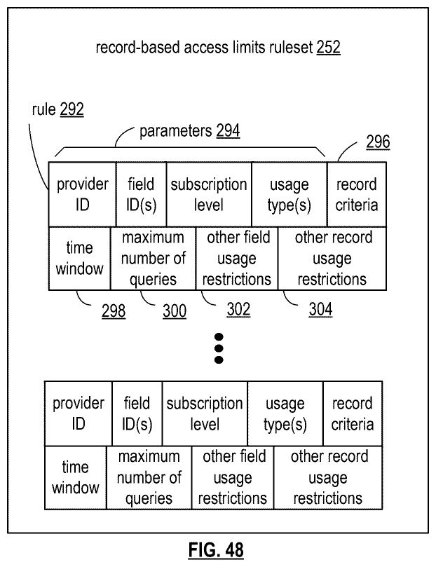

FIG. 47 is an example of an embodiment of a temporal access limits ruleset 250 and is similar to the examples of FIGS. 43-46. Enforcement of a temporal access limits ruleset can enhance the functionality of the maximum result set size ruleset. In particular, as the maximum result set size ruleset imposes limitations on the amount of data that a user can access for a particular query, a malicious user could surpass the rules invoked by the maximum result set size ruleset by, for example, subdividing their query into multiple independent queries for different, distinct sets of records filtered by distinct criteria that do not exceed result set size maximums individually. These distinct sets of records could then be ultimately combined into a single set that includes records meeting all of the criteria desired by the user, where this single set would have exceeded the maximum result set size requirements if requested in a single query. Tracking each user's access to records over time and utilizing a user's historical database accesses can be utilized to ensure a user does not receive and/or utilize more than a reasonable allotment of data within a particular timeframe and/or in an indefinite time period.

The temporal access limits ruleset 250 includes a plurality of rules 284. A rule 284 indicates a time window 288, along with at least one corresponding limit 290, which can include at least one of: a maximum number of records, a maximum number of queries, and/or a maximum number of fields to be enforced by the database system in accordance with the time window for queries received by the database system by different users over time.

The time window 288 can indicate a length for a sliding time window, for example, where the rule is invoked within a length of time indicated by the time window ending at the current time, such as within the last 48 hours. In another example, the time window 288 can indicate a recurring period of time that repeats at a fixed time regardless of the current time, for example, where the time window resets at the beginning of each day or each month. This configuration can be favorable in cases where subscriptions are paid and/or are in effect for a corresponding, recurring period. For example, the time window 288 can indicate the rule is invoked for all queries in the current month, where users are subscribed to a monthly subscription plan with recurring monthly payments. As another example, the time window 288 can otherwise indicate any start and/or end point for the time window and duration to indicate when and/or for how long the time window is in effect. In some cases, there is no time window, and the corresponding limits 290 are imposed indefinitely, where the maximums can never be exceeded across any length of time.

The maximum number of records of limits 290 can correspond to a number of distinct records and/or a total number of records, even if some of these records correspond to the same record. The maximum number of queries of limits 290 can correspond to a number of transactions, partial queries extracted from each received query request, and/or individual query functions performed against the database system. For example, a query request received from a user can include multiple queries applied towards this maximum. The maximum number of fields of limits 290 can correspond to a maximum number of fields of same or different records in the same or different table that can be accessed.

Each rule 284 can further indicate one or more rule parameters 286, denoting the conditions under which the one or more particular limits 290 for the given time window 288 are applicable for a given query and/or given result set. For example, the analytics sub-system can determine to retrieve and or utilize one or more limits 290 and/or corresponding time windows 288, and/or can otherwise determine given limits 290 and/or corresponding time windows 288 are applicable to a given query or result set, based on determining that the corresponding parameters 286 compare favorably to corresponding parameters determined by the analytics sub-system for the given query and/or result set. In particular, a limit 290 and/or corresponding time windows 288 can be checked by the analytics sub-system when a given query and/or given result set is determined to definitely and/or potentially increase the running total number of records, running total number of queries, and/or running total number of fields tracked for the user within the time window, for example, for the corresponding provider.

The parameters 286 of a rule 284 can include at least one provider ID, denoting which provider from which the rule 284 was received in a corresponding provider ruleset and/or otherwise denoting the limits 290 and/or time window 288 applies to data supplied by the corresponding at least one provider. The parameters 286 of a rule 284 can include one or more particular field IDs and/or groupings of field IDs, denoting the limits 290 and/or time window 288 applies usage of the particular field IDs and/or one or more of the groupings of field IDs. The parameters 286 of a rule 284 can include one or more subscription levels, denoting the limits 290 and/or time window 288 applies to queries received from users at a corresponding subscription level indicated in the one or more subscription levels.

The parameters 286 of a rule 284 can include a function type, denoting which type of functions apply to the limits 290 for the time window 288 and/or indicating whether the limits 290 for the time window 288 apply to queries and/or records returned to the user as raw values, or whether the limits 290 for the time window 288 apply to queries and/or records utilized in particular aggregation function, where the output returned to the user is based on the result of the particular aggregation function. For example, a particular rule 284 can indicate that no more than 500 queries within the last 7 days can include aggregation functions upon field C for records supplied by provider X for users at subscription level I. As another example, a particular rule 284 can indicate that no more than 500 records that include the combination of fields C and D and that are supplied by provider X can be returned as raw data to a user at subscription level I within the month of October.

In some embodiments, field conditionals such as ranges of acceptable and/or unacceptable raw values or aggregated values for the fields included in result sets unto which the limits 290 apply within the time window 288 can be indicated in the parameters 286 or otherwise apply to the rule. Such field conditionals and/or ranges of acceptable and/or unacceptable raw values or aggregated values for other fields of records included in result sets unto which the limits 290 apply within the time window 288, even if these fields themselves are not included in the result set, can be further indicated as parameters 286. These field conditionals can be applied in a similar fashion as discussed with regards to the maximum result set size ruleset.

Some rules 284 can include fewer parameters 286 and/or fewer limits 290, and/or can include additional parameters 286 and/or additional limits 290. In some cases, each listed parameter 286 must be met for the corresponding limit and/or time window to be retrieved, checked, and/or applied by the database system for the given query. In some cases, the analytics sub-system must determine the conditions of each listed parameter 286 of a rule 284 match or otherwise compare favorably to those of a given query or result set for a determination of non-compliance with rule 284 to be possible.

As discussed thus far, a rule 284 can impose the limits 290 for a particular user, where any user of the database system cannot exceed the respective limits 290 within the time window 288 as set for their respective subscription level. However, in other embodiments, a rule 284 can impose limits 290 across all usage within the timeframe, regardless of user. For example, the maximum number of records can correspond to the total number of distinct records accessed in total by all end users of the database system within time window 288 and/or in history, and/or the maximum number of queries can correspond to the total number of queries requested and/or performed in total for all end users of the database system within time window 288 and/or in history. This can be preferred by providers to ensure that multiple malicious users cannot consolidate data and/or to ensure that their data is otherwise not overly accessed. This can also be implemented by regulating entities and/or administrators of the database system to ensure the system is not performing too many queries in total and/or that de-privatization of data is not possible over multiple users.

FIG. 48 is an example of an embodiment of a record-based access limits ruleset 252 that is similar to rulesets of FIGS. 43-47. The record-based access limits ruleset 252 can impose limits for the usage of the same records within a given timeframe and/or over time in total. Enforcement of a record-based access limits ruleset can enable more stringent privacy regulation, for example, by ensuring a same record cannot be accessed too many times and/or be utilized in too many different ways in such as fashion that would enable identify matching and/or otherwise reduce and/or eliminate anonymity regarding one or more records. In such embodiments, rather than imposing a temporal limit, number of and/or types of queries that can be applied to the same record and/or multiple records with particular matching fields is restricted for the purpose of preventing identity matching.

In some cases, these restrictions are invoked for individual users to ensure the same user cannot de-privatize data. Alternatively, these restrictions can be invoked across all users or for defined sets of multiple users to prevent malicious users from consolidating their data, such as multiple fields of the same record that are restricted and/or multiple records with one or more matching fields that are restricted. In some cases, this can enhance the functionality of the forbidden fields ruleset by ensuring that forbidden fields groupings are not accessed across multiple different queries that, evaluated in isolation, would comply with forbidden fields rulesets, but where a set of fields for the same record that corresponds to a forbidden field is derivable across the multiple queries.

The restriction can also enhance the functionality of the temporal access limits ruleset by specifically limiting how much a user can access the same records, for example, to ensure that only most favorable subscription users are allowed to perform the higher number of queries with more sophisticated types of functions upon the same data over time, enabling greater analytical insights for these most favorable subscription users, while lower subscription users are only enabled low numbers of queries with basic functions upon same sets of data. Similarly, invoking longer time periods for usage of the same data by higher subscription users can enable more analysis to be performed by these users. These features can be particularly useful in embodiments where raw data is never accessible by end users, as their ability to access perform analytics on particular sets of data records is entirely limited by the rules invoked by such a record-based access limits ruleset for their subscription level.

As shown in FIG. 48, the record-based access limits ruleset 252 includes a plurality of rules 292. Some or all rules 292 can indicate a time window 298. The time window 298 can be implemented in the same and/or similar fashion as time window in FIG. 47. For example, time window 1516 can indicate a length for a sliding time window, for example, where the rule is invoked within a length of time indicated by the time window ending at the current time, such as within the last 48 hours. In another example, the time window 298 indicates a recurring period of time that repeats at a fixed time regardless of the current time, for example, where the time window resets at the beginning of each day or each month. This configuration can be favorable in cases where subscriptions are paid and/or are in effect for a corresponding, recurring period. For example, the time window 298 can indicate the rule is invoked for all queries in the current month, where users are subscribed to a monthly subscription plan with recurring monthly payments. As another example, the time window 298 can otherwise indicate any start and/or end point for the time window and duration to indicate when and/or for how long the time window is in effect. The time window 298 can otherwise indicate a time limit imposed on usage of records to which rule 292 applies.

In another example, some or all rules 292 can indicate a maximum number of queries 300. The maximum number of queries 300 can correspond to a number of transactions, partial queries extracted from each received query request, and/or individual query functions performed against the database system. In some cases, the maximum number of queries 300 otherwise indicates a limit imposed on an amount of usage of records to which rule 292 applies.

Each rule 292 can further indicate one or more rule parameters 294, denoting the conditions under which the given time window 298 is applicable and/or the given maximum number of queries 300 is applicable for a given query and/or given result set. For example, the analytics sub-system can determine to retrieve and or utilize one or more time windows 298 and/or one or more maximum number of queries 300 and/or can otherwise determine a given time window 298 and/or maximum number of queries 300 is applicable to a given query or result set, based on determining that the corresponding parameters 294 compare favorably to corresponding parameters determined by the analytics sub-system for the given query and/or result set.

In particular, a time window 298 and/or maximum number of queries 300 can be checked by the analytics sub-system when a given query and/or given result set is determined to involve and/or return a particular record and/or some or all of a particular set of records to which a corresponding rule 292 applies.

The parameters 294 of a rule 292 can include at least one provider ID, denoting which provider from which the rule 292 was received in a corresponding provider ruleset and/or otherwise denoting the maximum number of queries 300 and/or time window 298 applies to records supplied by the corresponding at least one provider. The parameters 294 of a rule 292 can include one or more particular field IDs and/or groupings of field IDs, denoting the time window 298 and/or maximum number of queries 300 applies usage of the particular field IDs and/or one or more of the groupings of field IDs of a particular record. The parameters 294 of a rule 292 can include one or more subscription levels, denoting the time window 298 and/or maximum number of queries 300 applies to queries received from users at a corresponding subscription level indicated in the one or more subscription levels.

The parameters 294 of a rule 292 can include a usage type, denoting which type of functions apply to the limits for the time window 298 and/or indicating whether the limits for the time window 298 apply to queries and/or records returned to the user as raw values or whether the limits for the time window 298 apply to queries and/or records utilized in particular aggregation function, where the output returned to the user is based on the result of the particular aggregation function. This can also indicate whether corresponding the fields can be utilized as filtering parameters, for example, in a WHERE clause of the query.

A rule 292 can further include record criteria 296, indicating whether the rule 292 applies to a particular record. This record criteria 296 can be considered a further parameter of the query and/or result set itself, for example, where a rule 292 is applicable to a given query and/or result set if it includes at least one record that meets the record criteria 296 of the rule 292. The record criteria can indicate age limits and/or bounds of the record, where the rule applies only to records within a given age range. The record criteria 296 can indicate the rule applies to records of a particular type, such as records included within a particular table, records that include one or more particular fields, and/or records whose data was collected by a particular data collection device. The record criteria can indicate one or more record identifiers, indicating the rule applies only to records with identifiers that match an identifier indicated in the record criteria. While the provider ID is indicated separately in FIG. 48, the provider ID can also be considered record criteria, indicating that the rule applies to records supplied by a particular provider.

The record criteria and/or other information indicated in rule 292 can indicate whether the rule applies to individual records meeting the record criteria, for example, where usage of individual records is tracked over time to determine whether or not the corresponding rule 292 is adhered to. In such cases, usage of each particular record meeting the record criteria may not be allowed to exceed the maximum number of queries 300 and/or may not be able to be used outside the indicated time window 298.

Alternatively, the rule can apply to all records indicated in a particular set of records indicated by the record criteria, such as records of a particular table: records collected by the same data collection device; records with one or more matching values in one or more particular fields: records with timestamps within a particular age range; records returned to a user in a same result set of a previous query: records in a same result set utilized in an aggregation of a previous query: records with record identifiers in a same set of record identifiers; and/or otherwise identified groups of records that are indicated in the record criteria. In such embodiments, the tracking of records can apply collectively to all records within these same identified sets, for example, where usage of multiple particular records within a same one of these indicated sets of records cannot exceed the maximum number of queries.

In particular, if the maximum number of queries 300 is set to 100 for a particular set of records, if a particular record in the set of records has been accessed in 20 queries, but 100 queries have already been run utilizing different records in this particular set of records, that particular record can no longer be accessed even though it has only been accessed 20 times itself. Similarly, the time window 298 can apply to all records within such a set, where any of the records in the identified set can only be accessed within the time window and/or can only be accessed in a number of queries indicated by maximum number of queries 300 within the particular time window 298.

In some cases, only a maximum number of queries is denoted in a rule 292, and a time window 298 is not included. In such cases, the rule can correspond to maximum total usage of the particular records meeting the record criteria 296 and/or for queries meeting parameters 294. For example, a particular record or particular group of records may be accessible for only the maximum number of queries and/or in a maximum number of distinct ways, across any span of time, to aid in prevention of identity matching. For example, a particular rule 292 can indicate that records provided by provider X that include field C can only be utilized in a maximum of 20 aggregations, and/or can only be returned once as raw values. Such rules can be applicable across all users or identified sets of users to prevent malicious users from consolidating records received to perform identity matching in tandem. For example, users located in the same geographic region, affiliated with the same company, and/or otherwise identified in the same group may not collectively be allowed more than the maximum number of queries upon individual records and/or any records within the same groups of records. In such cases, holistic usage of records can be tracked and/or determined across all user and/or usage of records across such a particular set of identified users can be tracked and/or determined. Alternatively, such rules can be applied on a user-by-user basis, where individual users are allowed to perform up to the maximum number of their own queries upon the data, given these queries meet parameters 294. For example, a particular rule 292 can indicate that each individual user is allowed up to 20 of their own aggregations upon records provided by provider X that include field C and/or is allowed one access to these records returned as raw data.

In such cases where restrictions are imposed due to de-privatizations concerns for particular records, alternatively or in addition to imposing a maximum number of queries 300, more specific limitations can be indicated in the rule 292 that restrict how records can be used across multiple queries. In some cases, forbidden field groups can be configured as discussed previously, and these forbidden field groups can be enforced for same records across multiple queries by the same user or different users. For example, the fields that have been accessed and/or have been returned to a particular user and/or to any user as raw data over time can be tracked and/or determined. Such information regarding forbidden fields groupings that are applicable for a same user, same group of users, and/or all users can be indicated in the rule 292 as other field usage restrictions 302.

In particular, if one or more field IDs are indicated for the rule 292 as parameters 294, indicating that the rule applies to records that involve one of these field IDs or all of these field IDs, the other field usage restrictions 302 can indicate one or more other fields of the record that must not have been previously accessed and/or returned for the rule to be adhered to. For example, the union of the set of field IDs indicated as parameters 294 and the set of additional field IDs indicated in the other field usage restrictions 302 can yield a forbidden fields grouping. Queries that, when executed, do not return or utilize all necessary fields for any record to which a rule 292 is applicable that render the entirety of any forbidden fields groupings will comply with such rules. Queries that, when executed, will return or utilize all necessary fields for at least one record to which a rule 292 is applicable that render the entirety of at least one forbidden fields groupings will not comply with such rules.

Consider a case where a proper subset of a forbidden fields grouping indicated in the other field usage restrictions has already been returned and/or utilized by the same user and/or by any user for a particular record. Suppose a given query involves utilization of or returning of one or more additional fields of this particular record. If these additional fields, in union with the proper subset of the forbidden fields grouping yields at least the entirety of the forbidden fields grouping, the query and/or result set the includes these additional fields of the particular records can be determined to be non-compliant and execution of the query and/or returning of these additional fields to the requesting user can be foregone by the analytics sub-system.

In some embodiments, field conditionals such as ranges of acceptable and/or unacceptable raw values or aggregated values for other fields not utilized in the query, but previously utilized in different queries, can be indicated in the other field usage restrictions 304, indicating particular conditions the other fields must meet for the corresponding other field usage restrictions to apply. Such field conditionals and/or ranges of acceptable and/or unacceptable raw values or aggregated values can be set for other fields of records not utilized in previous queries or the current query but still pertaining to fields of the same record utilized in the current query or a previous query. These field conditionals can be applied in a similar fashion as discussed with regards to the forbidden fields ruleset by enforcing the field conditionals for forbidden fields groupings across multiple queries.

In some cases, enforcing forbidden fields groupings over time for records individually is not sufficient in preventing identity matching, as identity matching can involve utilization of multiple records that are related to gain insights for a particular person and/or to otherwise deduce private information given multiple related records. Alternatively or in addition, access to many similar records may induce privacy concerns, for example, if they all correspond to a same person, a same mobile device, a same vehicle, a same mailing address, a same company and/or other same entity that may have data multiple records of the same or different type that in tandem supply private information.

In cases where identity matching or additional privacy matters due to access to multiple related records is of concern, some rules 292 can invoke additional restrictions for usage of a set of related records and/or that otherwise restrict usage based on past usage of other particular records. In particular, access sets of records with matching values for a particular field, and/or for each of a set of particular fields, can be rendered forbidden for some or all individual users, across particular sets of users, and/or across all users. Some rules 292 can indicate a maximum number of records and/or a distinct set of different types of records that can be returned to users over time and/or that can be utilized in queries over time. For example, the rules 292 can indicate that no more than 15 records can be returned to a user if they have a matching mailing address field. In such cases, such rule can apply even if the mailing address field is not accessed and/or utilized in the query, where only other fields of these records with the matching mailing address field are being accessed.

As another example, suppose the database contains records supplied by a car company that identify addresses of people that are owners of cars, records supplied by a credit card company that identify people that identify addresses of people that are customers of the credit card company, and records supplied by a telecommunications company that all contain identifying identify people that identify addresses of people that subscribe to a telecommunication service provided by the telecommunications company. A rule 292 can indicate that if a single record of the car company and/or if at least a threshold number of records of the car company with a matching person identifier are accessed by an end user, then no records, or up to a threshold number of records, supplied by the credit card company with the same person identifier as these one or more records supplied by the car company can be accessed. As another example, a rule 292 can indicate that if records with matching person identifiers are accessed by the same end user from any two of these three data providers, no records can be accessed from the remaining third one of these three data providers that also identify the same person.

Such limitations invoked by previous accesses to other records supplied by the same or different provider can be indicated as other records usage restrictions 304 of a particular rule 292. In particular, if a particular record meets record criteria 296 and/or the query meets the parameters 294, a record being accessed in the query can be evaluated for compliance with the rule 292 based on determining whether previous access to other records by the same or different user are deemed forbidden by the other record usage requirements. In particular, particular field IDs or field groupings accessed for different records previously, record criteria for these other records, number of other records accessed that meet particular criteria, time frames in which these records were accessed, user IDs or types of users that performed the previous access, and/or other criteria can be denoted that, when met by the previous accesses logged in the database usage data 214, render non-compliance with the corresponding the rule 296.

In some cases, a maximum number of queries 300 and time window 298 can both be indicated for a particular rule. In such cases, the indicated maximum number of queries 300 can be applied to the particular time window 298 in the same or similar fashion as discussed in conjunction with the temporal access limits ruleset, where the rule is specific to same records meeting the record criteria and/or any records within the same group. For example, a particular rule 292 can indicate that any particular record supplied by provider X can be utilized in no more than 50 queries in a given month.

In such embodiments where a time window 298 is indicated, a given time frame can be fixed, where a given record can only be accessed within the maximum number of queries, which all need to take place within the fixed time window. For example, records meeting particular criteria can only be accessible for a fixed time frame, such as a given month. Alternatively, any particular record, once accessed by a user for the first time, is then only available to the user for the length of the time window, where the time window for a particular record starts with the first access of the particular record. In such cases, any further access can be prohibited outside the time frame, even if the user never reached the maximum number of usages. This can be further useful in preventing de-privatization and/or identity matching by not only limiting the number of times a user can access a particular record, but by further limiting the total amount of time the record is available to the user for use.

Alternatively, the time window can correspond to a recurring time frame, where record usage tracking can reset as a new time window begins. In particular, the resetting of record tracking for particular records by a particular for a new time window can be enabled in conjunction with a user renewing their subscription for the new time window. For example, usage of a same record can be again acceptable for up to a maximum of 50 queries by a user in the current month, even if the user had already used this record in the maximum number of 50 queries in the previous month. Such embodiments can be ideal for records where identity matching is not possible and/or is not of concern, and thus where unlimited usage of a record by a user does not pose privacy concerns. In particular, this can encourage users to renew their subscription plan in future time frames so they again can continue usage of the same data records, for example, after reaching their maximum usage within a given month, to further the insights possible for these records.

In some cases, only a time window 298 is denoted in a rule 292, and a maximum number of queries or other amount of usages is not included. In such cases, the rule can correspond to a “rental period” for licensing of particular records meeting the record criteria 296 and/or for queries meeting parameters 294. For example, a particular end user may be granted an unlimited number of queries and/or unlimited access to a set of records denoted in the record criteria so long as this access falls within the time window. For example, a particular rule 292 can indicate that records provided by provider X where field C is greater than 100 can only be accessed by users at subscription level I in the month of July, while users at more favorable subscription level II are granted access to these records provided in the month of June for the remainder of the calendar year.

The time window can reset with each recurring time window as discussed above, for example, as a user continues to pay for their subscription, enabling unlimited access of data records as the user continues paying for their subscription. Alternatively, the time window for a particular record or set of records can similarly begin with the first access to the particular record or set of records, where access to a particular record or set of records is unlimited for the length of time specified by the time frame, but where the user is prohibited from further access of the particular record or set of records once this length of time has elapsed. Alternatively, the time window for a particular record can be otherwise fixed, for example, where particular records meeting particular criteria is only available for use within a particular month. For example, these particular records meeting the record criteria, can “expire” from future usage by users, where the usage of such records will only ever be available to a given user within the specified time window, and/or where the amount of time that a given record is available for usage increases with more favorable subscription levels.

One example of conditioning the fixed time window on record criteria is in scenarios where the age of a record is utilized to dictate its lifetime of usage. In such cases, the time window 298 for a particular record can be a function of the timestamp or other indication of age of the record itself. For example, a rule 292 can indicate that particular records provided by a particular provider, and/or particular usage of records by users at particular subscription levels, is available only within a fixed of time from the time in which the record was recorded in the database system. For example, a rule 292 can indicate provider X's records are available to users at subscription level I for one month after they are added to the database, that provider X's records are available to users at more favorable subscription level II for six months after they are added to the database, and that provider X's records are available to users at most favorable subscription level III for an indefinite period of time after being added to the database. As another example, a rule 292 can indicate provider X's records are available to be returned as raw data for 2 days after being added to the database but can be utilized in aggregation for 2 weeks after being added to the database. This can be useful in cases where historical data is deemed more valuable, as access to data spanning a longer period of time can be more useful in generating analytical insights than access to data spanning shorter time spans.

Such mechanisms of restricting some or all types access to records by some or all users for data once these records have aged beyond a specified amount can be useful not only for licensing purposes, but also in increasing performance of the analytics system. For example, older records that require less access can be stored in less efficient long term storage for only periodic access, for example, by the highest paying subscribers, while newer data allowed to be accessed by more users in more types of queries can be stored in faster, more efficient storage, later being moved automatically to slower storage as it ages. This mechanism for efficiently storing records used less frequently and/or by less users can also be performed for other types of record criteria 296 that more stringently prohibit access to certain types and/or groups of records, where the more stringently regulated groups of records can be automatically stored in the slower storage than less stringently regulated groups of records in response.

In another example, the most recent records can be deemed the most valuable and may be thus accessible for more immediate access only to users at the highest paying subscription levels. As a particular example, higher level subscription users can be granted access data records within an hour of being recorded, where lower paying subscription levels may need to wait a longer amount of time such as a week to access these records, and thus are only granted access to data that is at least a week old at any given time. These restrictions for different subscription levels can similarly be indicated in the time window 298 and/or record criteria 296.

In some cases, age restrictions for different records can be indicated in the other records usage restrictions 304, for example, to enforce maximum and/or minimum time spans for multiple records with one or more matching fields and/or for multiple records that are otherwise grouped and/or deemed as related record. For example, access to a location field for multiple records for a same vehicle within a short time span can indicate detailed information about a vehicle's location, which can be utilized by a malicious user to deduce private information regarding the route of a particular person's commute and/or to otherwise trace a private route. In such cases, users may be prohibited from accessing more than a threshold number of records with one or more matching fields if they all have timestamps that span a length of time that falls below a threshold minimum time span. Such a threshold minimum time span can denote the minimum amount of time for which two or more records with particular matching fields must be separated to be utilized and/or returned. One or more of these threshold minimum time spans can be included in the other records usage restrictions 304.

Similarly, access to records with one or more matching fields and/or that are otherwise related may be prohibited if they span a time frame that is too large. For example, gaining insights into short term whereabouts or other logged conditions for a particular person may be allowed, while accessing such information over longer spans of time could provide too much insight into private information. In such cases, users may be prohibited from accessing more than a threshold number of records with one or more matching fields if they all have timestamps that span a length of time that exceeds a threshold maximum time span. Such a threshold maximum time span can denote the maximum amount of time for which two or more records with particular matching fields can be separated to be utilized and/or returned. One or more of these threshold maximum time spans can be included in the other records usage restrictions 304.

Some rules 292 can include fewer parameters 294 and/or can optionally not include one or more of the time window 298, the maximum number of queries 300, the other field usage restrictions 302 and/or the other records usage restrictions 304. Some rules 292 can include additional parameters 294 and/or other usage limitations not indicated in FIG. 48. In some cases, each listed parameter 294 must be met for the corresponding time window 298, maximum number of queries 300, the other field usage restrictions 302, and/or the other records usage restrictions 304 to be deemed compliant. In some cases, the analytics sub-system must determine the conditions of each listed parameter 294 of a rule 292 match or otherwise compare favorably to those of a given query or result set for a determination of non-compliance with rule 292 to be possible. In some cases, the analytics sub-system must additionally determine that tracked information for previously processed queries indicate some or all conditions of the other field usage restrictions 302 have been previously met for a determination of non-compliance with rule 292 to be possible. In some cases, the analytics sub-system must determine that tracked information for previously processed queries indicate some or all conditions of the other records usage restrictions 304 have been previously met for a determination of non-compliance with rule 292 to be possible.

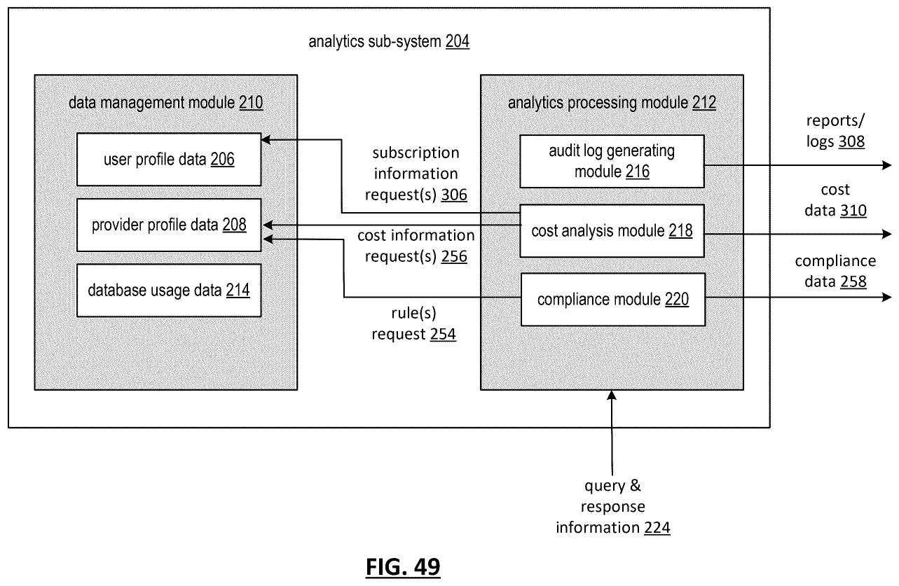

FIG. 49 is a schematic block diagram of another embodiment of the analytics sub-system 204. When the query and response information 224 includes an analysis indication for one or more queries and/or result sets, the analytics processing module 212 communicates with the data management module 210 to access data required for a desired analysis. An analysis may include determining whether a particular query (either prior to or during execution) adheres to one or more rules set by a data provider associated with the query's data. An analysis may include determining cost information for a particular query (either prior to or during execution). An analysis may include generating an audit log and/or report for a requesting entity based on historical and/or runtime data.

For example, depending on the analysis indication included in the query and response information 224, the compliance module 220 is operable to communicate with the data management module 210 to gather necessary data for the analysis. For example, based on a rule analysis indication, the compliance module 220 sends one or more rule request(s) 254 to the data management module 210 to obtain applicable rules related to the one or more queries and/or result sets. For example, the query indicates that the data is associated with a provider 1 and the compliance module 220 accesses rulesets associated with provider 1.

As another example, based on a cost analysis indication included in the query and response information 224, the cost analysis module 218 sends one or more cost information request(s) 254 to the data management module 210 to obtain applicable cost information related to the one or more queries and/or result sets. For example, the query indicates that the data is associated with a provider 1 and the cost analysis module 218 accesses billing structure data associated with provider 1 to provide an estimated cost to run the query. As another example, the cost analysis module 218 accesses subscription data associated with a user 1 subscription with data provider 1 to determine a pricing level associated with that user's data access to provide an estimated cost to run the query.

As another example, the cost analysis module 218 accesses one or more cost rulesets associated with one or more providers and/or users. For example, a user cost ruleset may indicate one or more query cost maximum totals and/or subtotals for one or more types of queries and/or one or more types of features with a corresponding subtotal. As another example a provider cost ruleset may indicate one or more query cost minimum totals and/or subtotals for one or more types of queries and/or one or more types of features with a corresponding subtotal. In another example, the compliance module 220 is also applicable to access one or more cost ruleset to determine a query and/or result set's compliance with the rule.

The compliance module 220 compares the applicable rules 256 and associated parameters to the one or more queries and/or result sets to produce compliance data 258 indicating whether the one or more queries and/or result sets adhere to the applicable rules 256. For example, the compliance data 258 may include an error message indicating that a particular query and/or result set did not comply with a ruleset, one or more rules of the ruleset in which the query and/or result set failed to comply with, and/or portions of the query and/or result set that failed to comply with one or more rules.

As another example, the compliance data 258 may include an indication that a query and/or result set does adhere to a given rule which may also include one or more rules of the ruleset in which the query and/or result set comply with, and/or portions of the query and/or result set that comply with one or more rules. If the analysis is done pre-execution, the compliance data 258 may include instructions to the query and response sub-subsystem on how to move forward with the query. As another example, if the analysis is completed on a result set, a report regarding the compliance data may be provided to one or more of the associated provider and/or end user. Additionally, the if the analysis is completed on a result set during execution of a query, the compliance data can indicate whether the query should be terminated or may proceed.

The cost analysis module 218 compares cost information and associated parameters to the one or more queries and/or result sets to produce cost data 310 indicating an estimated cost associated with one or more queries and/or result sets, historical cost data pertaining to relevant queries and/or result sets, recommendations for reducing costs, etc. For example, the cost data 310 may include a message indicating that a particular query and/or result set has an estimated cost and that if a cost reduction is desired, a list of steps can be taken to adjust the query.

As another example, if the analysis is completed on a result set, a report regarding the cost data may be provided to one or more of the associated provider and/or end user. Additionally, the if the analysis is completed on a result set during execution of a query, the cost data can indicate whether the query should be terminated or may proceed.

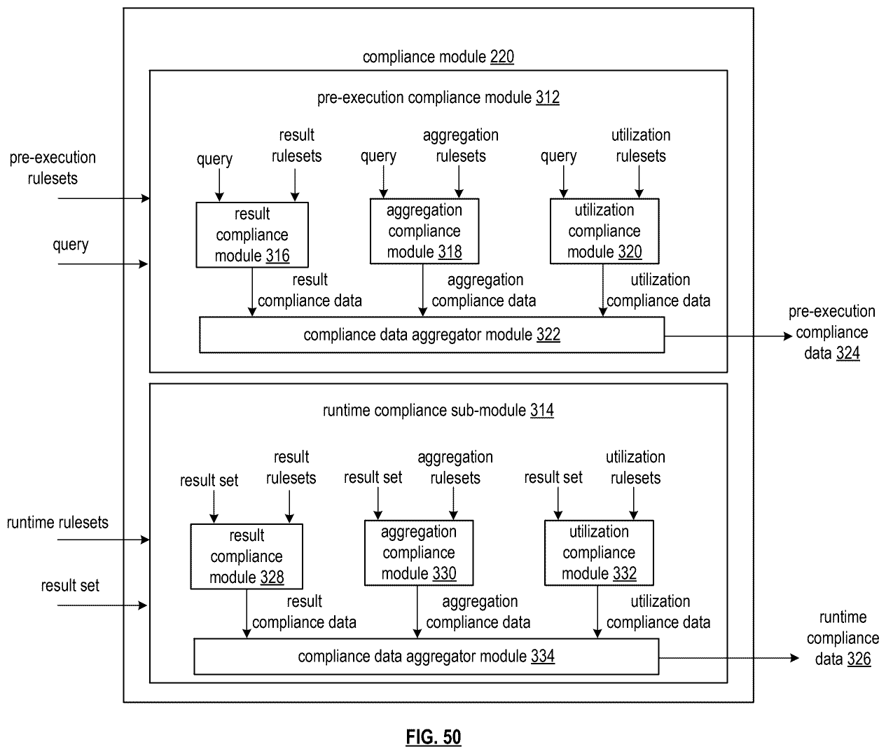

FIG. 50 is a schematic block diagram of an embodiment of a compliance module 220 of an analytics processing module. As shown, the compliance module 220 includes a pre-execution compliance sub-module 312 that evaluates pre-execution rulesets on a query to produce pre-execution compliance data 324, and a runtime compliance sub-module 314 that evaluates runtime rulesets on a result set to produce runtime compliance data 326. Alternatively, different types of rulesets can be evaluated by one or both of the pre-execution compliance sub-module 312 and/or a runtime compliance sub-module 314.

The pre-execution compliance sub-module 312 includes a result compliance module 316, an aggregation compliance module 318, a utilization compliance module 320, and a compliance data aggregator module 322. The result compliance module 316 is operable to compare a query to pre-execution rules that correspond to result rulesets to produce result compliance data. Result rulesets can correspond to rules regarding results that are be returned by a query, such as forbidden fields rulesets or other rulesets regarding whether the particular records and/or number of records returned in execution of a query are allowed.

The result compliance module 316 evaluates a given query based on the requested values to be returned in the query, for example, by determining whether or not a forbidden field and/or set of forbidden fields of the result ruleset are requested to be returned as raw values. The aggregation compliance module 318 compares a query to pre-execution rules that correspond to an aggregation ruleset to produce aggregation compliance data. The aggregation compliance module 318 evaluates a given query based on the requested aggregation to be performed in the query, for example, by determining whether or not a forbidden field and/or set of forbidden fields of the result ruleset are utilized in an aggregation and/or by determining whether a forbidden type of aggregation function is performed.

Aggregation rulesets can correspond to rules regarding aggregations performed on a set of records. For example, the aggregation rulesets can indicate whether particular aggregation functions are allowed to be performed on particular sets of records given their size, provider that supplied the records, and/or particular set of fields that are aggregated upon. As used herein, aggregation functions can include: count functions that return a count of records in a given set of records: sum functions that return a sum of values in one or more fields of records in a given set of records: average functions; average functions that return an average of values in one or more fields of records in a given set of records: minimum functions that return a raw value corresponding to a minimum value over values in one or more fields of records in a given set of records: maximum functions that return a raw value corresponding to a maximum value over values in one or more fields of records in a given set of records; and/or other functions that return an aggregate result or other value for a given set of records.

The utilization compliance module 320 compares a query to pre-execution rules that correspond to a utilization ruleset to produce utilization compliance data. The utilization compliance module 320 evaluates a given query based on a WHERE clause or other requested filtering to be applied in generating intermediate and/or final results, and/or can otherwise evaluate fields and/or records that are otherwise involved in the query. Utilization rulesets correspond to rules regarding utilization of records in executing a query, for example, utilized in any intermediate result sets and/or utilized to filter or otherwise determine any intermediate or final values or sets of records.

For example, a utilization ruleset can include rules that apply to filtering a set of records via the WHERE clause and/or via another filtering mechanism. In particular, conditioning a particular field in the WHERE clause may be restricted, as this condition can indicate private information and/or may otherwise be forbidden. For example, consider a rule where field A is a forbidden field. Thus, a query such as SELECT C FROM TABLE_1 WHERE A= ‘MARRIED’ can be determined to be non-compliant by the utilization ruleset, as the filtering of the results to include records where A is a particular value or within a particular range of values because the result set indirectly returns the values of both A and C in the resulting set of records. Utilization rulesets can indicate forbidden fields or sets of records to be used in WHERE clauses and/or to be otherwise used in filtering sets of records in any capacity: restrictions on values, sets of values, and/or ranges for one or more fields that can be used in WHERE clauses and/or to be otherwise used in filtering sets of records; and/or other restrictions on the type of filtering and/or level of filtering that can be applied in filtering sets of records. The compliance data aggregator module 322 is operable to combine the result compliance data, the aggregation compliance data, and the utilization compliance data to produce pre-execution compliance data 324. In other embodiments, one or more of the result compliance data, the aggregation compliance data, and the utilization compliance data can be output individually or in combination with combined results.

The runtime compliance sub-module 314 includes a result compliance module 328, an aggregation compliance module 330, a utilization compliance module 332, and a compliance data aggregator module 334. The result compliance module 328 compares a result of a result set to runtime rulesets that correspond to a result ruleset to produce result compliance data. The result compliance module 328 evaluates a returned final result, for example, by determining whether or not a forbidden field and/or set of forbidden fields indicated the result ruleset have corresponding raw values returned in the final result set: by determining whether a number of results returned in the final result set exceed a predetermined maximum number of records indicated in the result ruleset; by determining whether particular records returned in the final result set cannot be included for example, due to being included in result sets for other queries requested by the same user; and/or by making determinations for other rules relating to the final result set based on other corresponding factors indicated in the final result set.

The aggregation compliance module 330 can utilize a result of an aggregation returned as a final result, a result of an aggregation utilized as an intermediate result in execution of the query, and/or an intermediate result set corresponding to a set of records that are utilized to perform an aggregation. This information can be indicated in the result set data and can be compared to corresponding rules of the aggregation ruleset to produce aggregation compliance data.

For example, the aggregation compliance module 330 evaluates intermediate result sets utilized to perform the aggregation, for example, by determining whether or not a forbidden field and/or set of forbidden fields indicated in the aggregation ruleset are included in this intermediate result set utilized in the aggregation: by determining whether a number of results included in this intermediate result set utilized to perform an aggregation do not meet a predetermined minimum number of intermediate results indicated in the of the aggregation ruleset: by determining whether particular records included in the in the intermediate result set utilized to perform an aggregation cannot be utilized in an aggregation for example, due to being utilized in other aggregations for other queries requested by the same user; and/or based on other factors indicated by the intermediate result set. As another example, the values returned by an aggregate as an intermediate result or the final result can be evaluated. For example, a raw value and/or record returned by a maximum or minimum function can be evaluated based on whether or not this field and/or record can be utilized and/or returned as a raw value. These various rules for evaluating intermediate result sets can be the same or different for different types of aggregation functions performed on these intermediate result set, and thus an intermediate result set can be compared to a particular set of rules dictated by the particular aggregation function performed on the intermediate result set.

The utilization compliance module 332 evaluates particular records and/or fields included in intermediate sets of records and/or the final set or record, and/or can evaluate particular records and/or fields that were utilized in determining any intermediate results and/or the final result. This information can be indicated in the result set data and can be compared to corresponding rules of the utilization ruleset to produce utilization compliance data.

The compliance data aggregator module 334 is operable to combine the result compliance data, the aggregation compliance data, and the utilization compliance data to produce runtime compliance data 326. In other embodiments, one or more of the result compliance data, the aggregation compliance data, and the utilization compliance data can be output individually or in combination with combined results.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data”).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of’ industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “, “b”, and “.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While transistors may be shown in one or more of the above-described figure(s) as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage: (b) a wired or wireless medium for the transportation of data as a signal within a computing device from one element of the computing device to another element of the computing device for temporary storage or persistent storage: (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence-i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

The preceding technical discussion may include a discussion regarding one or more of: an advantage(s) of a solution(s) to a problem(s), a benefit(s) of a solution(s) to a problem(s), an issue(s) giving rise to a problem(s), a market need(s) for a solution(s) to a problem(s), a value proposition(s) of a solution(s) to a problem(s), and/or the like. As may be applicable, the determining of an advantage(s) of a solution(s) to a problem(s), the determination of a benefit(s) of a solution(s) to a problem(s), the determination of an issue(s) giving rise to a problem(s), the determination of a market need(s) for solving a problem(s), the determination of a value proposition(s) for solving a problem(s), and/or the like can be deemed as one or more discoveries that constitute an invention and/or constitute part of an inventive step to create an invention.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A database system comprises;
an analytics sub-system of an administrative sub-system includes;
a data management module operable to obtain and store;
user profile data related to end users of the database system;
data provider profile data related to data providers of the database system;
database usage data related to one or more current or past queries on the database system; and
an analytics processing module;
a parallelized query and results sub-system includes;
a plurality of query and results computing nodes of a plurality of computing devices of a computing device cluster of a plurality of computing device clusters, wherein a selected query and results computing node of the pluralities of query and results computing nodes is operably coupled to;
obtain a query regarding a dataset stored in memory of the database system, wherein the query includes an analysis indication; and
wherein the analytics processing module is operable to;
obtain query and results information from the parallelized query and results sub-system based on the analysis indication;
obtain analysis information from the data management module related to the query and results information; and
compare the query and results information and the analysis information in light of the analysis indication to produce an analysis result.

2. The database system of claim 1 further comprises;
a parallelized data store and compute sub-system including;
pluralities of processing core resources of pluralities of store and compute computing nodes of a plurality of computing devices of a first computing device cluster, wherein the pluralities of processing core resources is operably coupled to;
access the dataset, wherein the dataset is stored as a plurality of encoded data segments within the pluralities of processing core resources;
execute computations on at least some of the encoded data segments in accordance with the query to produce a set of resultants; and
provide at least some of the set of resultants to the parallelized query and results sub-system, wherein the parallelized query and results sub-system includes second pluralities of processing core resources of the pluralities of query and results computing nodes, wherein a set of processing core resources of the second pluralities of processing core resources is operable to;
execute second computations on the at least some of the set of resultants to produce a query response; and
wherein data management module is operable to obtain and store one or more of the set of resultants and the query response as part of the database usage data.

3. The database system of claim 2 further comprises;
wherein the analytics processing module is operable to;
obtain the query and results information from the parallelized query and results sub-system based on the analysis indication, wherein the analysis indication involves a runtime analysis of a resultant of the set of resultants;
obtain the resultant from the database usage data;
obtain runtime analysis information from the data management module; and
compare the resultant and the analysis information to produce the analysis result.

4. The database system of claim 1, wherein the data management module is further operable to;
obtain past query information from the parallelized query and response sub-system; and
organize the past query information within one or more of: the user profile data, the data provider profile data, and the database usage data.

5. The database system of claim 1, wherein the user profile data comprises;
a plurality of user profile entries, wherein a first user profile entry of the plurality of user profile entries includes a first user identifier (ID) and one or more of;
subscription data;
user verification data;
payment history data; and
record usage data.

6. The database system of claim 1, wherein the data provider profile data comprises;
a plurality of data provider profile entries, wherein a first data provider profile entry of the plurality of data provider profile entries includes a first data provider identifier (ID) and one or more of;
schema data;
record usage restriction data;
record storage requirement data;
billing structure data,
provider verification data;
record usage data; and
audit log preference data, and wherein provider compliance rulesets include rules based on one or more of the record usage restriction data, the record storage requirement data, the billing structure data, and the record usage data produce.

7. The database system of claim 6, wherein the provider compliance rulesets comprise;
a plurality of provider rulesets, wherein a provider ruleset of the plurality of provider rulesets includes one or more of;
a forbidden fields ruleset;
a forbidden functions ruleset;
a maximum result set size ruleset;
a minimum result set size ruleset;
a temporal access limits ruleset; and
a record-based access limits ruleset.

8. The database system of claim 1, wherein the database usage data comprises;
a plurality of database usage data entries, wherein a first database usage data entry of the plurality of database usage data entries includes;
a timestamp;
a user identifier (ID);
one or more data provider identifiers (ID);
query data; and one or more of;
result set data;
billing data; and
restriction compliance data.

9. The database system of claim 1, wherein the analytics processing module further comprises;
a cost analysis module operable to;
obtain cost analysis information from the data management module related to the query and results information; and
compare the query and results information and the cost analysis information in light of the analysis indication to produce cost data as at least a portion of the analysis result; and
a compliance module.
obtain compliance rulesets from the data management module related to the query and results information; and
compare the query and results information and the compliance rulesets in light of the analysis indication to produce compliance data as at least part of the analysis result.

10. The database system of claim 1, wherein the analytics processing module is further operable to;
obtain an analysis indication involving a pre-execution analysis of the query and results information;
compare the query and results information and the analysis information to determine whether the comparison is favorable; and
when the comparison is favorable, provide one or more of;
a notification to the parallelized query and results sub-system to execute the query; and
analysis result to one or more of: an end user associated with the query, and a data provider associated with the query.

11. A computer readable storage medium comprises;
a first memory section that stores operational instructions that when executed by a data management module of an analytics sub-system of an administrative sub-system of a database system, cause the data management module to obtain and store;
user profile data related to end users of the database system;
data provider profile data related to data providers of the database system;
database usage data related to one or more current or past queries on the database system;
a second memory section that stores operational instructions that when executed by selected query and results computing node of pluralities of query and results computing nodes of a plurality of computing devices of a computing device cluster of a plurality of computing device clusters of a parallelized query and results sub-system of the database system, cause the selected query and results computing node to;
obtain a query regarding a dataset stored in memory of the database system, wherein the query includes an analysis indication; and
a third memory section that stores operational instructions that when executed by an analytics processing module of the analytics sub-system, cause the analytics processing module to;
obtain query and results information from the parallelized query and results sub-system based on the analysis indication;
obtain analysis information from the data management module related to the query and results information; and
compare the query and results information and the analysis information in light of the analysis indication to produce an analysis result.

12. The computer readable storage medium of claim 11 further comprises;
a fourth memory section that stores operational instructions that when executed by pluralities of processing core resources of pluralities of store and compute computing nodes of a plurality of computing devices of a first computing device cluster of a plurality of computing device clusters of a parallelized data store and compute sub-system, cause the pluralities of processing core resources to;
access the dataset, wherein the dataset is stored as a plurality of encoded data segments within the pluralities of processing core resources;
execute computations on at least some of the plurality encoded data segments in accordance with the query to produce a set of resultants; and
provide at least some of the set of resultants to the parallelized query and results sub-system;
a fifth memory section that stores operational instructions that when executed by a set of processing core resources of second pluralities of processing core resources of the pluralities of query and results computing nodes, cause the set of processing core resources to;
execute second computations on the at least some of the set of resultants to produce a query response; and
wherein the first memory section further stores operational instructions that when executed by the data management module, cause the data management module to obtain and store one or more of the set of resultants and the query response as part of the database usage data.

13. The computer readable storage medium of claim 12, wherein the third memory section further stores operational instructions that when executed by the analytics processing module, cause the analytics processing module to;
obtain the query and results information from the parallelized query and results sub-system based on the analysis indication, wherein the analysis indication involves a runtime analysis of a resultant of the set of resultants;
obtain the resultant from the database usage data;
obtain runtime analysis information from the data management module; and
compare the resultant and the analysis information to produce the analysis result.

14. The computer readable storage medium of claim 11, wherein the first memory section further stores operational instructions that when executed by the data management module, cause the data management module to;
obtain past query information from the parallelized query and response sub-system; and
organize the past query information within one or more of: the user profile data, the data provider profile data, and the database usage data.

15. The computer readable storage medium of claim 11, wherein the user profile data comprises;
a plurality of user profile entries, wherein a first user profile entry of the plurality of user profile entries includes a first user identifier (ID) and one or more of;
subscription data;
user verification data;
payment history data; and
record usage data.

16. The computer readable storage medium of claim 11, wherein the data provider profile data comprises;
a plurality of data provider profile entries, wherein a first data provider profile entry of the plurality of data provider profile entries includes a first data provider identifier (ID) and one or more of;
schema data;
record usage restriction data;
record storage requirement data;
billing structure data,
provider verification data;
record usage data; and
audit log preference data, and wherein provider compliance rulesets include rules based on one or more of the record usage restriction data, the record storage requirement data, the billing structure data, and the record usage data produce.

17. The computer readable storage medium of claim 16, wherein the provider compliance rulesets comprises;
a plurality of provider rulesets, wherein a provider ruleset of the plurality of provider rulesets includes one or more of;
a forbidden fields ruleset;
a forbidden functions ruleset;
a maximum result set size ruleset;
a minimum result set size ruleset;
a temporal access limits ruleset; and
a record-based access limits ruleset.

18. The computer readable storage medium of claim 11, wherein the database usage data comprises;
a plurality of database usage data entries, wherein a first database usage data entry of the plurality of database usage data entries includes:
a timestamp;
a user identifier (ID);
one or more data provider identifiers (ID);
query data; and one or more of;
result set data;
billing data; and
restriction compliance data.

19. The computer readable storage medium of claim 11 further comprises;
a fourth memory section that stores operational instructions that when executed by a cost analysis module of the analytics processing module, cause the cost analysis module to;
obtain cost analysis information from the data management module related to the query and results information; and
compare the query and results information and the cost analysis information in light of the analysis indication to produce cost data as at least a portion of the analysis result; and
a fifth memory section that stores operational instructions that when executed by a compliance module of the analytics processing module, cause the compliance module to;
obtain compliance rulesets from the data management module related to the query and results information; and
compare the query and results information and the compliance rulesets in light of the analysis indication to produce compliance data as at least part of the analysis result.

20. The computer readable memory of claim 11 further comprises;
the third memory section further stores operational instructions that when executed by the analytics processing module of the analytics sub-system, cause the analytics processing module to;
obtain an analysis indication involving a pre-execution analysis of the query and results information;
comparing the query and results information and the analysis information to determine whether the comparison is favorable; and
when the comparison is favorable, provide one or more of;
a notification to the parallelized query and results sub-system to execute the query; and
the analysis result to one or more of: an end user associated with the query, and a data provider associated with the query.
